(19) United States
(12) Patent Application Publication
(10) Pub. No.: US 2016/0241713 A1
(43) Pub. Date: Aug. 18, 2016

(54) Apparatuses, Methods and Systems For Improved Call Center Training

(71) Applicant: FMR LLC, Boston, MA (US)

(72) Inventors: Ryan Alm, Union, KY (US); James Hill, New Carlisle, OH (US); Jeff Parsley, Arlington, TX (US)

(21) Appl. No.: 14/622,392

(22) Filed: Feb. 13, 2015

(51) Int. Cl. H04M 3/51; G09B 19/00; H04M 3/22

(52) U.S. Cl. CPC H04M 3/5175; H04M 3/5183; H04M 3/2281; G09B 19/00

(57) ABSTRACT

The Apparatuses, Methods and Systems for Improved Call Center Training (“CallLab”) transforms recorded telephone call inputs and call operator screen displays via CallLab components into training outputs for use in generating a call training game and evaluating a trainee's performance during the call training game.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address Automated Management Arrangements, and more particularly, include Apparatuses, Methods and Systems for Improved Call Center Training for Improved Call Center Training.

As such, the present innovations include performance analysis of employees with respect to a job function (with a suggested Class/Subclass of 705/7.42).

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Heretofore, call centers have typically trained new employees by supervising them during live phone calls with real customers. This leaves the potential to adversely affect customer relations when a trainee makes an error during such live calls, until such time as trainees have developed suitable experience.

### BRIEF DESCRIPTION OF THE DRAWINGS

Appendices and/or drawings illustrating various, non-limiting, example, innovative aspects of the Apparatuses, Methods and Systems for Improved Call Center Training (hereinafter “CallLab”) disclosure, include:

FIG. 1-3 show datagraph diagrams illustrating embodiments of user training interactions with the CallLab;

FIGS. 4-8 show logic flow diagram illustrating embodiments of training and administration workflows for the CallLab;

FIGS. 9-11 show block diagrams illustrating embodiments of call center training components for the CallLab;

FIGS. 12-39 show screenshot diagrams illustrating embodiments of call center training games for the CallLab;

FIGS. 40-69 show screenshot diagrams illustrating embodiments of call center training administration and reporting for the CallLab; and

FIG. 70 shows a block diagram illustrating embodiments of an exemplary CallLab controller.

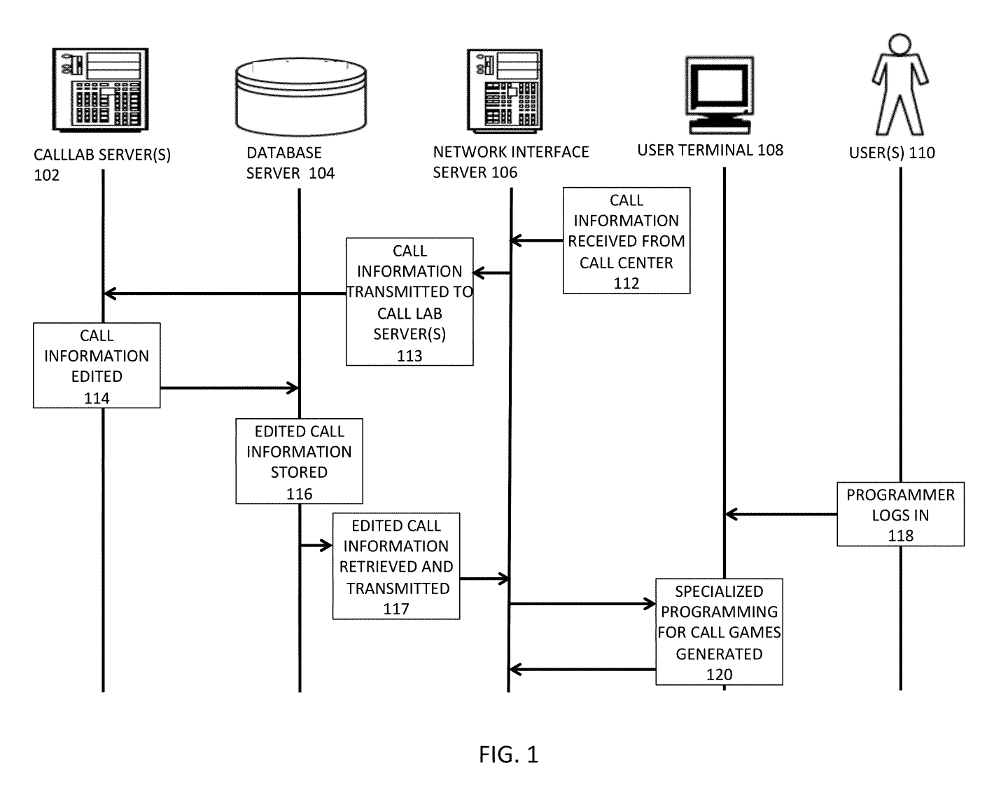

Generally, the leading number of each citation number within the drawings indicates the figure in which that citation number is introduced and/or detailed. As such, a detailed discussion of citation number 101 would be found and/or introduced in FIG. 1, etc. Any citation and/or reference numbers are not necessarily sequences but rather just example orders that may be rearranged, and other orders are readily contemplated.

### DETAILED DESCRIPTION

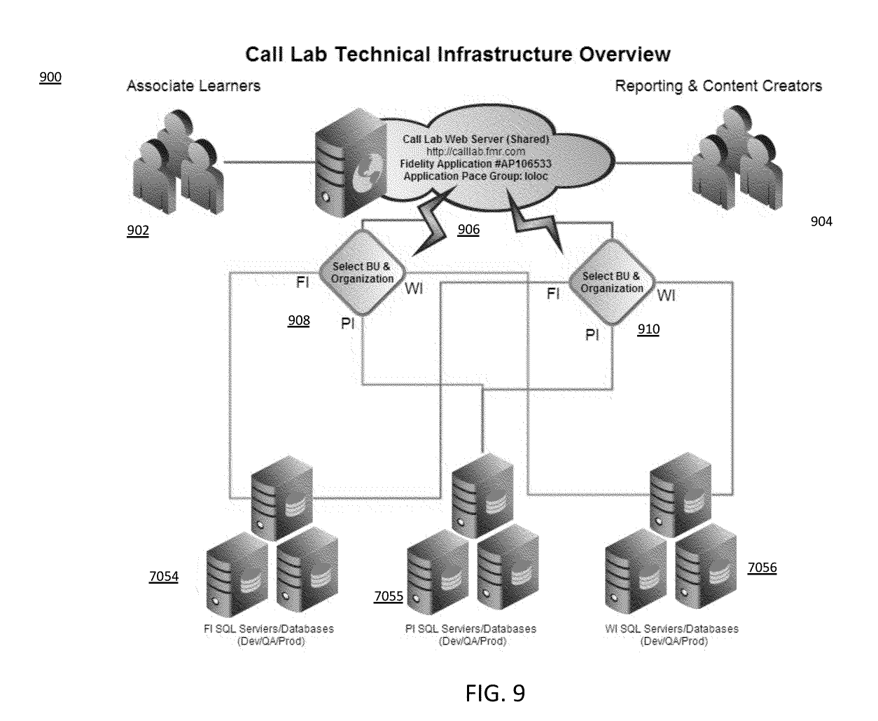

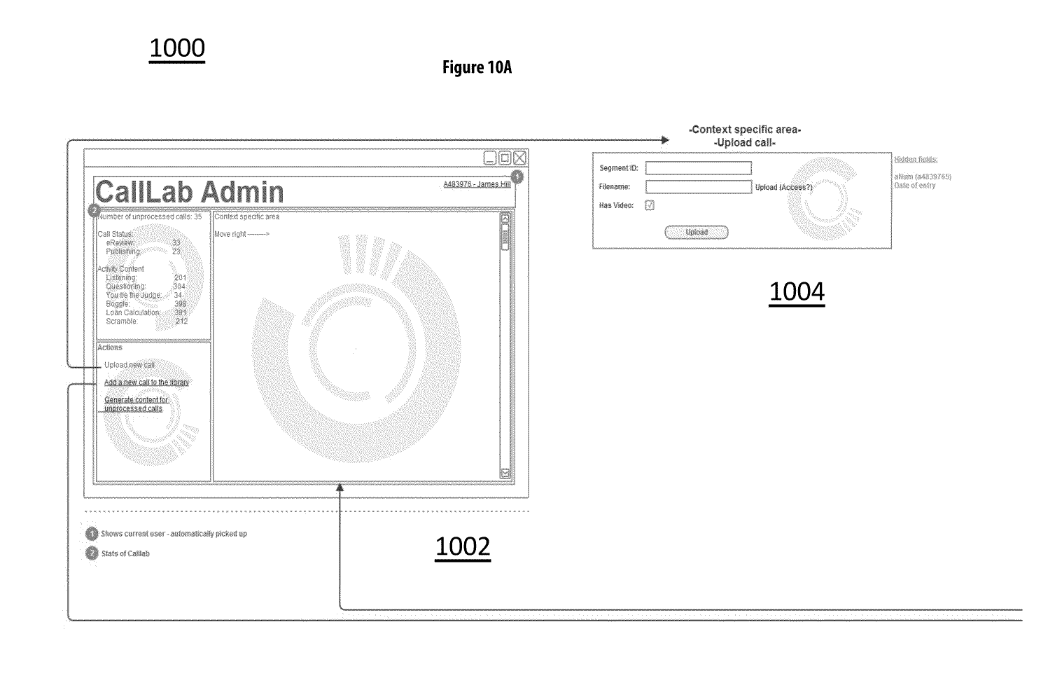

The Apparatuses, Methods and Systems for Improved Call Center Training (hereinafter “CallLab”) transforms real-world and simulated phone conversation inputs (including, but not limited to, audio, video, images and text), via CallLab components (see e.g., FIGS. 9-11), into outputs that are used in call center training games, which outputs may be displayed to various users, such as trainees, employees and administrators. The CallLab components, in various embodiments, implement advantageous features as set forth below.

### Introduction

The CallLab portal may be implemented as a flash-based, HTML-based, or Javascript-based website, or other accessible network server(s), which allows users to access the CallLab system by entering their user identification (ID) and selecting a business unit.

Upon entry and on first use, a user chooses a business unit (department) and a phone call topic relevant to that business unit. Each such topic may apply to multiple (e.g., one to five) tiers of that must be completed by call center trainees during call training games. These tiers can be populated with any of the call training content maintained in the CallLab library. More games and game content can be added to the library as they are developed and become available.

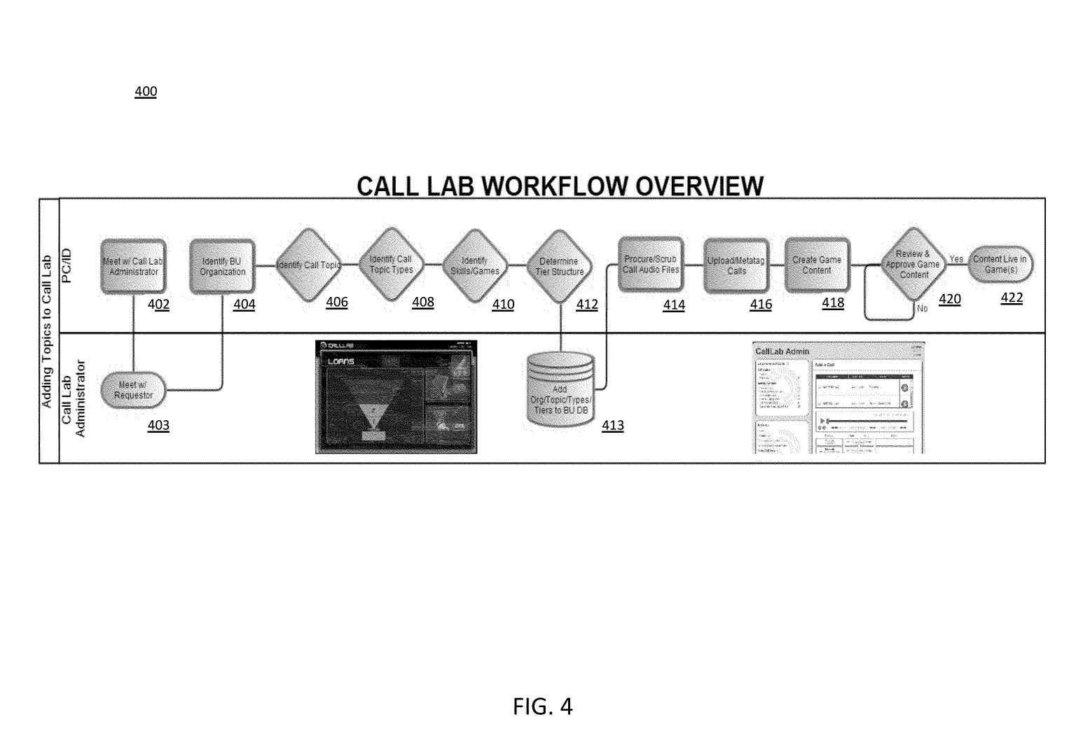

Each topic may have a number of call types assigned to it. These call types are identified by the administrators, programmers or other subject matter experts. The call types are set up in the configuration of that topic's CallLab, along with the tier structure and game setup (see, FIGS. 4-11)

Each call training game engine is designed around specific skills, such a those typically used for telephone-based customer interactions. By design, and for the advantageous reasons identified further herein, each game engine contains no content of its own. All of the settings for the game mechanics (scores, timers, number of questions, weighted answers, etc.) are held on a separate database server, thus allowing for customization of each game on each tier, and enabling administrators to change the game behavior for each instance it exists within a topic without interfering with ongoing live games being used by trainees.

Each game may use points, badges and leveling mechanics to guide the call center trainee to appropriate behaviors and drive repetition and practice, thereby allowing them a safe place to fail while learning their skill with actual call center calls that have previously occurred, all without negatively impacting actual customers. Using a reporting structure, administrators can see trends and progression each time trainees or employees play the call training games.

When a call training game is loaded, it requests a library of content from the server, for example in the form of the following sequence of programming interactions: Flash->C#->MSSQL->C#->XML->Flash. The XML file, which is built in C# based on the SQL results returned for a particular game (that, in turn, is generally dependent upon the topic and tier the player has achieved), contains all textual information for question and answer text, as well as any paths to the server for the .MP3 and JPG files that will be processed and displayed to users during the games. The call training game platform is not limited to a FLASH implementation, and any client-side deliverable may readily be used.

Keeping the content externally from the game engines advantageously allows game administrators to reuse, expand, update and control all of the content without interrupting or otherwise interfering with live call training games that are in progress. This allows for a fully-scalable gaming platform (sometimes referred to herein as a “SkillEngine”) that has a continuously-expandable content management system for any game platform that employs this improved network architecture.

The administration panel of the content management system, as may be provided to game administrators, allows for full control over the content used in each of the games. Instructional designers can go in to the system and load, for example, full phone conversations in the form of a stored .MP3 file or similar stored audio files. Advantageously, previously recorded telephone conversations between call center representatives/operators and customers in the real world may be edited and used as sources of content for games on which new representatives may be trained and evaluated.

Once uploaded into the system, each call may be available for use with any of the call training games at various tiers and levels. The administrator uses various game creation screens and panels to review the calls in the database (for example, according to topic). Once a call has been found that the administrator wishes to use, the file containing the call is moved into a game content creation area.

The game content creation area allows administrators to choose which game content they wish to create. Different content creation panels may be provided for separate types of call training games. The content creation panel allows the administrator to select and review a stored call, locations within the game where edited content playback is to start in the game, and where it should stop playing. Then, depending on the game type, administrators may fill in the appropriate sections of the creation panel to input content into the system. For an exemplary Listening and Questioning game (described in more detail later herein), a start and stop time is required, along with the call type or topic that goes along with that section of the call. For various Listening and Questioning games, administrators may input a start and stop time along with the call type, and then enter a longer start and stop time from another part of a given phone call. They would then be able to add custom text for each response type used for that game. An exemplary Screen Puzzle game (described in more detail later herein) requires a start and stop time, as well as a JPEG image or the like for presenting portions of call operator screen displays with which trainees are to become familiar. The skill level required to satisfactorily complete a game may change, such as by increasing in difficulty as the game progresses. The level or tier achieved by a user will determine how many questions and hotspot areas will need to be input into a game as it is played, and may also dictate game presentation criteria, such as a size of displayed puzzle pieces for a game (for example, higher levels may have smaller puzzle piece).

In this manner, a single recorded phone call can be used for multiple games and game types, allowing administrators to maximize its use and lessen the number of different calls needed by the system in order for the games to run.

Once call training game content has been created and stored, it may undergo a review process. Using a displayed administrator panel, someone other than the content creator is required to go to a game content review panel, listen to that portion or segment of a phone call and check all the assigned answers and questions that are to be presented to a trainee regarding the same. If the content is approved without changes, that piece of content will be flagged as live and will be immediately available to the call game engine whenever it runs, and even to those games that may already be in progress, without causing any interruption of such live game. If however, content is changed in the review panel, a further review process may occur. These checks should aim to ensure that all content is valid and will not confuse or frustrate player/trainees should they be served that content during a live call training game.

A Reporting component may also be provided within the CallLab environment in order to allow administrators to see a general overview of all trainees that have played the training games for each available topic. By selecting a particular trainee, administrators can drill down into trainees' progress over time and see how well different areas of skill might be developing. Administrators may also create custom groups of trainees that are to be reviewed.

FIG. 1-3 show datagraph diagrams illustrating embodiments of various user interactions with the CallLab environment.

Turning to FIG. 1, CallLab Servers 102 comprise one or many servers, including a business unit server, an administrator server, a call training game server, and a reporting server, which may collective comprise the CallLab environment.

A Database Server 104 may be provided to store various information used by the CallLab Server(s) 102 including phone call data, screen display information, user profile information, question and answer data, trainee performance evaluation data, and any other data described and used herein.

Network Interface Server 106 enables network communication between the CallLab Server(s) 102, Database Server 104, and User Terminals 108.

User Terminal 108 may be any type of computing device, such as a used by users 110 who may be trainees, employees, programmers, and administrators as described further herein.

The servers and terminals represented in FIGS. 1-3 cooperate via network communications hardware and software to initiate the collection of data for use in a call training game, as well as for generating and operating the call training games and updating the call training games as more call game data becomes available. This is illustrated in the datagram flow depicted in FIGS. 1-3. Turning to FIG. 1, commencing at step 112, the Network Interface Server 106 receives phone call data from a live phone conversation between a call center operator and a customer. The phone call data may include, for example, phone call segments from the conversation, as well as screen displays presented to the call center operator during the call, which assist the call center operator in servicing a customer that has called into the call center for assistance. The Network Interface Server 106 transmits the phone call data to the CallLab Server(s) 102 (step 113) where the phone call information is edited (step 114). The CallLab Server(s) 102 then transmit the edited phone call information to the Database Server 104, which stores it in memory (step 116). Next, at step 118, a user 110, such as a call game programmer, logs into the user terminal 108. The edited call information is retrieved and transmitted to the programmer (step 119). The programmer then manipulates the phone call information to generate specialized programming and call game data from the stored, edited phone call information (step 120).

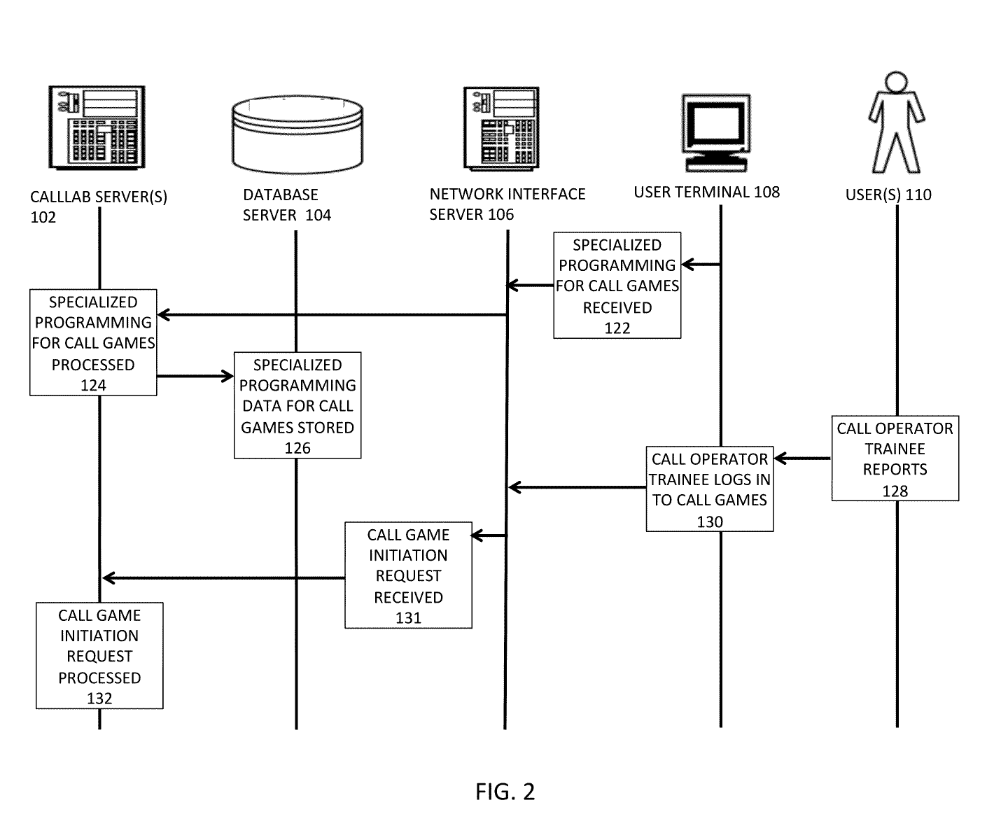

Continuing to FIG. 2, the specialized programming for call training games is received from the user terminal 108 by the Network Interface Server 106 (step 122). The specialized programming for the call games are received and processed by the CallLab Server(s) 102 (step 124). The specialized programming data for the call games is then stored in the Database Server 104 (step 126).

Next, at step 128, a call operator trainee reports to participate in one or more call games for training purposes. Using a user terminal 108, the call operator trainee logs into initiate a call game (step 130). A call game initiation request is received by the Network Interface Server 106 from the User Terminal 108 (step 131). The call game initiation request is transmitted to and processed by the CallLab Servers 102 (step 132).

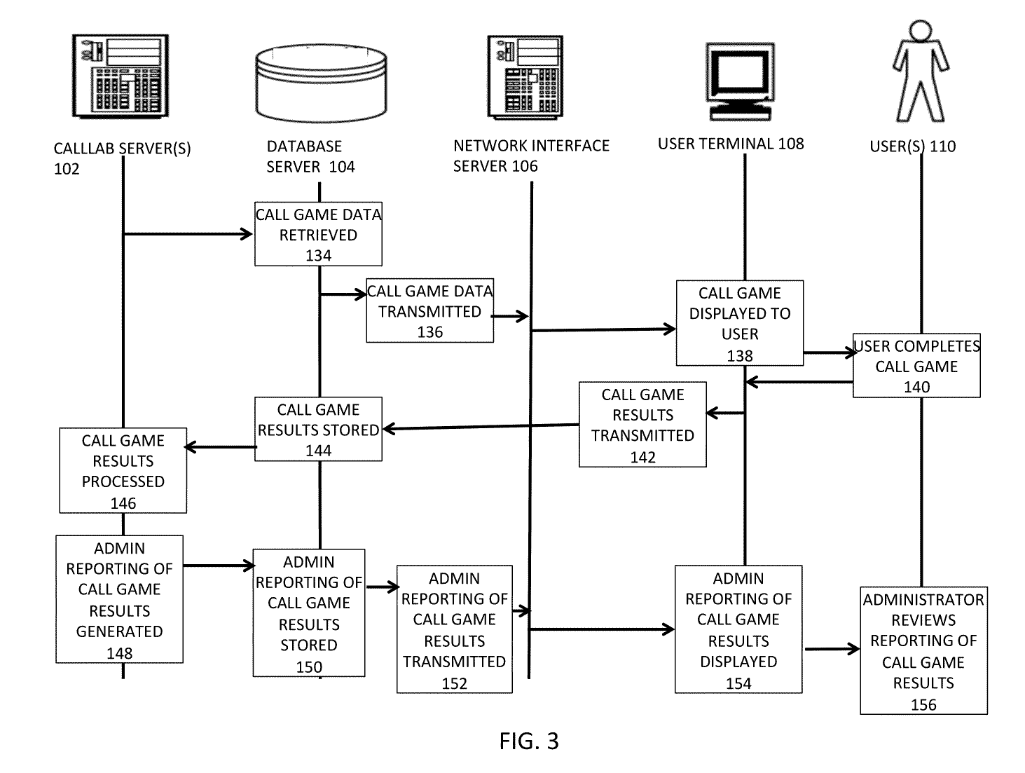

Continuing to FIG. 3, responsive to step 132, call game data is retrieved from Database Server 104 (step 134). The Network Interface Server 106 transmits the call game data to the User Terminal 108 (step 136). A call game is then displayed to the trainee via user terminal 108 (step 138), after which, the trainee interacts with and completes one or more call training games (step 140).

The results of a trainee's interactions with the call game are next received by the Network Interface Server 106 (step 142), and then transmitted to the Database Server 104 for storage in the memory thereof (step 144). The call training game results are then retrieved by the CallLab Server(s) 102 and processed to determine an evaluation of the trainee's performance (step 146). Reporting of the trainee's call game results are responsively generated (step 148) and stored in the Database Server 104 (step 150). Reports of call game results are then transmitted via the Network Interface Server 106 (step 152) to a user terminal 108 and displayed to an administrator on a display screen thereof (step 154). The reporting of the call game results may then be reviewed by an administrator (step 156) using a User Terminal 108.

FIG. 4 shows an exemplary CallLab workflow diagram 400 for adding topics to a call center training game. At steps 402 and 403, an administrator and programmer collaborate over the CallLab network to establish one or more call training games and game types. Applicable business units of the call center are first identified (step 404). Next, call topics for each business unit may then be established (step 406). Call topic types for categorizing each call topic are then established (step 408). The skills that are tested for each call training game are then identified (step 410). Tier structures for the call training games are next established (step 412). Business units, call topics, call topic types and game tiers are then transmitted to and stored in the CallLab database (step 413). Phone call segment audio files and call operator display screen information are then obtained, and meta-tags describing such content are input and stored (step 414). Such call game data with meta-tags are then uploaded to CallLab servers (step 416). Game content is then generated from the call game data (step 418). The call game content is then reviewed and approved for use or marked for further editing if it is found to contain errors or the like (step 420). All approved game data content is then transmitted to call training game servers that run the call training games for use within the live call training games that may be operating thereon (step 422).

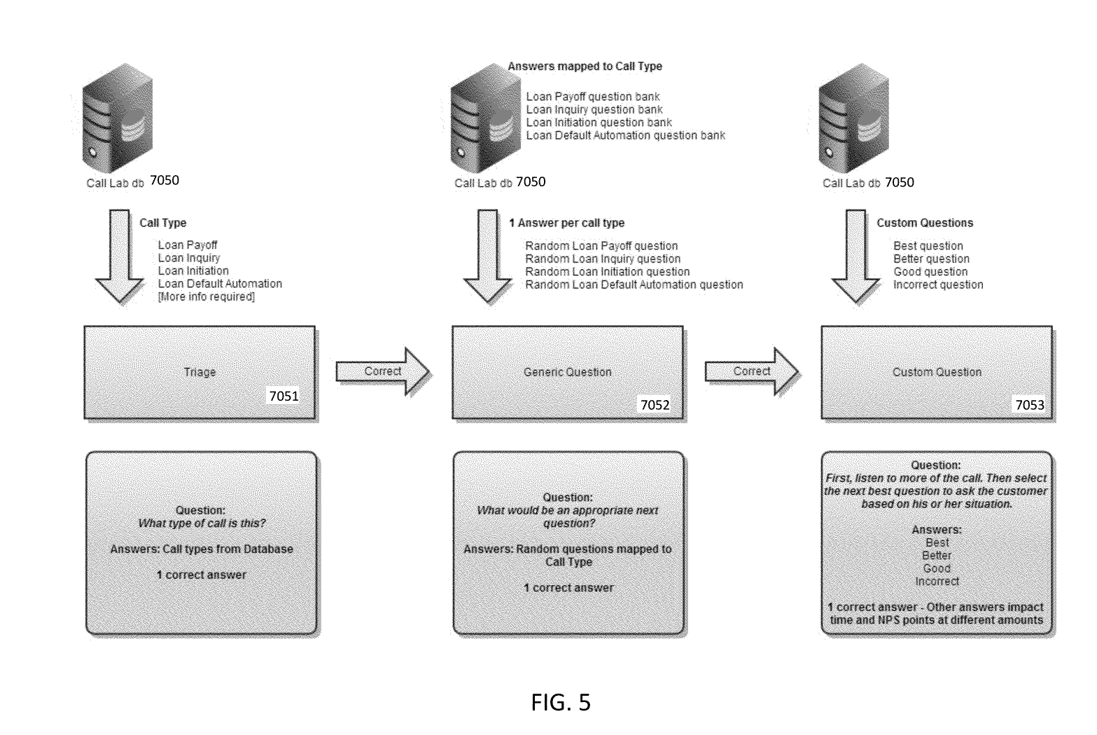

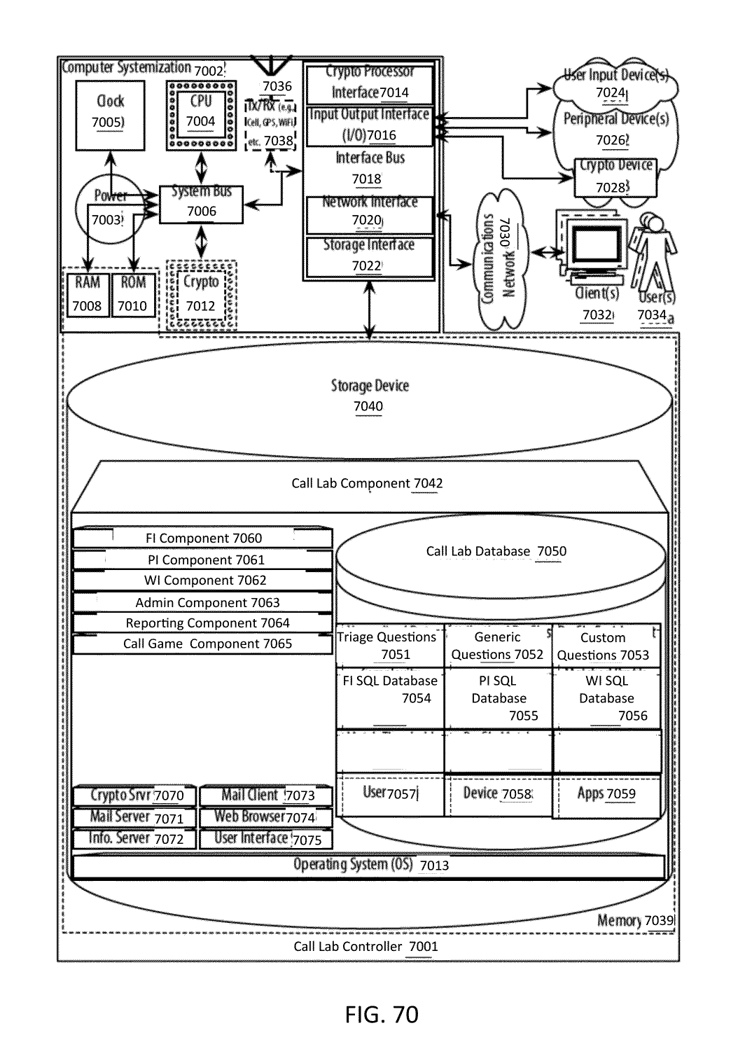

FIG. 5 shows an exemplary embodiment in which a CallLab database 7050 may be maintained by one or more database servers. In various embodiments, CallLab database 7050 may contain separate databases for different call game content types. In various embodiments, the call game content may include various types of questions such as Triage Questions database 7051, Generic Questions database 7052, Custom Questions database 7053 (each of which is described in more detail with respect to FIG. 70 below). Triage Questions database 7051 may be a repository for triage questions that are to be presented to a trainee during a call training game, where triage questions (and stored correct answers) relate to identifying a call type of a simulated call that is presented to a trainee during a call game. Generic Questions database 7052 may contain general questions regarding a call presented to the trainee during a call training game. The Custom Questions database 7053 may contain more specific questions regarding a call presented to a trainee during a call training game.

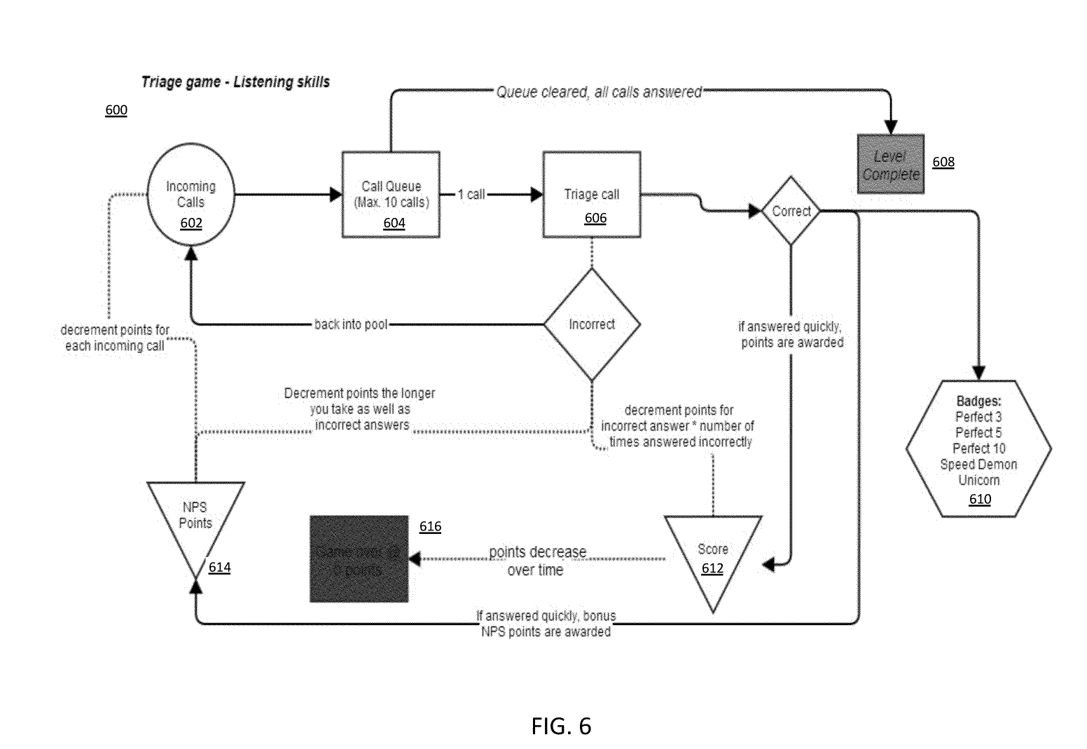

FIG. 6 shows an exemplary triage call game flowchart 600 for an exemplary triage call game, in which a trainee is asked to correct triage, or identify, a simulated incoming call. At the commencement of the triage game, the simulated incoming call is presented to a trainee (step 602). The incoming call is placed in the trainee's simulated call queue (step 604). The trainee is then asked to triage the call (step 606). If the trainee answers the triage question correctly, the trainee may be awarded with game badges or the like (step 610), and game points may be awarded for the correct answer(s) (step 612). If the trainee took too long to answer a call or a call is triaged incorrectly, the trainees game score may instead be decremented (step 616). If however, the trainee has triaged calls properly and also within an acceptable amount of time, then additional bonus points may be awarded (step 614). When an appropriate amount of calls have been completed during a game, the trainee may proceed to the next game level or tier (step 616). The points gained from previous levels may be used to increment a timer for later levels selected by the trainee. Better scores may thereby give the trainee more time in later levels, allowing them to achieve better scores in such later levels. In addition, while a trainee may nominally pass a level, the training game may still require them to retake the level in order to achieve a better or more acceptable score.

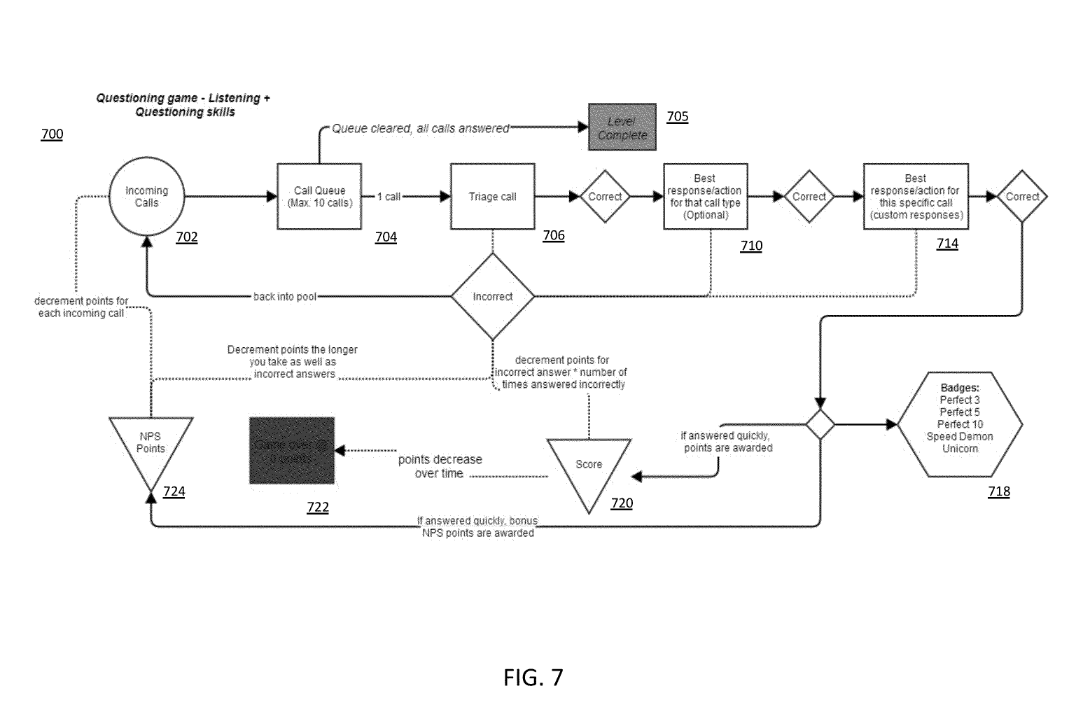

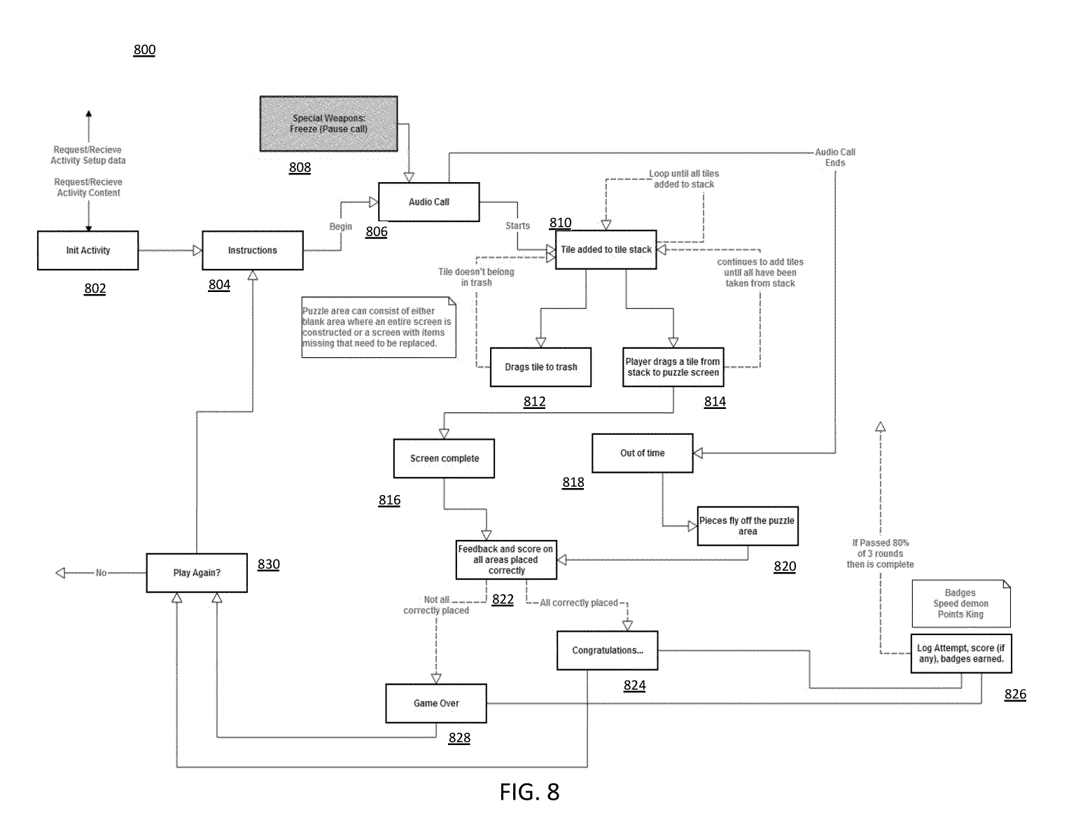

FIG. 7 shows an exemplary listening and questioning game flowchart 700 for a Listening and Questioning game administrated by CallLab. At the commencement of the Listening and Questioning game, an incoming call is received (step 702). The incoming call is placed in the call queue of the trainee (step 704). The trainee is then asked to triage the incoming call (step 706). If the trainee answers correctly, then at step 710, the trainee is asked to identify the best response or action to take for that type of call. If the trainee answers correctly, then at step 714, trainee asked to identify the best response action for that specific call. If the trainee is correct, then at step 718, the trainee may earn a game award badge based on performance and time to respond at steps 706, 710 and 714. The trainee's score may be incremented based on performance at step 720. If however, the trainee is incorrect at steps 706, 710 or 714, points may be decremented at step 720. If the trainee answered correctly but took too long to answer, then at step 722, no points may be awarded. In addition, at step 724, if the trainee takes an acceptable amount of time to answer calls correctly, bonus points may be awarded during the game.

FIG. 8 shows an exemplary Screen Puzzle game flowchart 800 for a call training puzzle game in which puzzle pieces representing individual portions of a call operator's display screen information are presented to, and must be correctly organized by, a trainee. At step 802, a Screen Puzzle game is initiated by a trainee. Gameplay instructions are responsively presented to the trainee on a user terminal 108 or the like (step 804). A simulated incoming audio call is next presented to the user via speakers or the like of user terminal 108 (step 806). Next, a collection of puzzle pieces consisting of correct call screen tiles and incorrect call screen tiles are added to a tile stack that is presented to trainee during the Screen Puzzle game (step 810). The trainee may select and place tiles from the tile stack onto the simulated call operator display screen (step 814), or drags one or more tiles believed to be incorrect to a trash area presented on the game display screen (step 812), until all tiles relating to incoming call have been placed (step 816) or time given to the trainee to complete the puzzle runs out (step 818). Upon completion of a puzzle, the tiles are removed from the game display screen (step 820). If the screen is timely completed by the trainee, the trainee's performance is scored and evaluated based on correct/incorrect placement of tiles and the trainee's time to completion (step 822). If all tiles were placed correctly, the trainee is notified (step 824) and the trainee's score is reported to a CallLab administrator (step 826). If all tiles were not placed correctly, the games ends (step 828) and the trainee is asked to play the Screen Puzzle game again (step 830) until correct completion of the puzzle is achieved. Once the puzzle has been completed, the trainee may be asked to identify correct areas of the puzzle screen that they have just built based on a question that is presented upon completion. Each level of the puzzle game can have one or more questions that are required to be answered correctly and quickly in order to achieve mastery of the game/skill.

FIG. 9 shows a block diagram of the technical infrastructure 900 of an exemplary CallLab network, in which associate learners/trainees 902 are tested and evaluated using the call training games as described herein. Game content may be developed by game content creators or administrators 904. The CallLab network may include one or more CallLab Servers 906. Trainees interact with the CallLab network via a Trainee Business Unit interface 908. Content creators and administrators interact with the CallLab network through an Administrator business Unit interface 910. The CallLab network may include business unit servers such as a FI SQL Server database 7054, a PI SQL Server database 7055, and WI SQL Server database 7056, which contain and store game data for various business units (examples of which are nominally designated herein as WI, PI and FI).

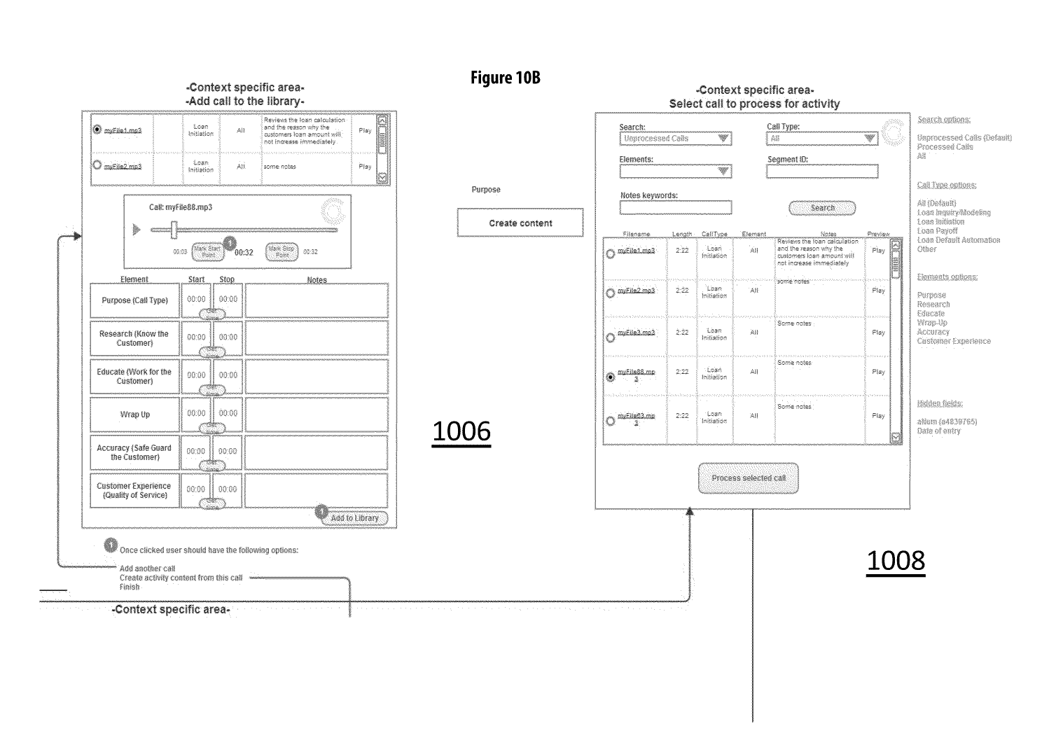

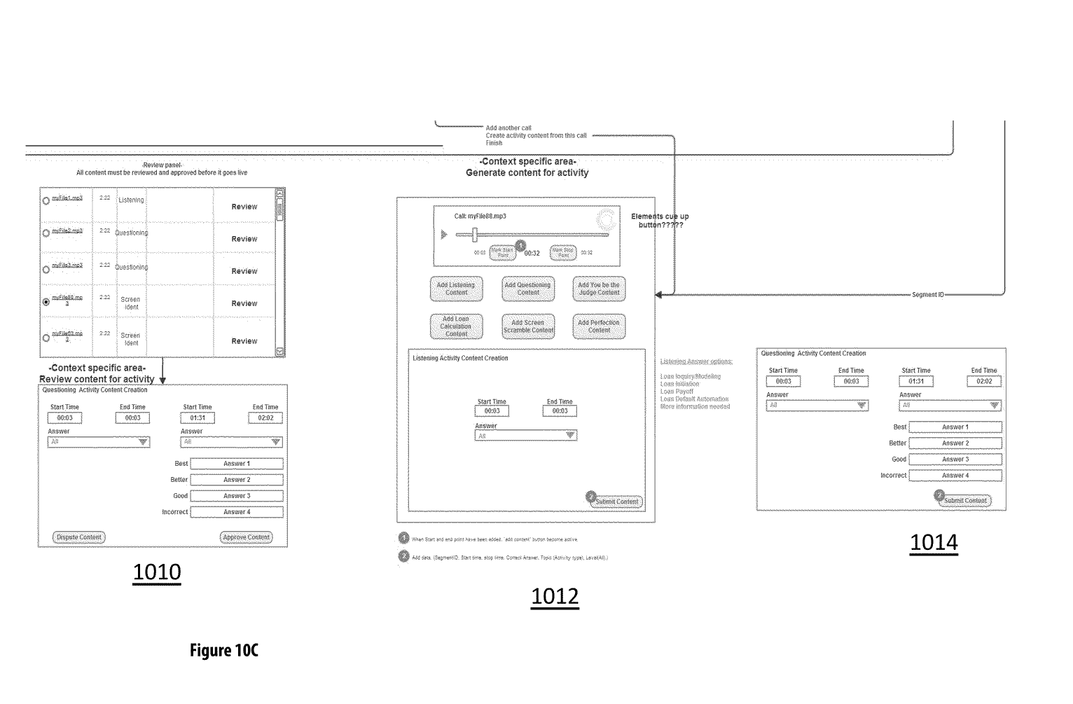

FIG. 10 shows an exemplary block diagram of CallLab administrator display panels 1000 that are displayed to an administrator or programmer on a user terminal 108 or the like, and by which an administrator or programmer may establish call game data content. The CallLab display panels 1000 include a CallLab Administrator interface 1002, a Call Content Specification area 1004, a Call Library 1006, a Call Selection interface 1008, a Review panel 1010, an Activity Content Generation panel 1012, and a Questioning Game Content Creation panel 1014.

The CallLab Administrator interface 1002 may include information pertaining to the number of unprocessed calls that are available to generate call game content, the review status of each call, call types, and actions to take regarding the unprocessed calls, such as: upload a call, adding a new call to a call game library and generating meta-tag content or the like for an unprocessed call.

The Call Content Specification area 1004 may include fields for designating a filename for a call and segment identifications (IDs) for portions of a call to be used as call game content.

The Call Library 1006 includes playback buttons for reviewing calls, fields for entering call types, keywords or metatags that describe the call, fields for entering skills that are to be tested by the call, and the like. An “upload” button is provided so that a call may be uploaded to the Call Library when selected by the administrator.

The Call Selection interface 1008 includes search fields for searching for calls in the CallLab library based on file name, keywords, meta-tags, call type, call elements and the like. Calls that conform to a search are displayed to the administrator in this area of the display panel 1000. The administrator may then select one or more stored calls for processing in order to generate call game content.

The Review panel 1010 is provided so that an administrator may select a call for review, see the start and end times for a phone segment, as well as review questions to be presented to a trainee about the call and the correct answers thereto. If the information for a phone segment is correct, the administrator may select an “approve” button to approve the call for inclusion in a call game. Otherwise, a “reject” button may be selected by the administrator to reject to dispute the call content.

The Activity Content Generation panel 1012 allows an administrator to add additional content for the call that is to be presented to a trainee during a call game session involving the call. The administrator may add listening activity content, questioning activity content, puzzle piece content and the like to such calls as desired.

The Questioning Game Content Creation panel 1014 allows an administrator to add additional questions and a list of possible answers, including correct answers, which may be presented to a trainee regarding the call during a call training game.

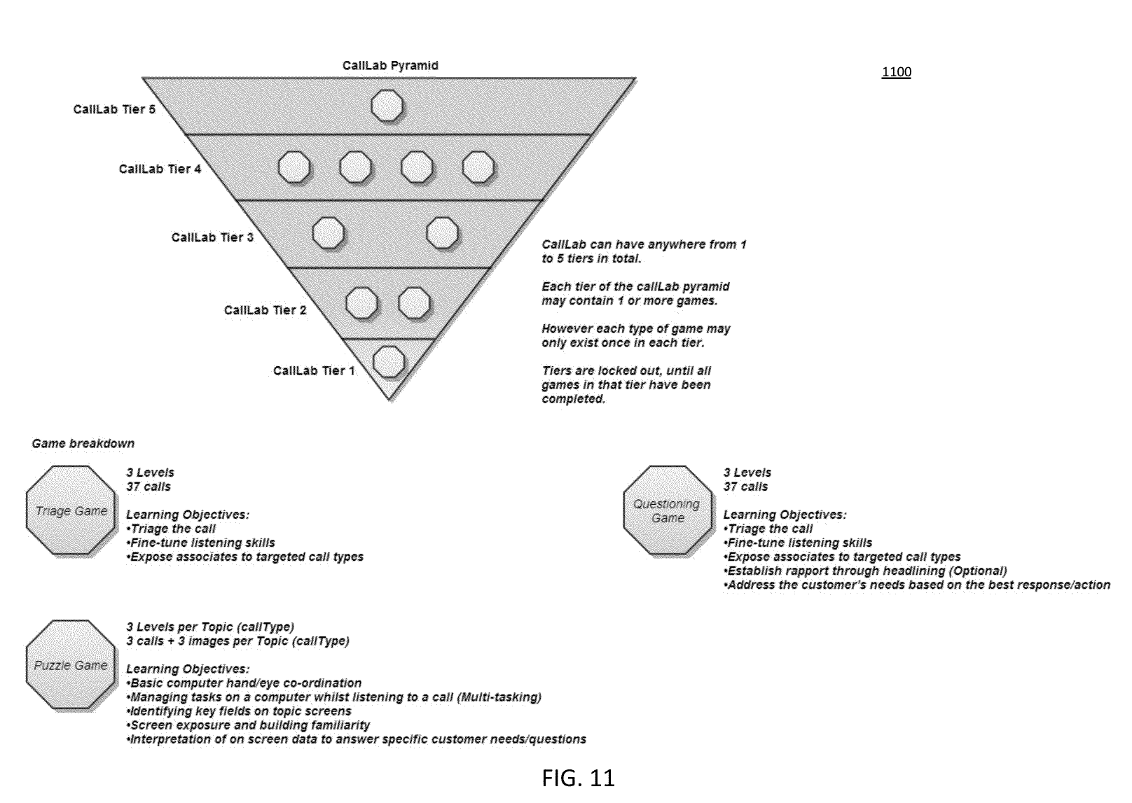

Each CallLab training game may have one or more tiers to be completed by a trainee. Each tier, in turn, may have one or more individual levels that require correct completion by the trainee. Each level may require the completion of one or more game types, such as a Listening and Questioning game or a Screen Puzzle game. The level of difficulty of games may increase with level or tier. FIG. 11 shows exemplary tiers that may be employed by the CallLab. There may be, for example, five game tiers, each with at least one level for completion, with each level comprising at least one call game type. The number of games, tiers and levels are not to be viewed as limiting, as any number of such tiers, levels and games may be employed for evaluating a trainee's performance.

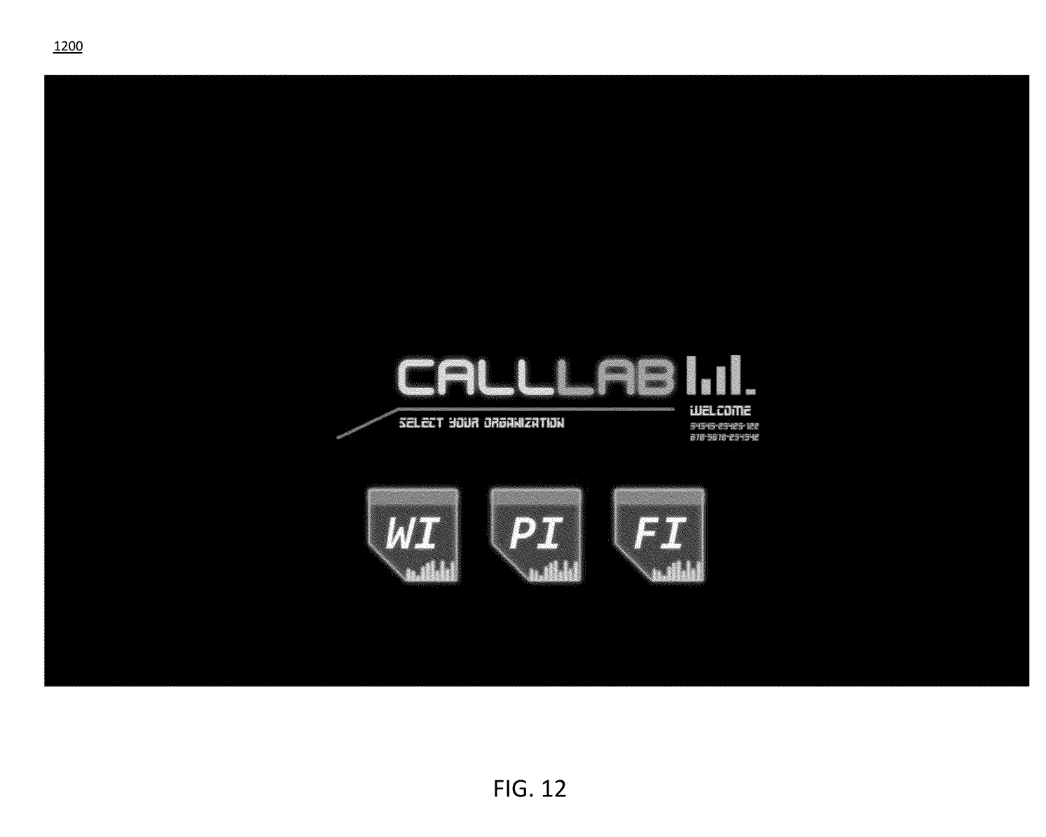

Turning now to FIGS. 12-29, therein are depicted a series of exemplary screen displays that may be presented to a trainee during gameplay of a call center training game. FIG. 12 shows an exemplary screen shot of an initial entry page 1200 of a CallLab Trainee interface, which may be presented to a trainee upon login to a user terminal 108. WI, FI and PI, as displayed therein, nominally represent the current businesses units that have a CallLab database for which a trainee may train. Each business unit may have a separate database maintained for their CallLab topics. However, all game code and game engines may be maintained on and shared from a separate server for the reasons previously described.

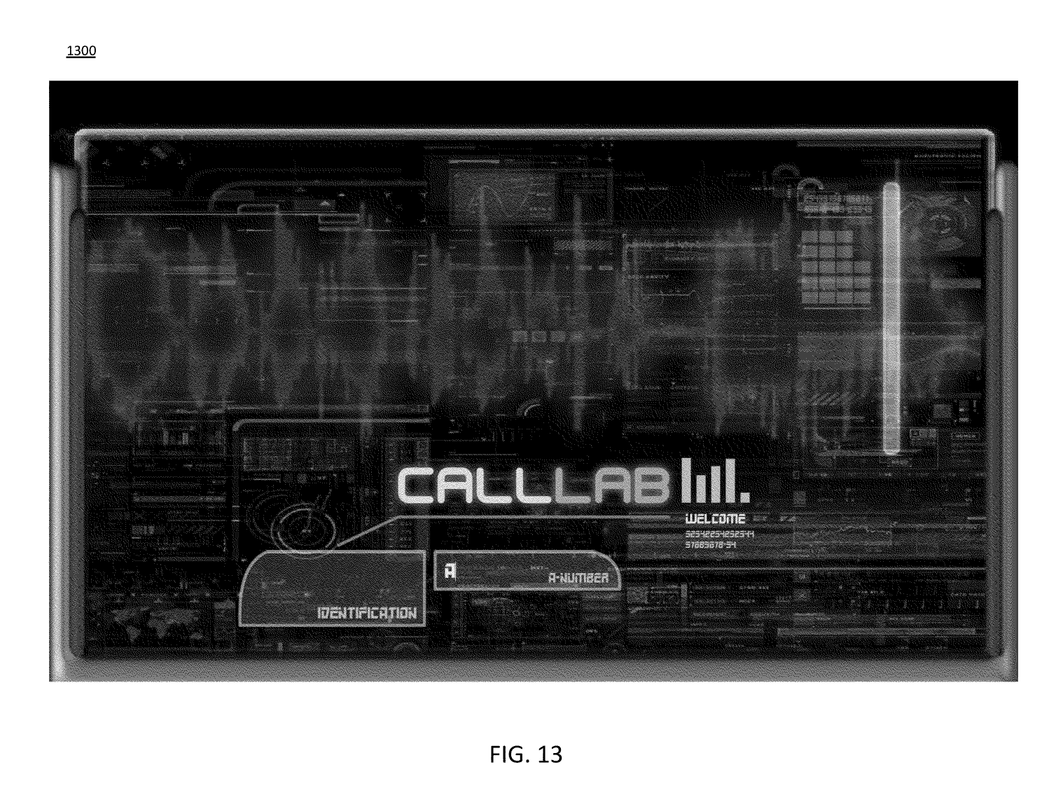

FIG. 13 shows an exemplary screen shot of a Login page 1300 next presented to the trainee, by which they are prompted to enter their user ID once a business unit has been selected. The user ID will be used to track the trainee's performance in the games presented for the selected business unit.

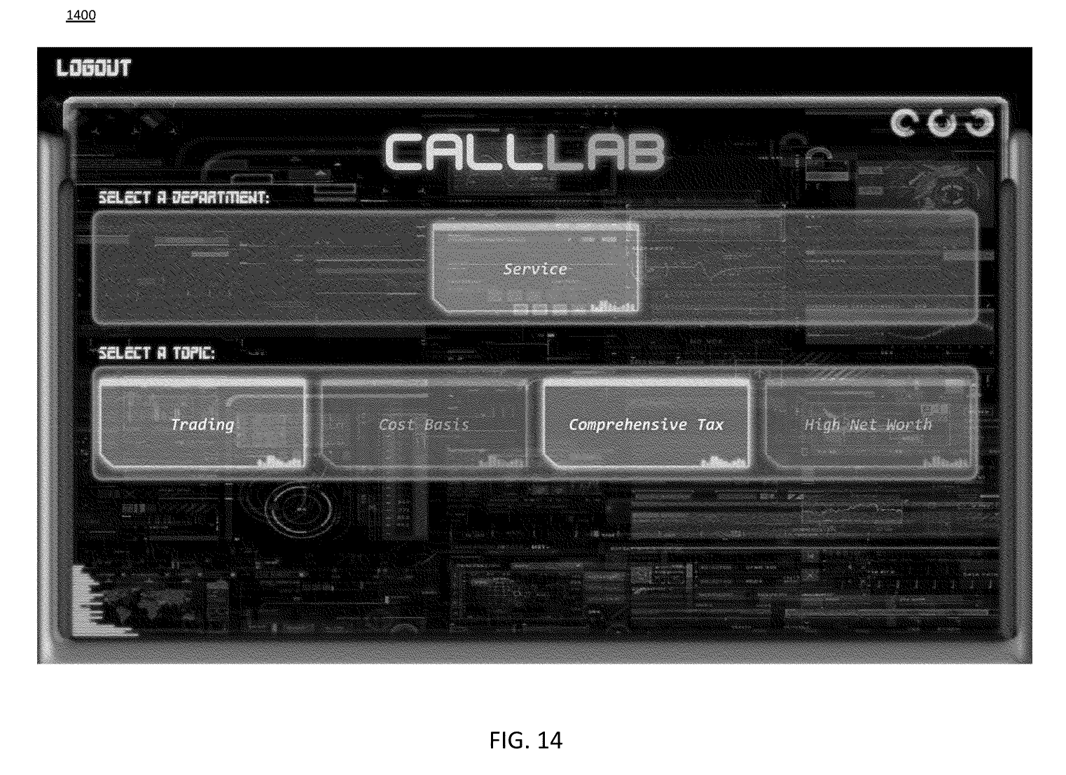

FIG. 14 shows an exemplary screen shot of a Topic Selection screen 1400 that may be next presented to the trainee. For example, if this is their first login, the trainee will be taken to this topic selection screen 1400. Each business unit can have any number of topics. Each game associated with a particular topic may have number of tiers and games per tier. An exemplary business unit here is the “service” department. Example call topics may include “Trading” or “Tax Consultation.” Topics that are inactive may be greyed-out on the screen.

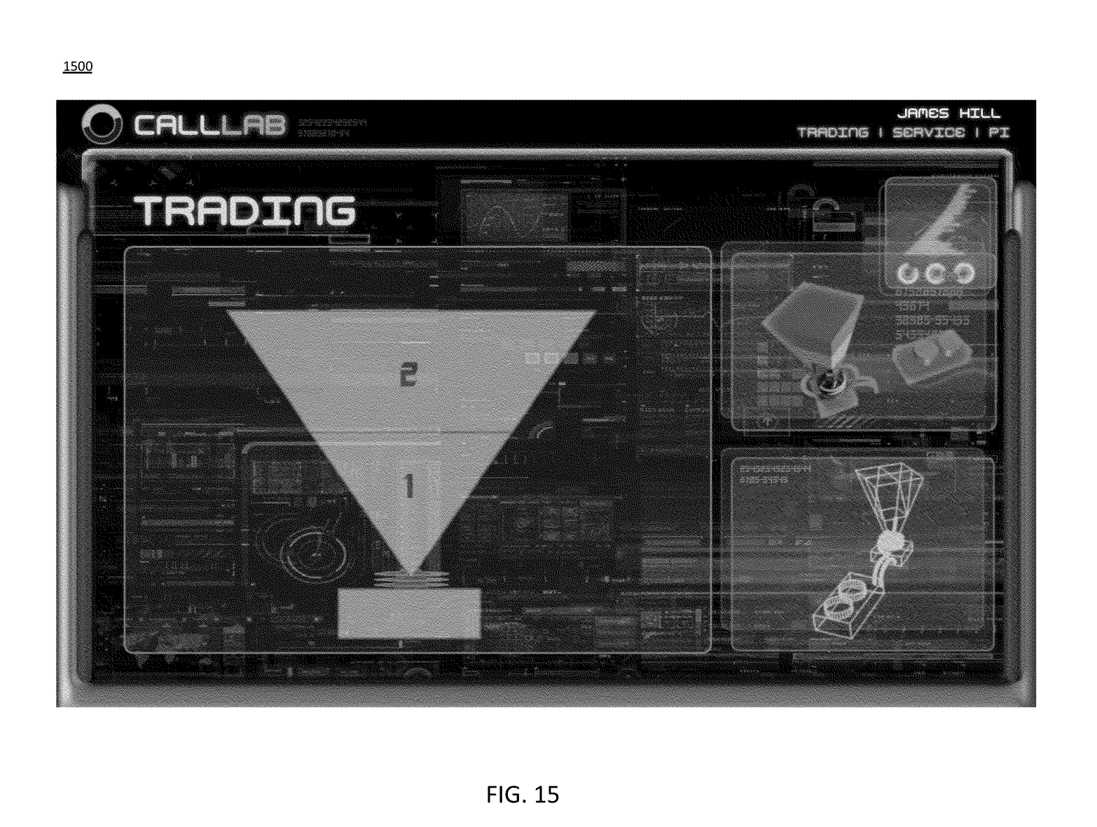

FIG. 15 shows an exemplary screen shot of a Tier Display screen 1500 that may be next presented to a trainee after the previous selection of a business unit and call topic. In this example, a game topic has been configured with two tiers that must be completed by the trainee. Topics may have a maximum number of associated tiers, such as five tiers. Each tier can have one or more games assigned to it, and each game can have its game mechanics configured depending on the goal of the game. A trainee would typically start at the bottom-most tier, i.e., tier one. Once all the games in tier one have been completed successfully, the associate is allowed to proceed to the next tier and access the games assigned thereto. At any point, the associate may also move to any “unlocked” tier and practice the games provided therein.

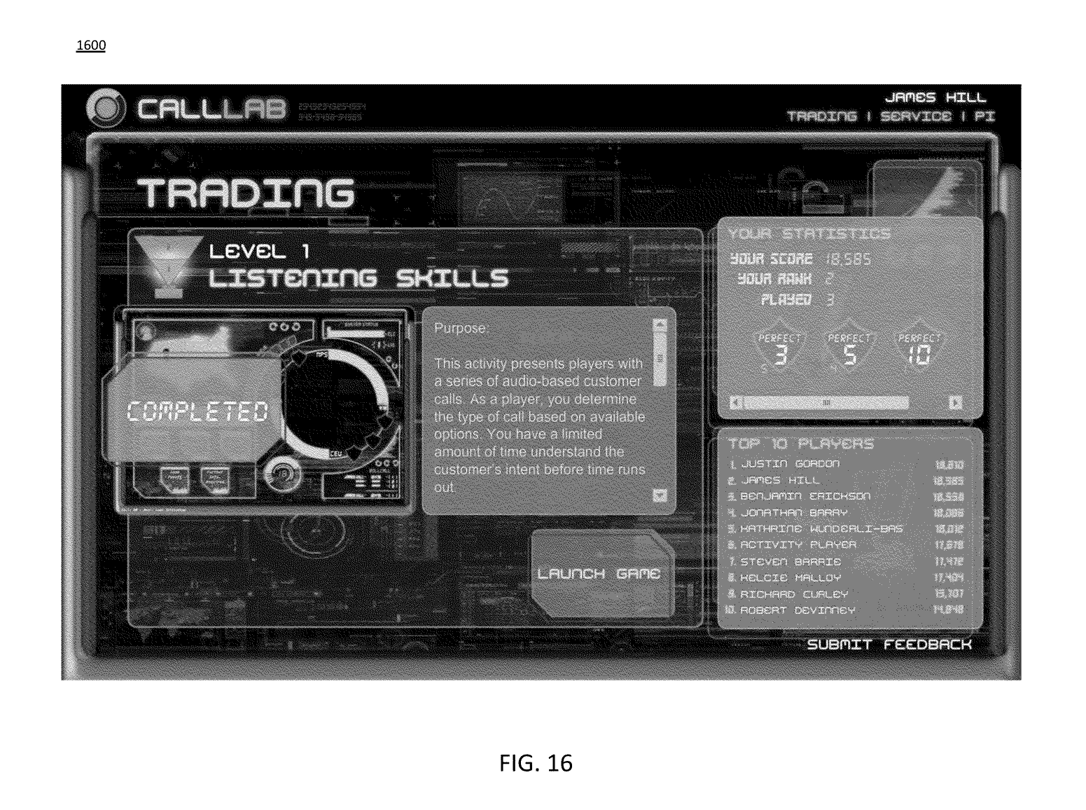

Continuing next to FIG. 16, therein is shown an exemplary screen shot of a Training Game screen 1600 presented to the trainee. In this example, a game is at tier one. It shows the status of the trainee for the game, which badges have been achieved by the trainee, the trainee's score, as well as the number of times they've played the game. It also displays a description of the game and the skillsets targeted by the game.

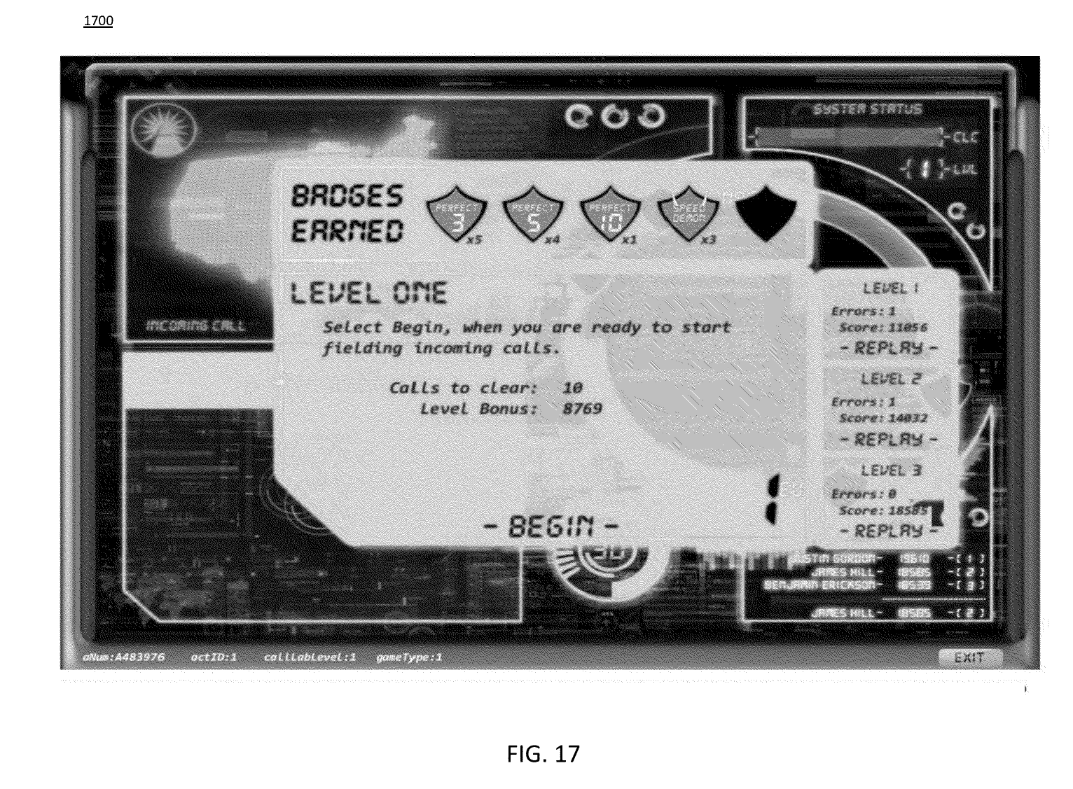

FIG. 17 shows an exemplary screen shot of a Listening and Questioning Game screen 1700. This screen 1700 represents an example of the game engine for both a Listening portion and a Questioning portion of this game. The Questioning portion, in various embodiments, may just be an extension of the Listening portion of the game. The premise of such game is to train an associate/trainee to listen and correctly identify the types of calls that typically come into the CallLab environment. The Listening portion of the game may comprise simply listening to a short portion of a call and correctly identifying its call type. The Questioning portion of the game may build on the listening aspect by asking a trainee to identify the correct responses or actions to take with respect to the identified call. As each level of a game is completed the next level may be unlocked. The trainee is shown how many incorrect responses were entered. A trainee may then choose to replay a level in order to increase their overall score. If the trainee achieves desirable scores for all levels of a game, they may be awarded a badge or other award within the game. Special awards may be presented, for example, when the trainee completes the game perfectly and within a predetermined acceptable time. The points gained from previous levels may be used to increment a timer for later levels selected by the trainee. Better scores may thereby give the trainee more time in later levels, allowing them to achieve better scores in such later levels. In addition, while a trainee may nominally pass a level, the training game may still require them to retake the level in order to achieve a better or more acceptable score.

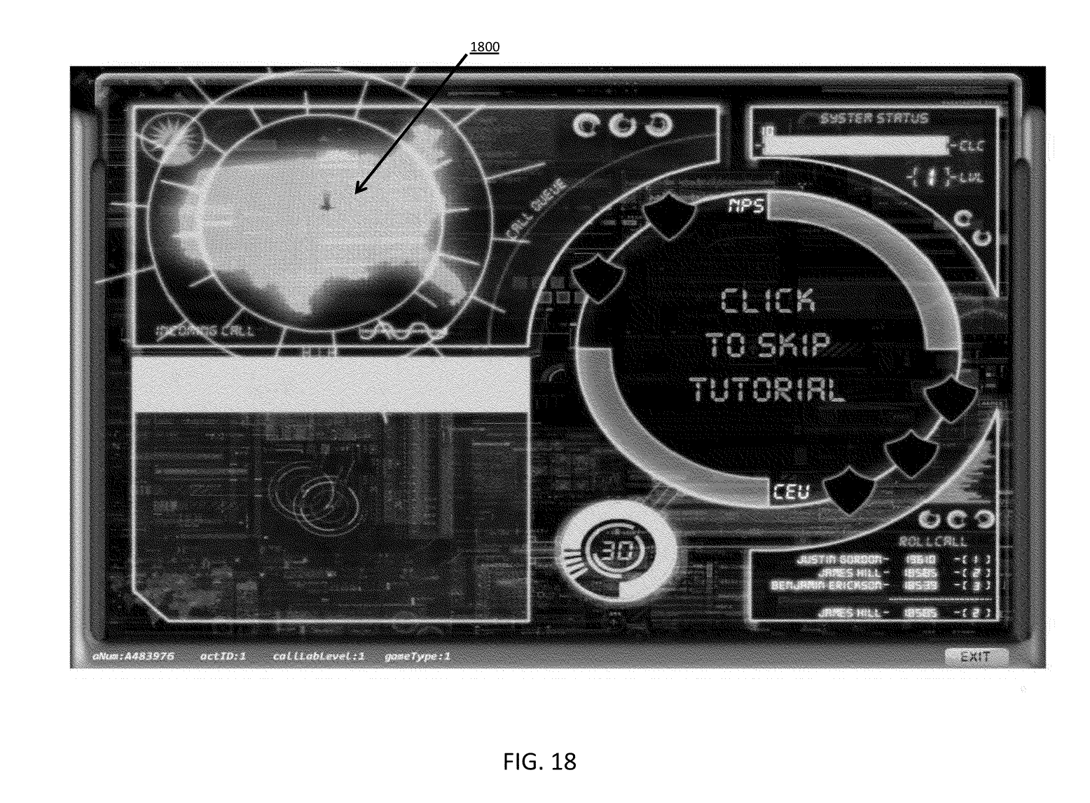

Continuing to FIG. 18, therein is shown an exemplary screen shot of the screen 1700 in which a call queue 1800 is presented within a training game. Here, the trainee must clear all the incoming calls in the game's simulated call queue 1800. Each level within a call game has a certain amount of calls that have to be cleared by answering questions about the calls correctly. Increasing levels of the game may have an increasing number of calls. As each virtual caller phones in, the caller appears on the map area within the call queue 1800. The number of spaces in the call queue 1800 may be limited (i.e., ten available spaces). Whenever there is space in the call queue, a simulated incoming call is automatically “answered” and placed on hold in the call queue 1800 for the trainee to select during the call game. Otherwise, when the call queue is full (i.e., no further available spaces), the calls may go unanswered until space in the call queue is made available. Completion of a call by the trainee removes the call from the call queue 1800.

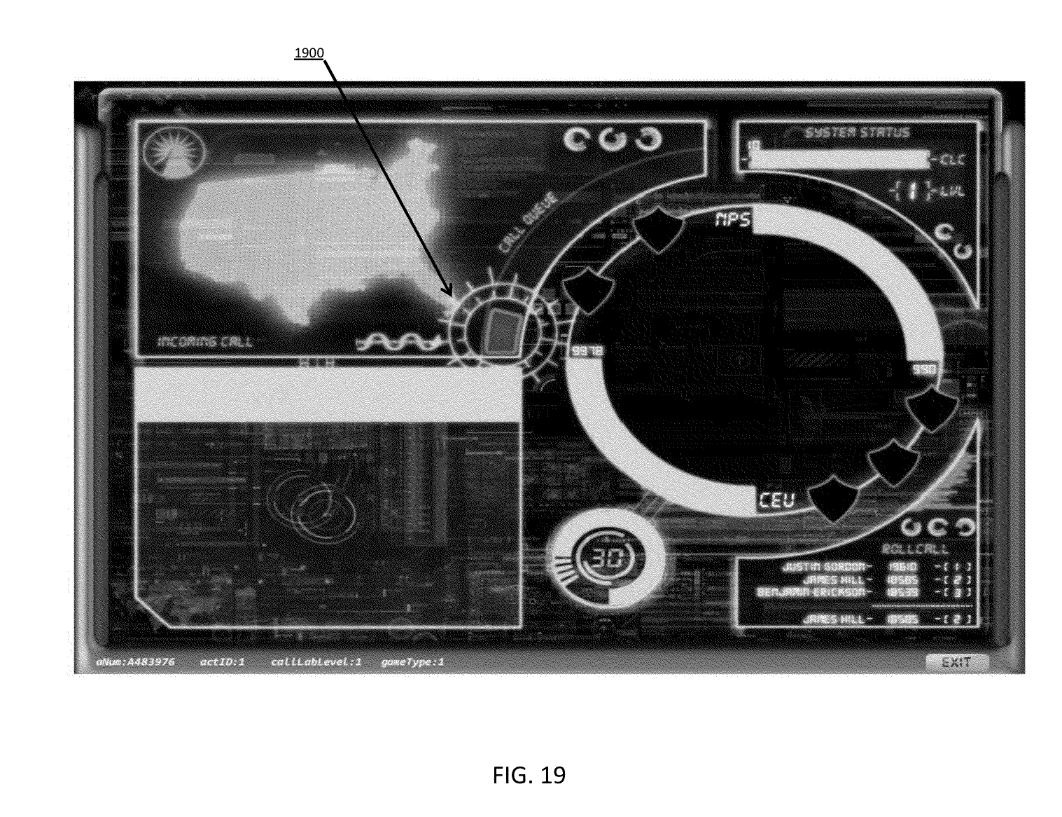

Continuing to FIG. 19, therein is shown an exemplary screen shot of the screen 1700, in which one call 1900 has been selected from the call queue 1800. A trainee's Net Promoter Score (NPS), or similar customer satisfaction index of callers in the trainee's queue, may be assessed as the trainee proceeds throughout the call game. The NPS score may relate to the calling party satisfaction with the call center's performance, which in turn, may be based on how long it takes the trainee to select and complete calls from the call queue 1800.

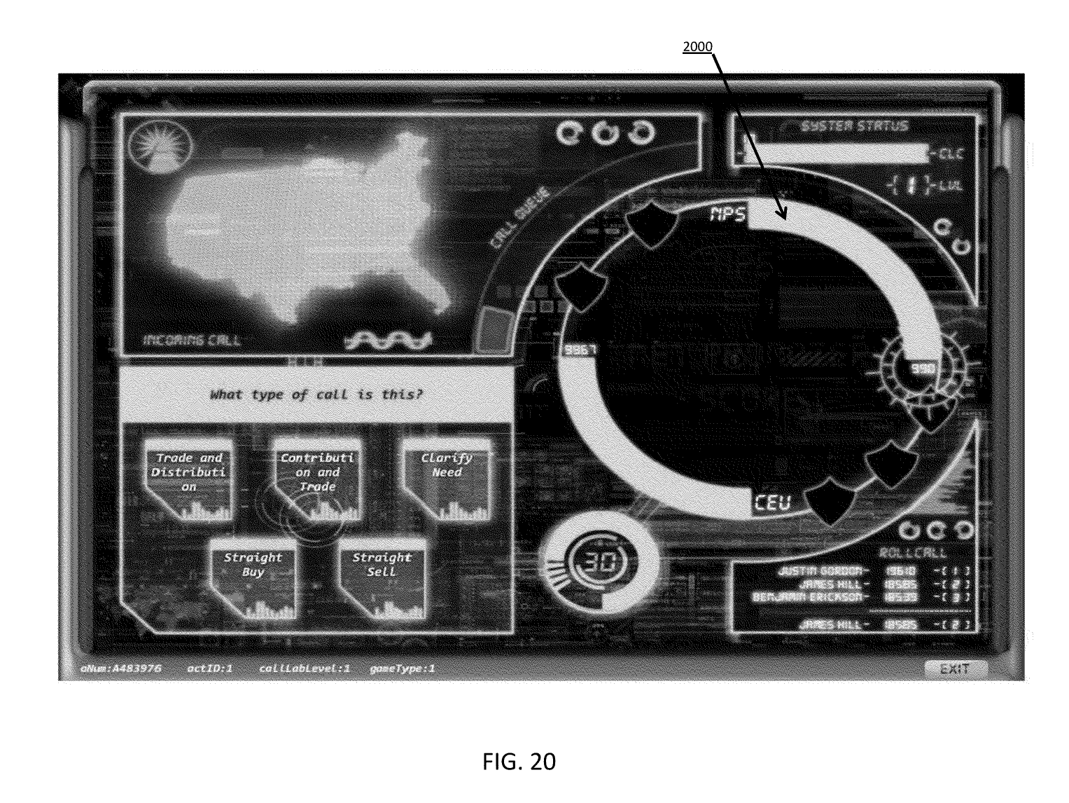

Continuing to FIG. 20, therein is shown an exemplary screen shot of the screen 1700, in which an NPS meter 2000 is presented within a call training game. The NPS meter 2000 is used to measure each of the caller's moods and satisfaction resulting from the trainee's performance during the call game. When a caller is left waiting for entry one of the limited number of slots in the trainee's call queue 1800 because the call queue 1800 is presently full, the NPS meter's value for that call decreases. While a caller is in the call queue 1800, the NPS value remains stable. When a trainee completes the call, the value on the NPS meter is given to the trainee as his/her NPS score for that call. The NPS value of calls handled by the trainee can greatly affect the trainee's performance score achieved at the end of each level in the call game.

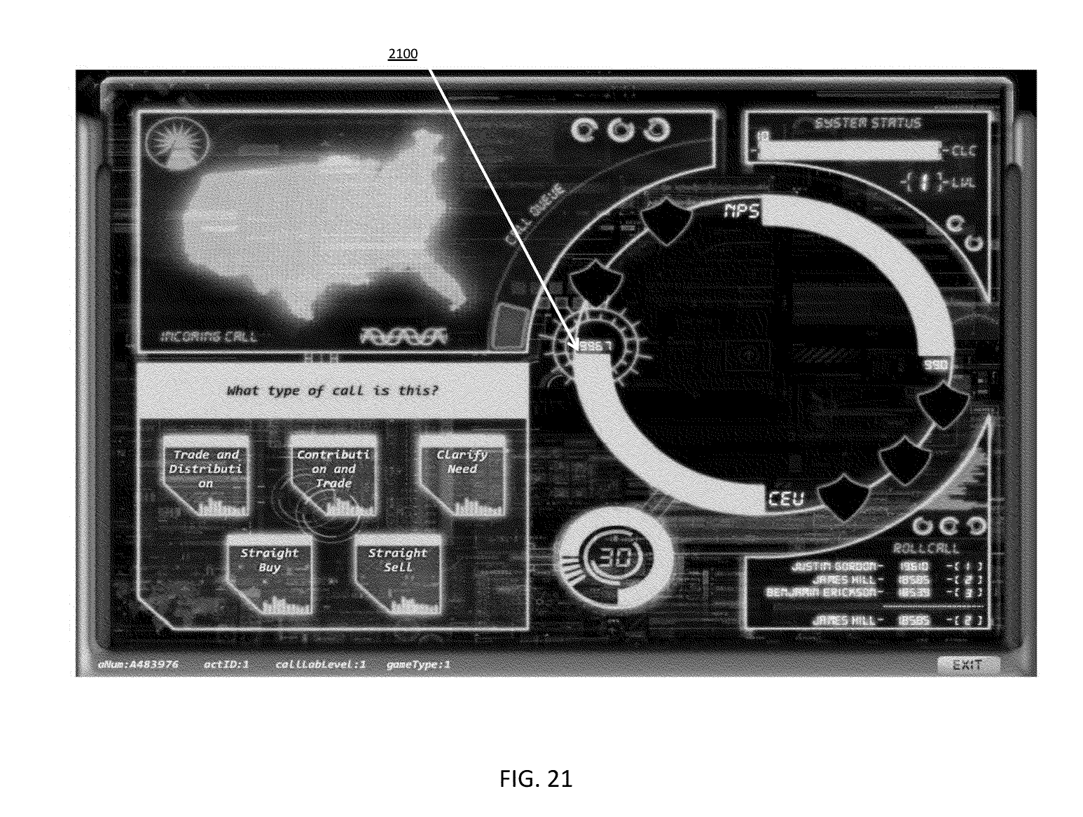

FIG. 21 shows an exemplary screen shot of the screen 1700, in which a main game timer 2100 is presented within a training game. In the example shown, the meter on the opposite side of the NPS meter 2000 is the main game timer 2100. A number of points earned by the trainee is also shown. At the commencement of level one of a training game, a trainee may be awarded an initial number of points that are continuously decremented as the game progresses. Points are therefore continuously lost over time. The trainee must then clear all calls in the call queue before they run out of such points. However, further points may also be taken away for wrong answers or incorrect actions by the trainee. Any points remaining after a trainee clears a level may be multiplied by any NPS points remaining as a reward for good overall performance. Accordingly, trainees are incentivized to answer quickly and accurately to retain as many points as they can in order to retain more points available for the countdown timers at higher levels, which in turn may have increasing levels of difficulty.

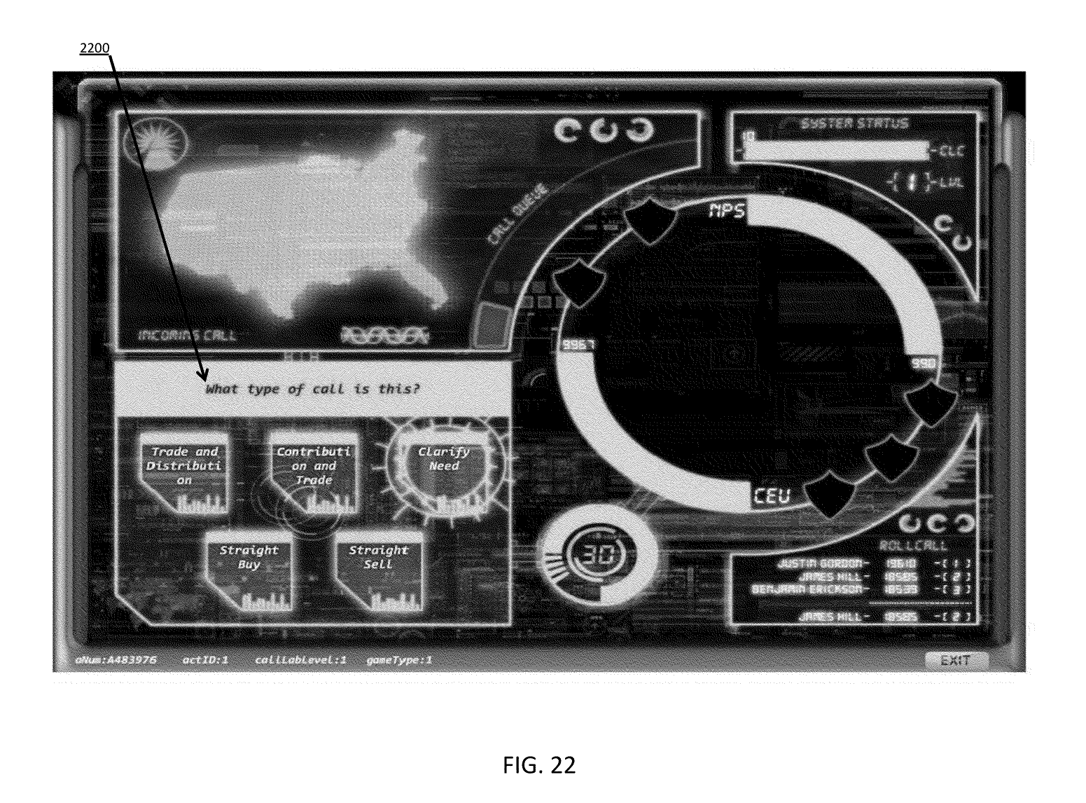

FIG. 22 shows an exemplary screen shot of the screen 1700 in which the trainee selects an answer to a question 2200 presented during the game. During a call in the game, the trainee listens to a portion of a phone call and is given a limited duration of time (i.e., 30 seconds) to respond.

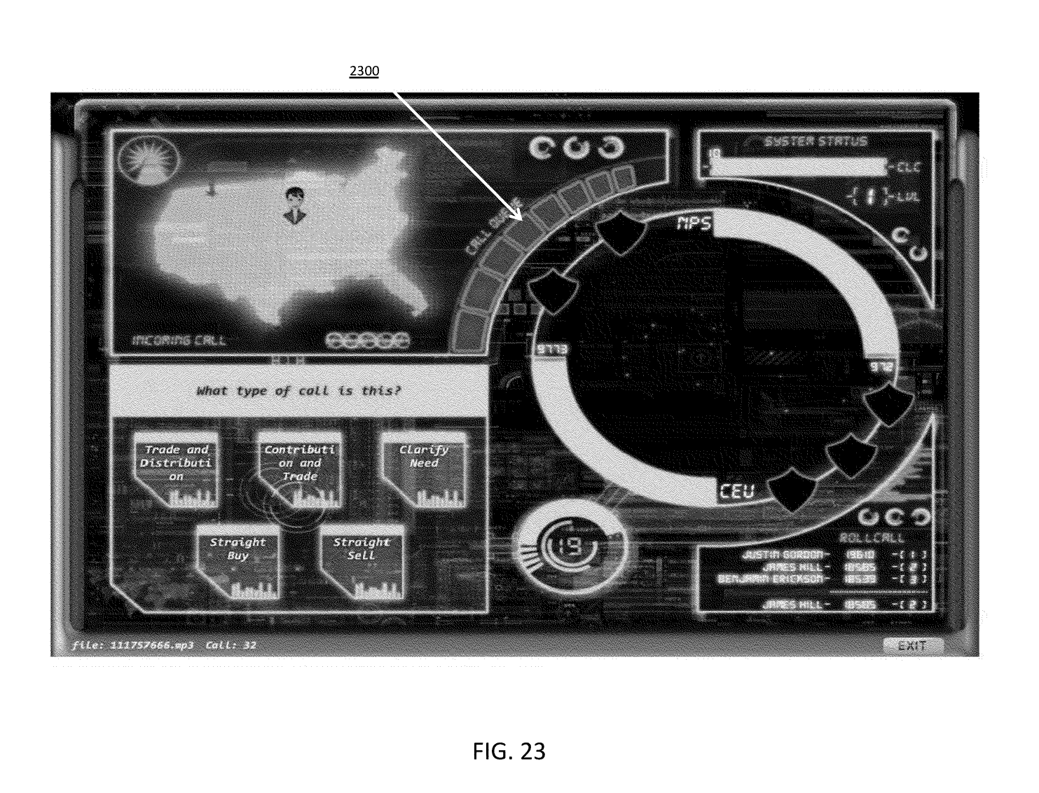

FIG. 23 shows an exemplary screen shot of the screen 1700 in which additional calls 2300 appear in the call queue 1800.

FIG. 24 shows an exemplary screen shot of the screen 1700 in which an error message 2400 is displayed to the trainee for an incorrect response or action. If a call is answered incorrectly, the error message 2400 is given as feedback. Points are also dropped from the both the main point timer and the NPS points. The call that was answered incorrectly will then be dropped and next end up back in the call queue 1800. If the trainee gets the same call wrong again, a greater amount of NPS and timer points may be deducted. This may continue until the call is answered correctly or the trainee's points run out.

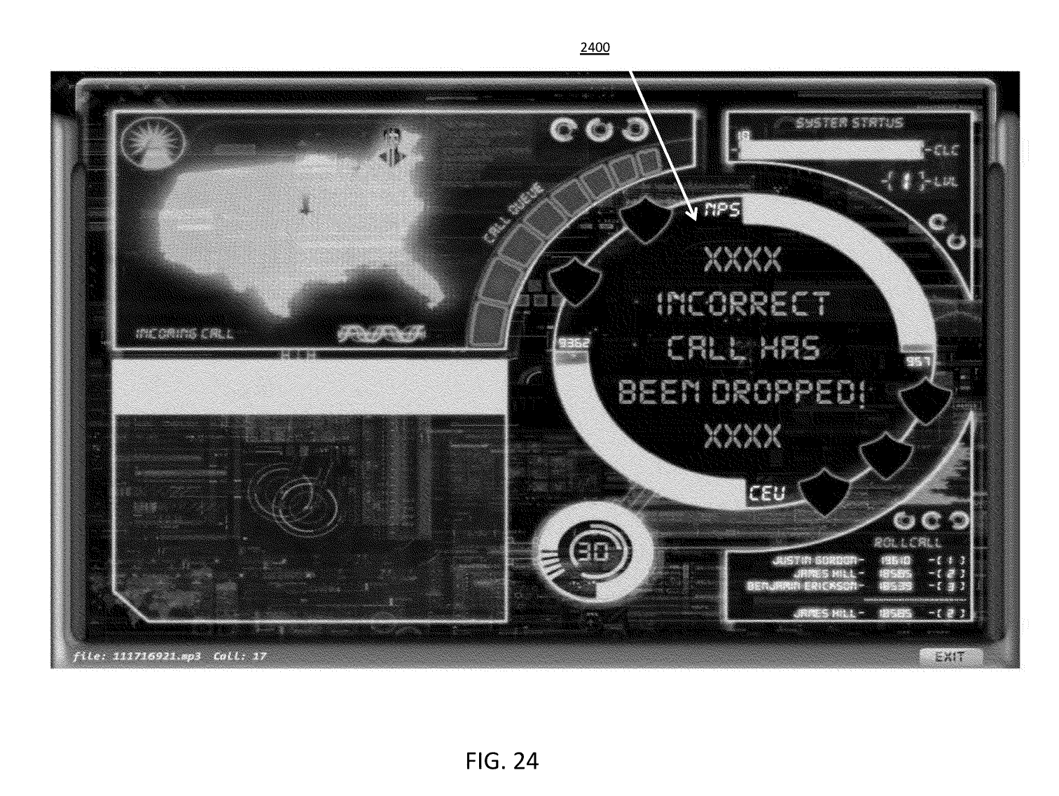

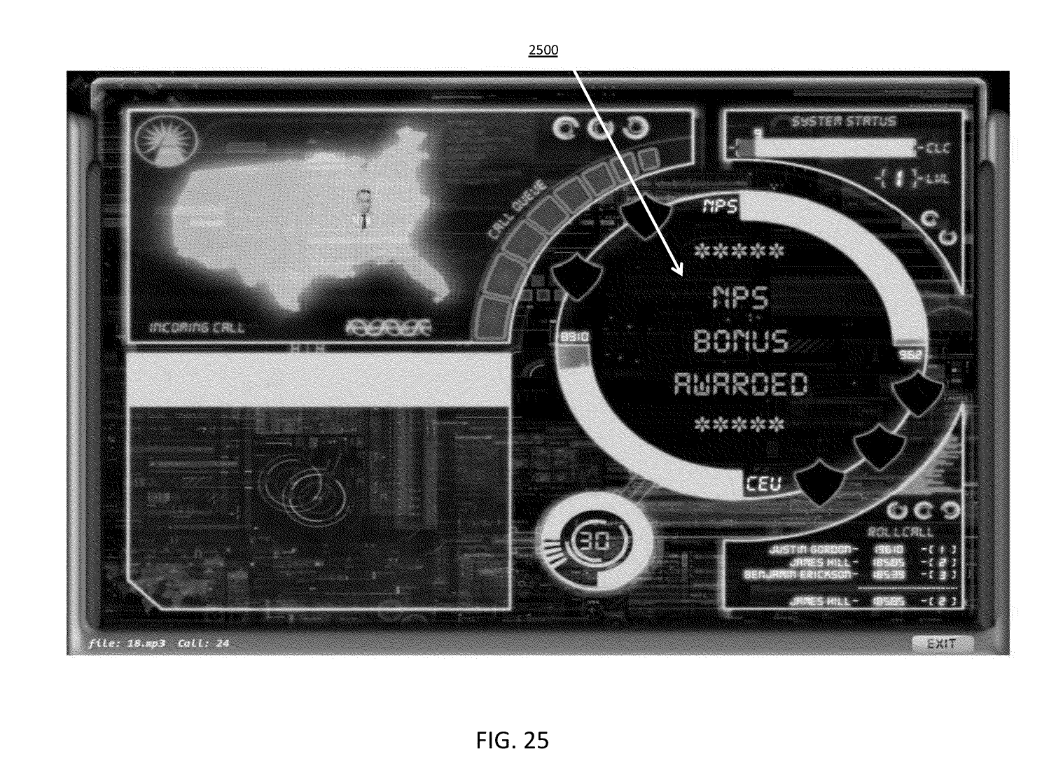

FIG. 25 shows an exemplary screen shot of the screen 1700 in which a reward message 2500 is displayed to the trainee for a correct and quick response or action. When a call is answered correctly, it is removed from the call queue 1800. If the call is answered correctly and quickly enough, the trainee may actually win back some previously lost NPS points.

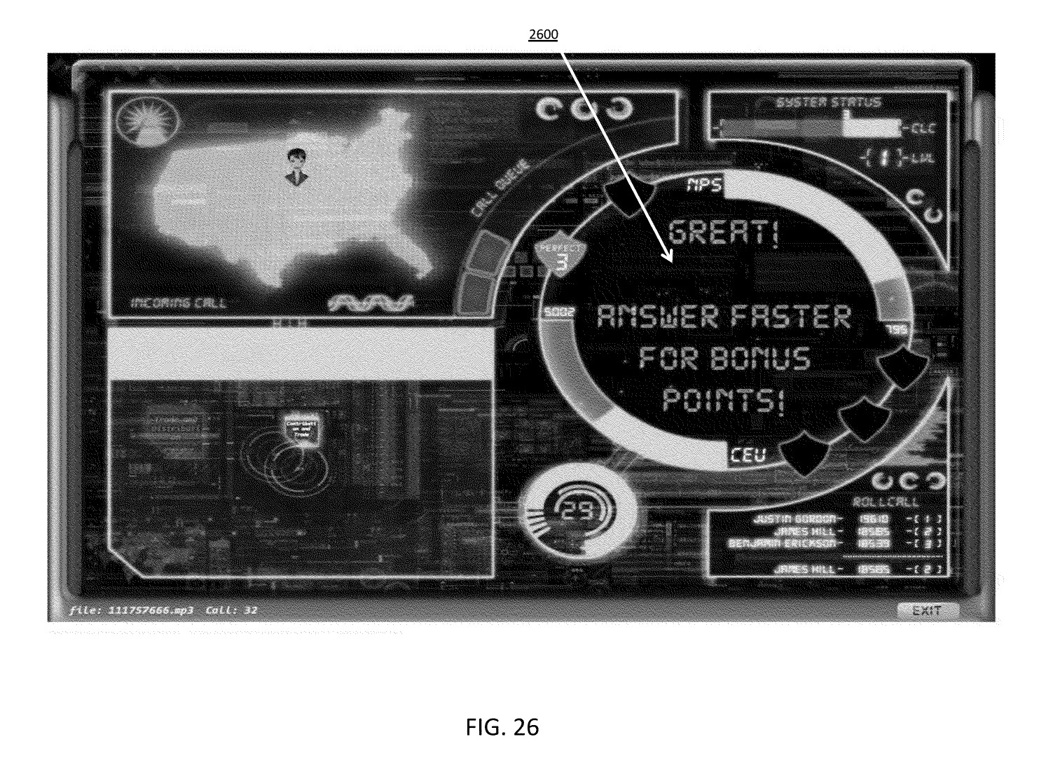

FIG. 26 shows an exemplary screen shot of the screen 1700 in which a reward message 2600 is displayed to the trainee for a correct response or action, but for which a speed bonus is not awarded based on the trainee's performance.

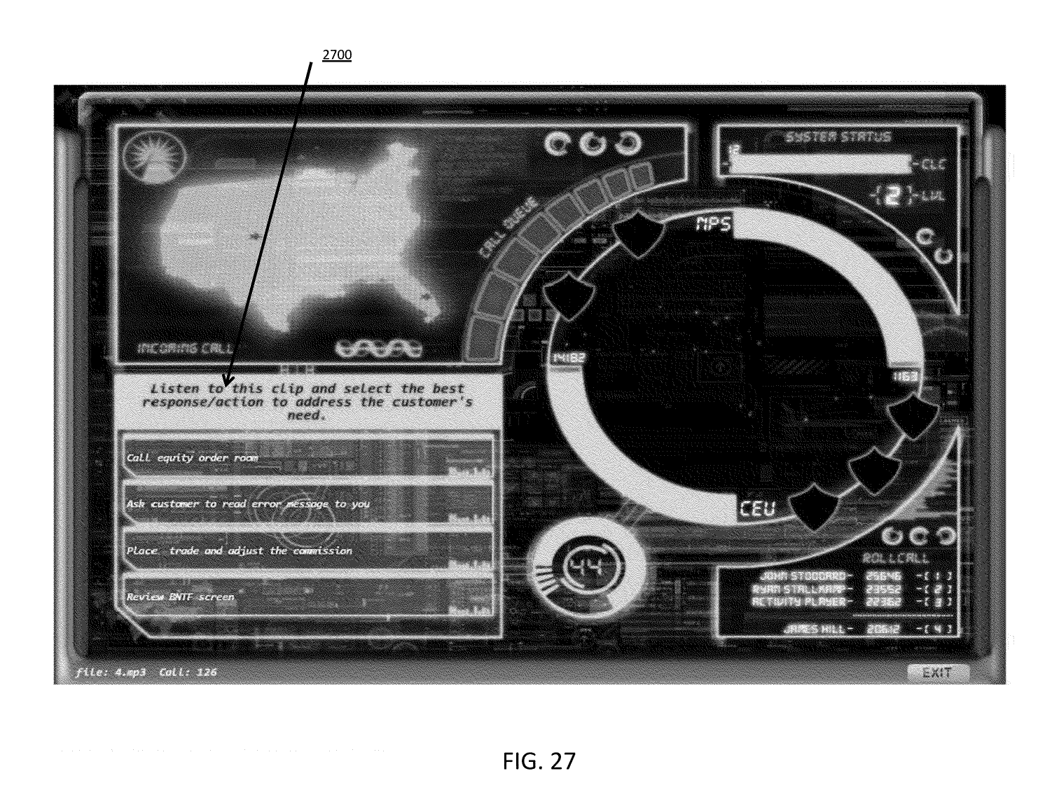

FIG. 27 shows an exemplary screen shot of the screen 1700 in which a list of possible action types 2700 is presented to a trainee for selection in response to a correctly identified call type. If a correct call type is identified in the Listening portion of the game, then during a Questioning portion of a game, the trainee is then asked to select the correct response or action for that call type in the form of a question to be answered. The list of possible responses is generated from a database of stored responses that may, for example, be selected at random. Each call type has a bank of responses specific to that call type, which may be stored in the Database Server 104. The Questioning portion of the Listening and Questioning game may appear in early levels of the game, but may be turned off or eliminated in later levels. Points may be awarded as for the Listening portion of the game as described previously above.

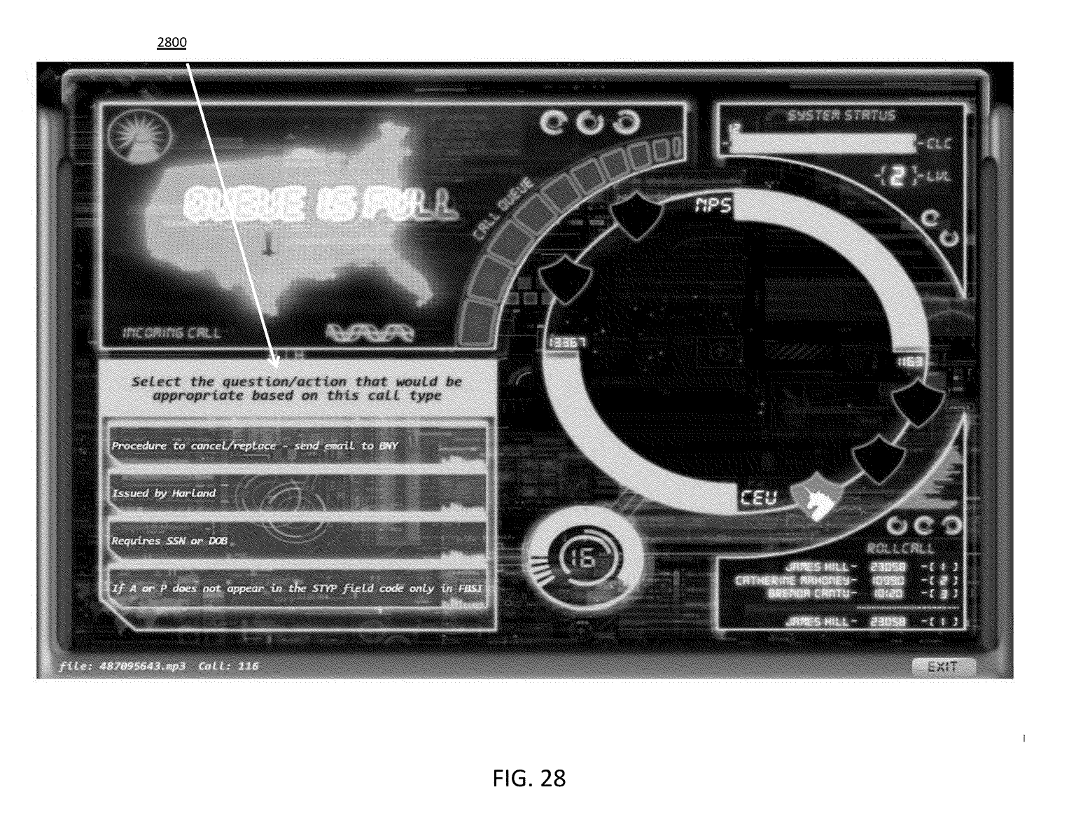

FIG. 28 shows an exemplary screen shot of the screen 1700 in which a list of possible responses to a custom question 2800 is presented to a trainee for selection during the game. In the Questioning portion of the game, a custom question may appear after the call type has been correctly identified (triaged) in the Listening portion and the best response/action has been previously correctly selected. The trainee is played a different clip of the same call listened to earlier. The trainee is then required to select the most appropriate question or action to use based on what was heard in the clip. These responses can be weighted, for example, on a scale of Best, Better, Good and Incorrect, with the best responses being the only “correct” responses. The weighting applies only to the amount of lost points and NPS points the trainee loses when they click on a response other than the Best response. Incorrect answers would then result in the most points lost. A call may not be cleared from the trainee's call queue 1800 until a certain number of the aspects of the call have been correctly identified.

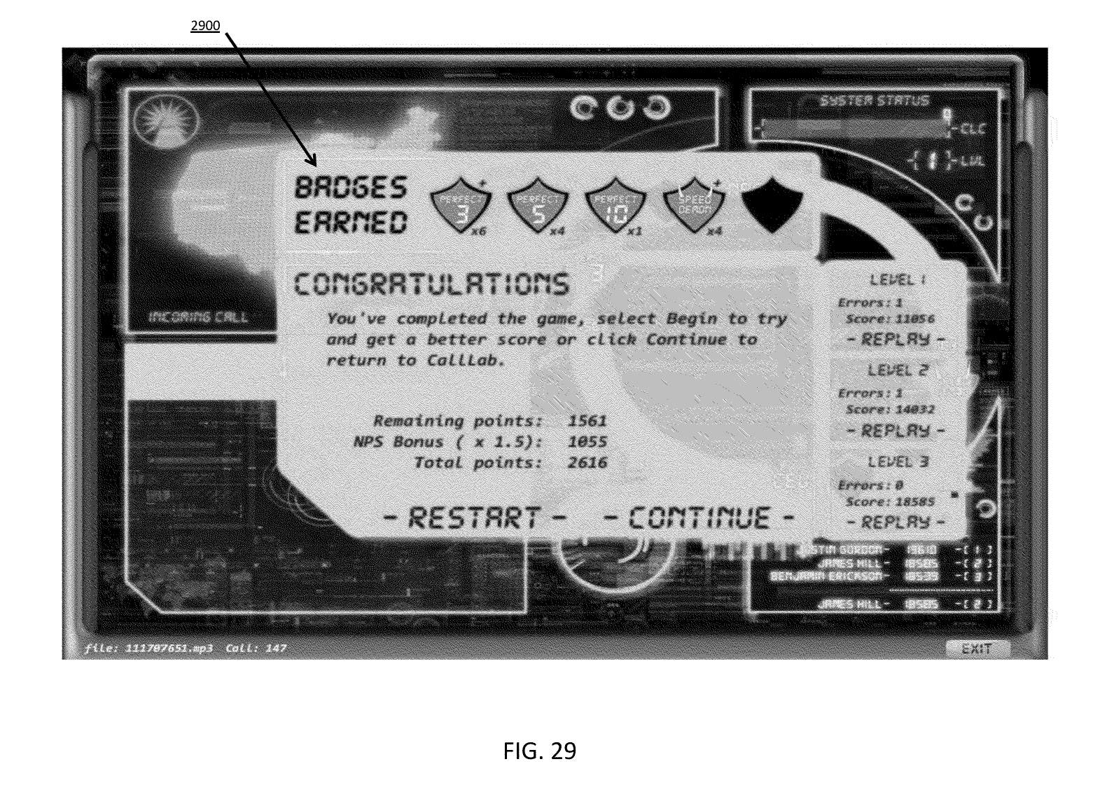

FIG. 29 shows an exemplary screen shot of the screen 1700 in which a level completion message 2900 is presented to a trainee upon completing a level of the training game. At the end of each level, a breakdown of the points they scored may be displayed to the trainee. They can choose to replay a level and finish with more points to help them in later levels, or they may attempt the next level of the game.

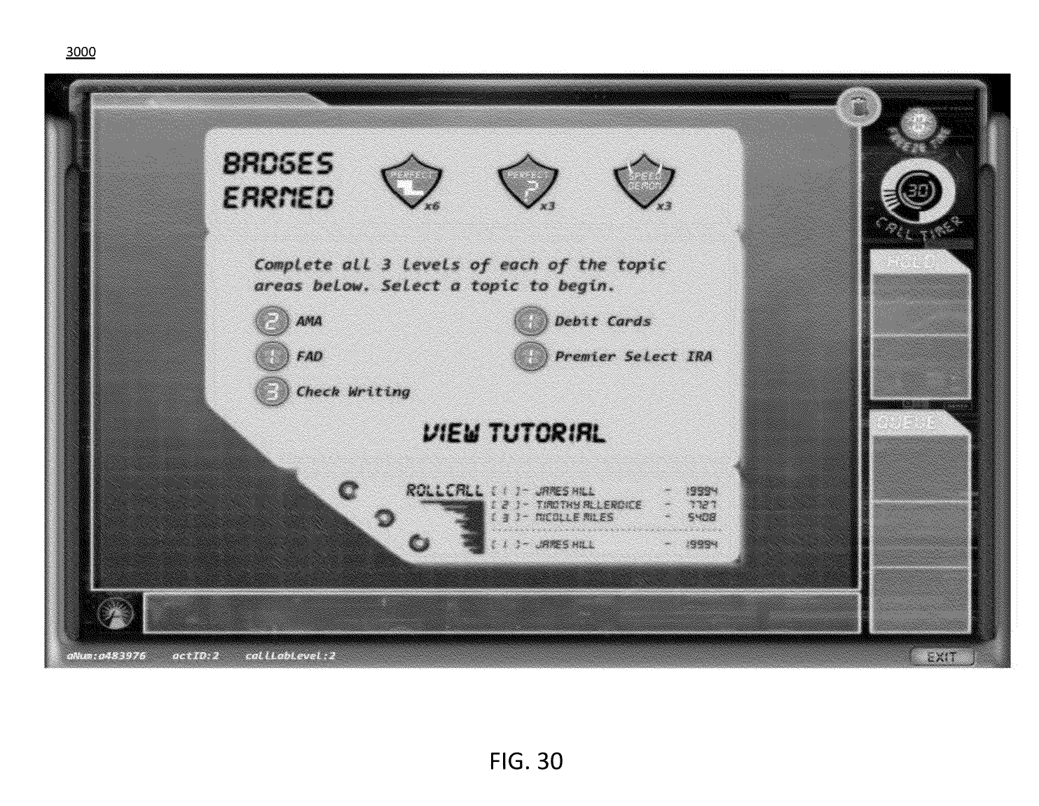

Turning now to FIGS. 30-39, therein are depicted an exemplary sequence of screen shots from a Screen Puzzle game. FIG. 30 shows an exemplary screen shot of an initial Screen Puzzle game display 3000, which is displayed during an initiation of a Screen Puzzle game that may be played by a trainee. The Screen Puzzle game may target memorization and familiarity of actual CallLab center screens used by call center operators during live calls with customers.

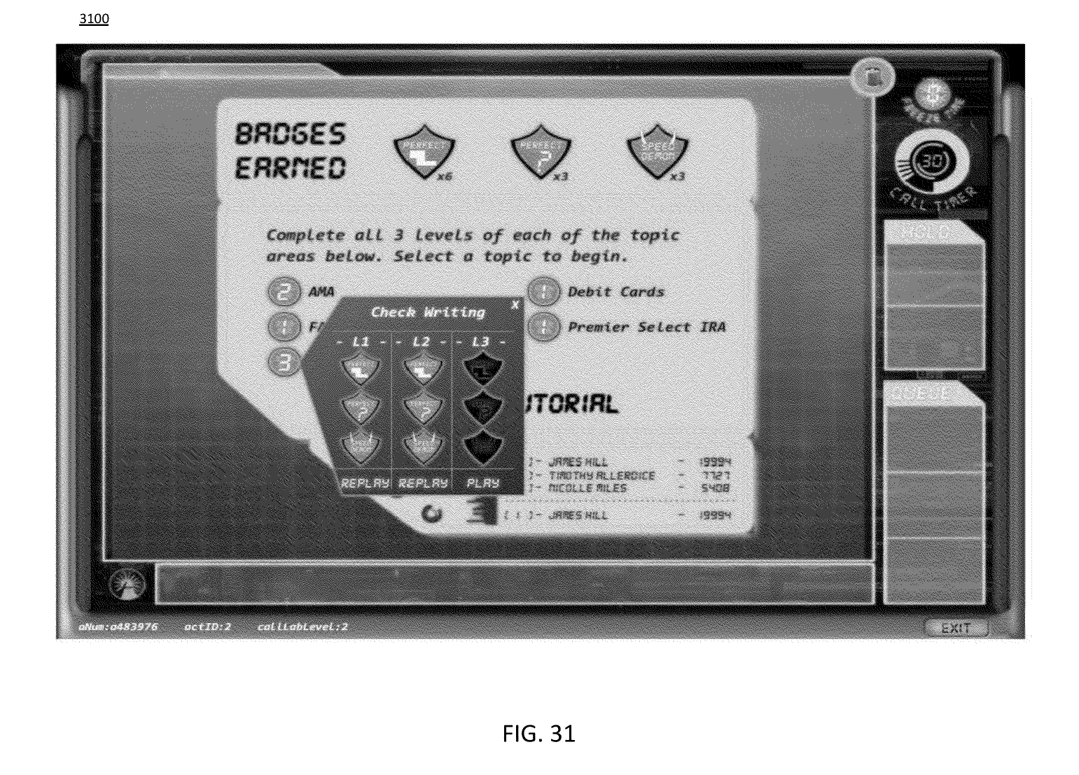

FIG. 31 shows an exemplary screen shot of the Screen Puzzle game in which a menu screen 3100 of the Screen Puzzle game is presented to a trainee. Each of the call types are identified as a menu item of the menu screen 3100. Each call type may have multiple levels (i.e., three levels) that must be completed successfully before the game is complete. Each call type has a determined number of badges that can be earned by the trainee. The badges awarded may help an administrator determine the quality of a trainee's performance during the game.

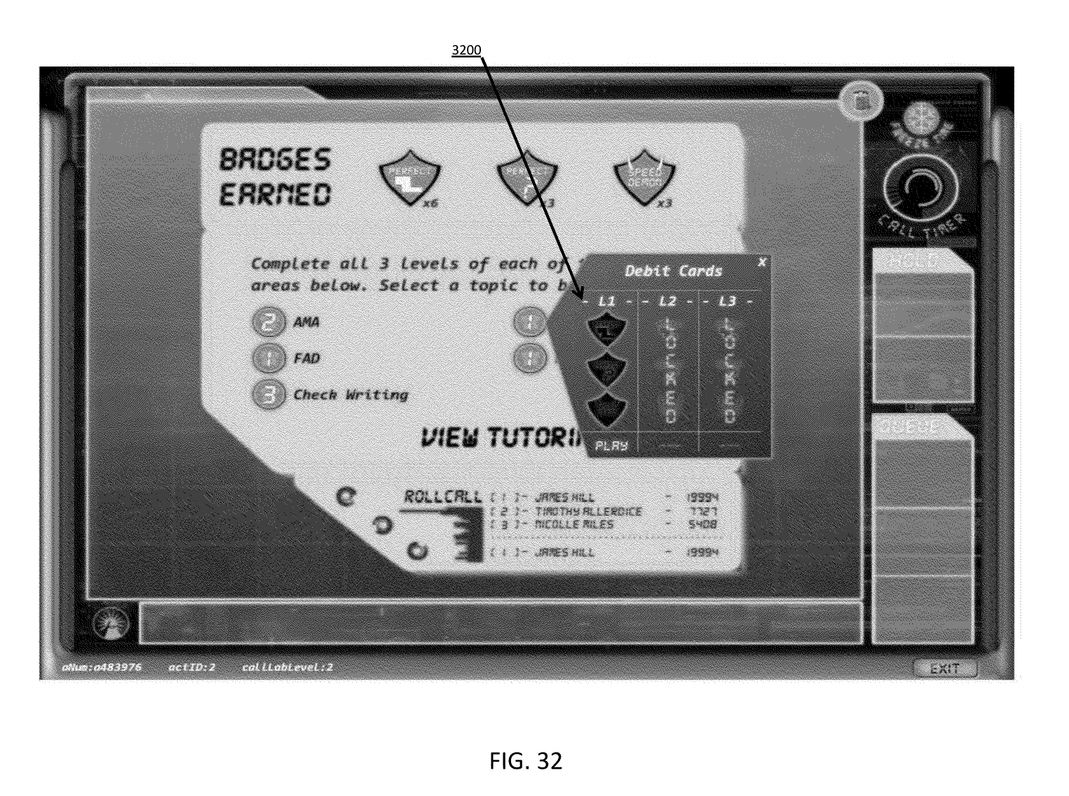

FIG. 32 shows an exemplary screen shot of the Screen Puzzle game in which an unlocked level 3200 appears. Level one of this game may be initially unlocked for all call type for the trainee. Higher levels may be unlocked by successfully completing a prior level.

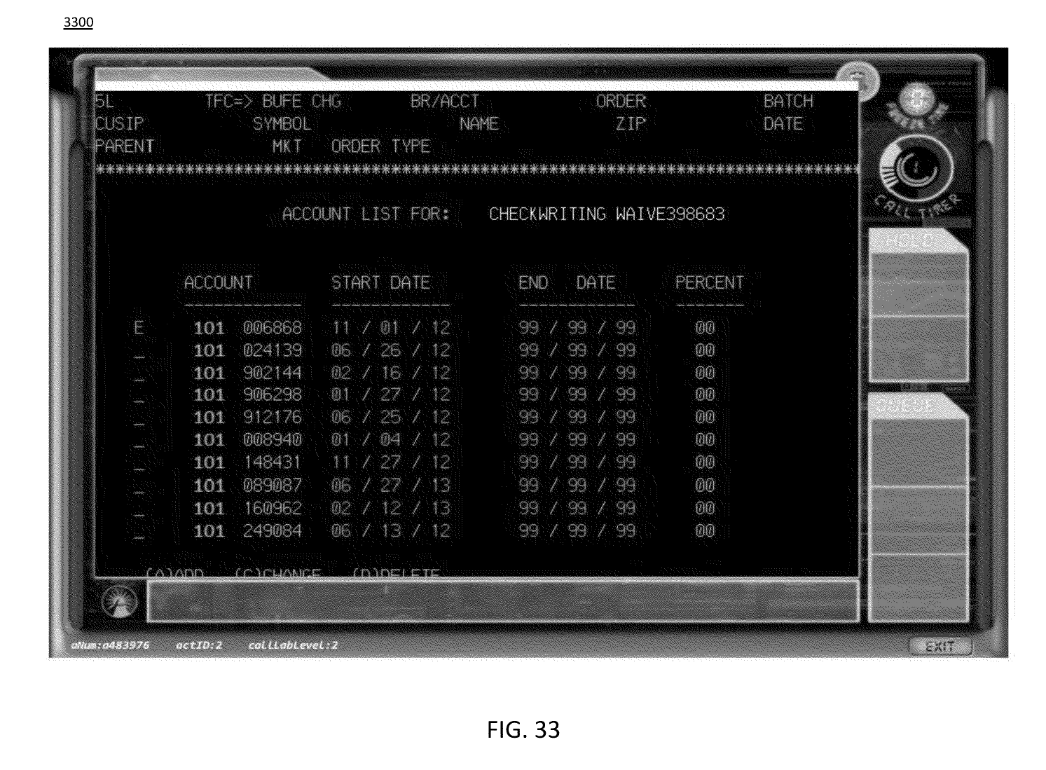

FIG. 33 shows an exemplary screen shot of the Screen Puzzle game in which a view of a Completed Puzzle screen 3300 is presented to the trainee during the game. When a trainee selects a call type to play during the Screen Puzzle game, the Completed Puzzle screen 3300 is initially presented to a trainee for a limited duration, such as five seconds.

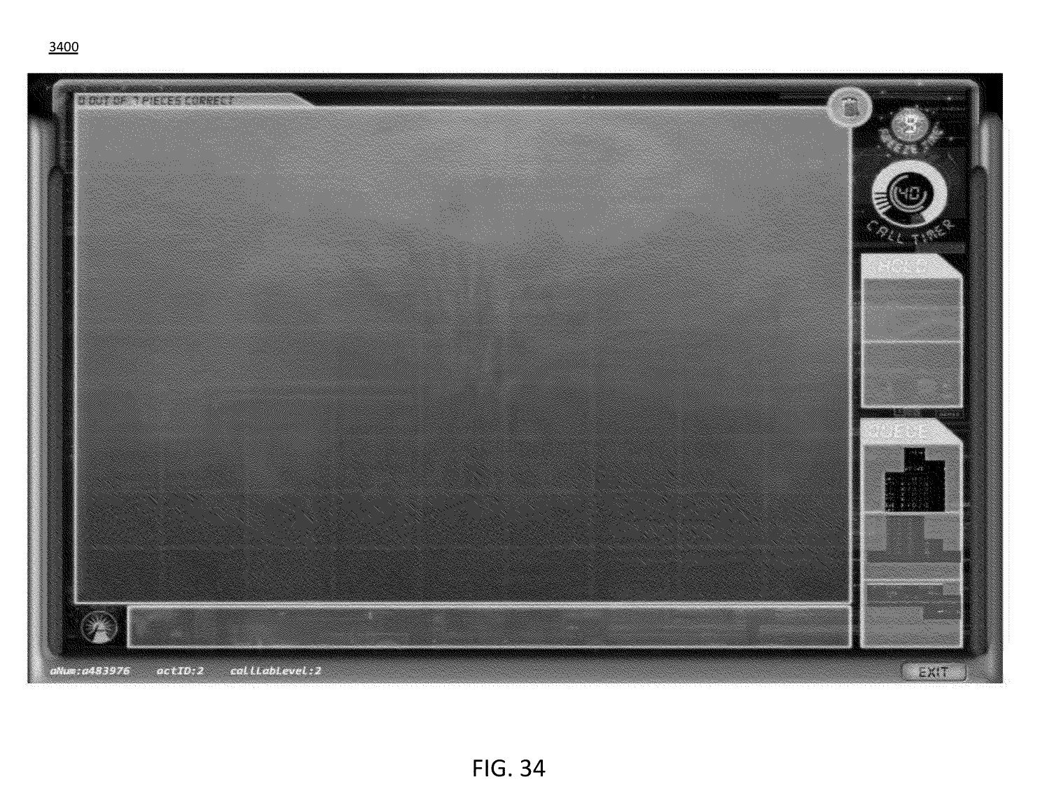

FIG. 34 shows an exemplary screen shot of the Screen Puzzle game in which a Puzzle screen 3400 is displayed to a trainee. When the limited duration from the previously described screen 3300 expires, that screen 3300 is divided up into a number of puzzle pieces or tiles and placed in a tile stack as shown in the lower right corner of the Puzzle screen 3400. The trainee must attempt to build the screen 3300 back up again by dragging the correct puzzle pieces on to the correct locations of the Puzzle screen 3400. If a piece is placed correctly on its first try, they may earn special points or badges. The trainee can see whether they have placed a piece correctly by looking at their score, which is shown in the top left corner of the Puzzle screen 3400.

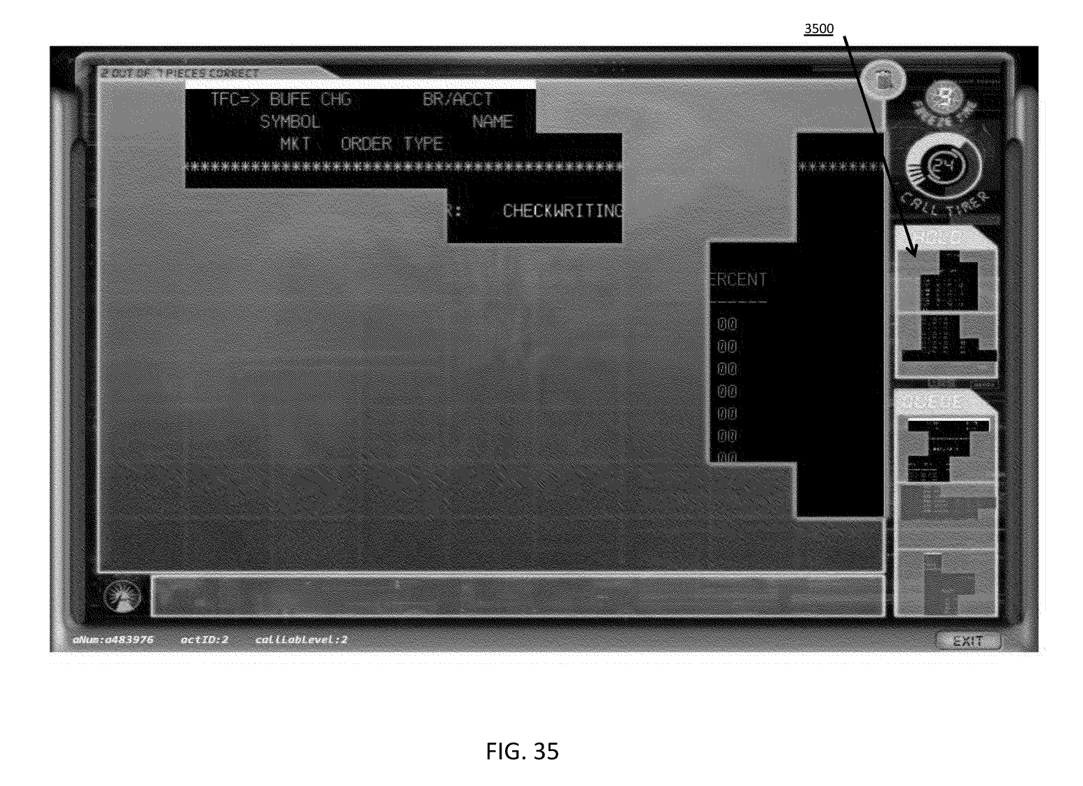

FIG. 35 shows an exemplary screen shot of the Screen Puzzle game in which a hold area 3500 is presented to the trainee during the game. As the trainee builds the puzzle by placing puzzle pieces, they are given some resources to further assist them. The hold area 3500 allows them to keep a puzzle piece in play without placing it on a position on the Puzzle screen 3400. If a trainee encounters a piece that is problematic to them, they may place it in the hold area 3500 for later re-selection. The trainee may alternately return the puzzle piece to the tile stack, and the game may re-present that puzzle piece to the trainee at a randomly-selected later point in the game.

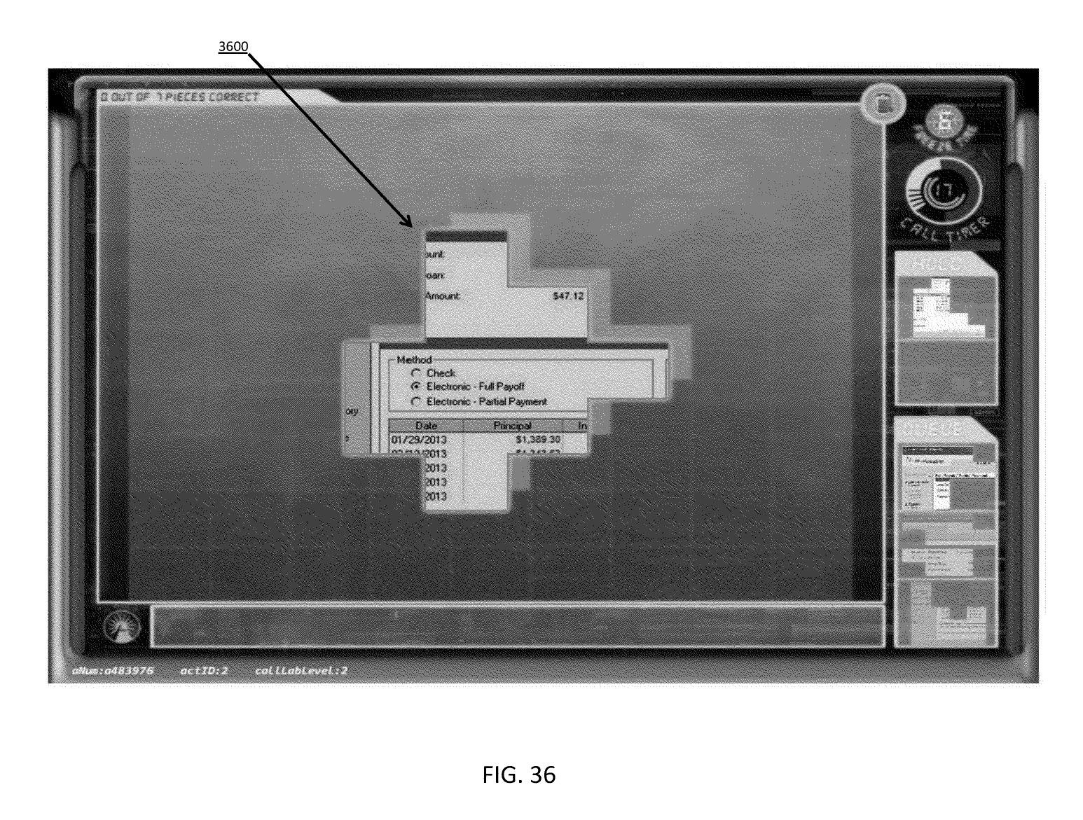

FIG. 36 shows an exemplary screen shot of the Screen Puzzle game in which a puzzle piece 3600 has been placed on the Puzzle screen 3400 by the trainee during the game. Each call type may have different content for use as puzzle pieces. The content may be chosen from a database for the game as described previously herein. Each increasing level of this game may be made increasingly difficult by further restricting the time to complete the puzzle piece placement and by making puzzle pieces smaller and more numerous.

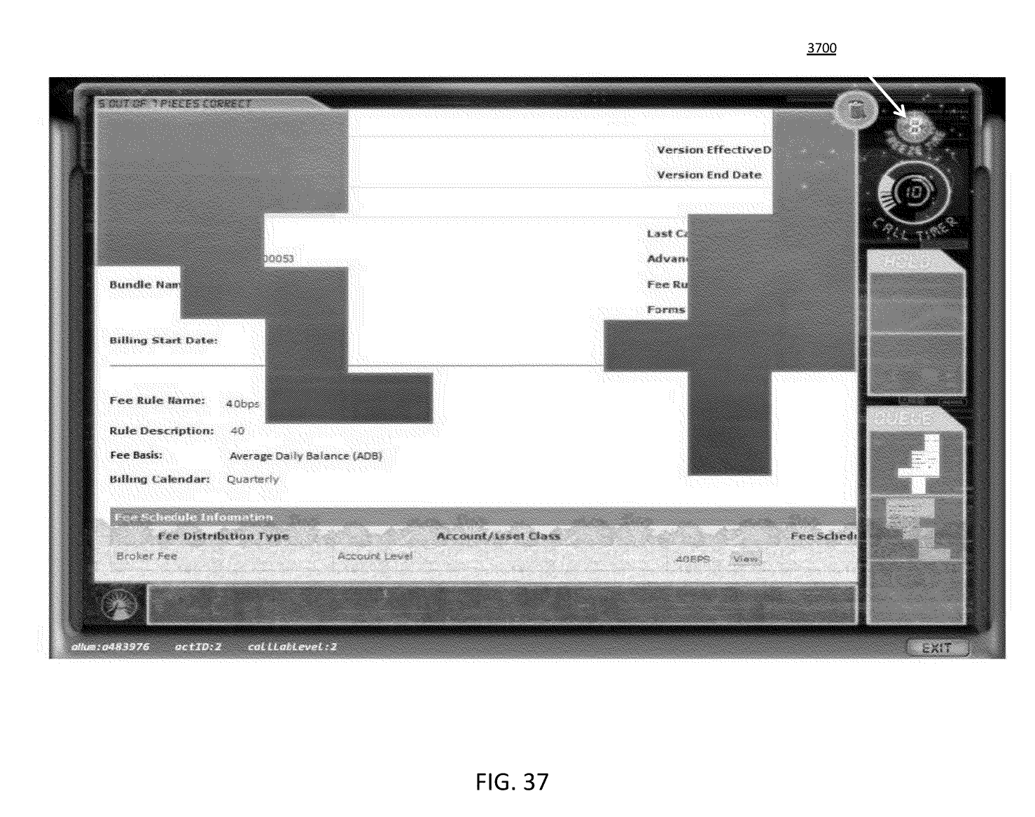

FIG. 37 shows an exemplary screen shot of the Screen Puzzle game in which a power-up tool 3700 is presented to the trainee during the game. In one embodiment, the power-up tool 3700 may, for example, allow the trainee to freeze the timer during a level of the game. This gives the trainee a small window in which to try to catch up and finish the puzzle without tolling the game timer. The power-up tool 3700 generally needs to be recharged after use, and there may only be a limited number of power-ups provided in each level. However, playing the game and winning points for perfect placement of puzzle pieces, answering questions correctly and doing so promptly can mean that the trainee gains enough points to earn back power-up tools 3700. Such game mechanics incentivize a trainee to play levels again, regardless of whether they've won all badges or not. By playing easier levels, trainees can win more power-up tools 3700 to help them with later, harder levels, thus giving them exposure to more advanced puzzle screens.

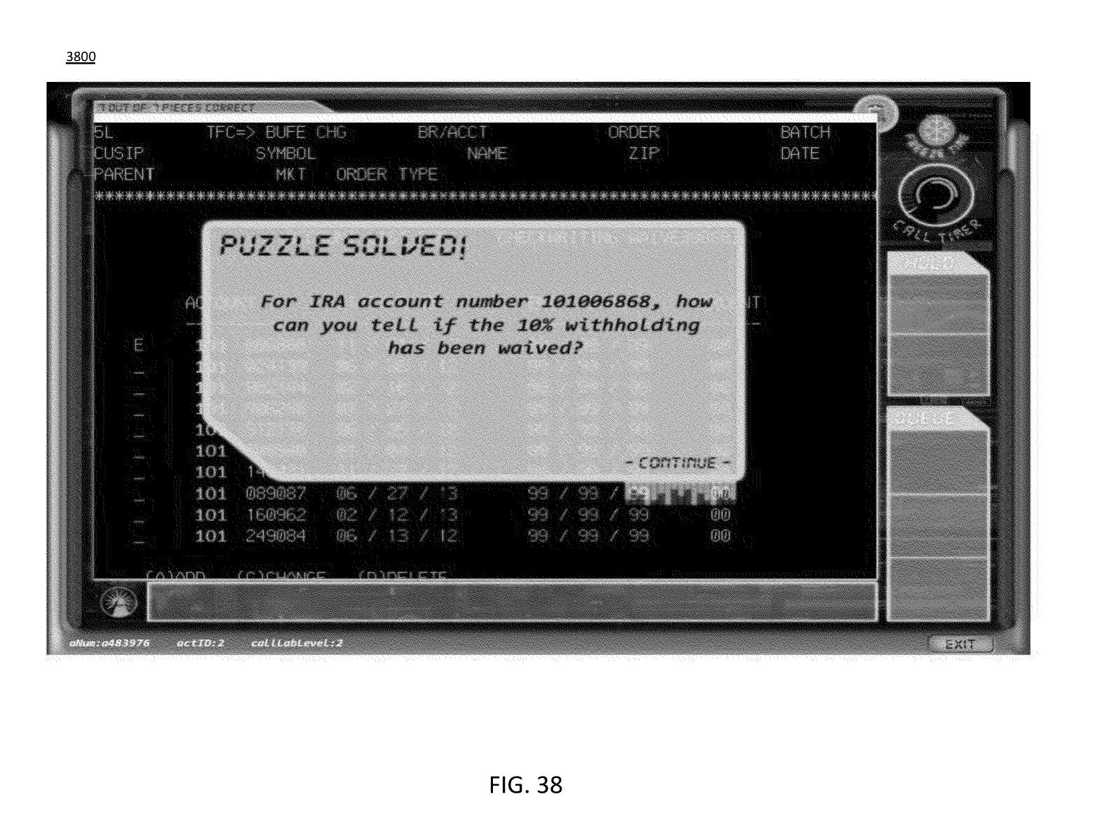

FIG. 38 shows an exemplary screen shot of the Screen Puzzle game in which a Level Completion screen 3800 is displayed to the trainee upon completion of a level of the game. When a puzzle has been successfully completed, the trainee may be asked a question about the completed puzzle screen, which requires them to click on a correct area of the completed puzzle screen. Each screen may have one or more correct spots for a given question. The number of questions requiring response may increase with increasing levels or tiers of the game.

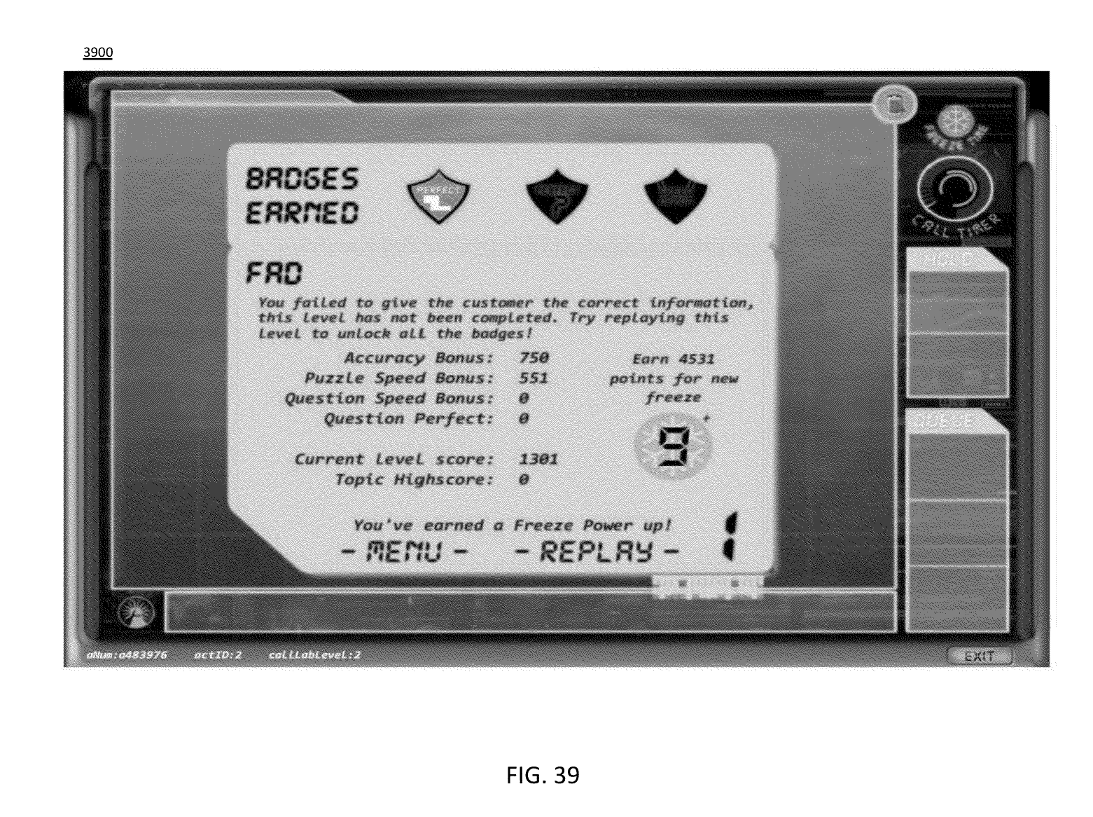

FIG. 39 shows an exemplary screen shot of the Screen Puzzle game in which an awards message 3900 is displayed to the trainee upon completion of a level or game. At the end of each level of play, the results of the trainee's performance are displayed to them, showing them points won as well as badges and any power-ups awarded.

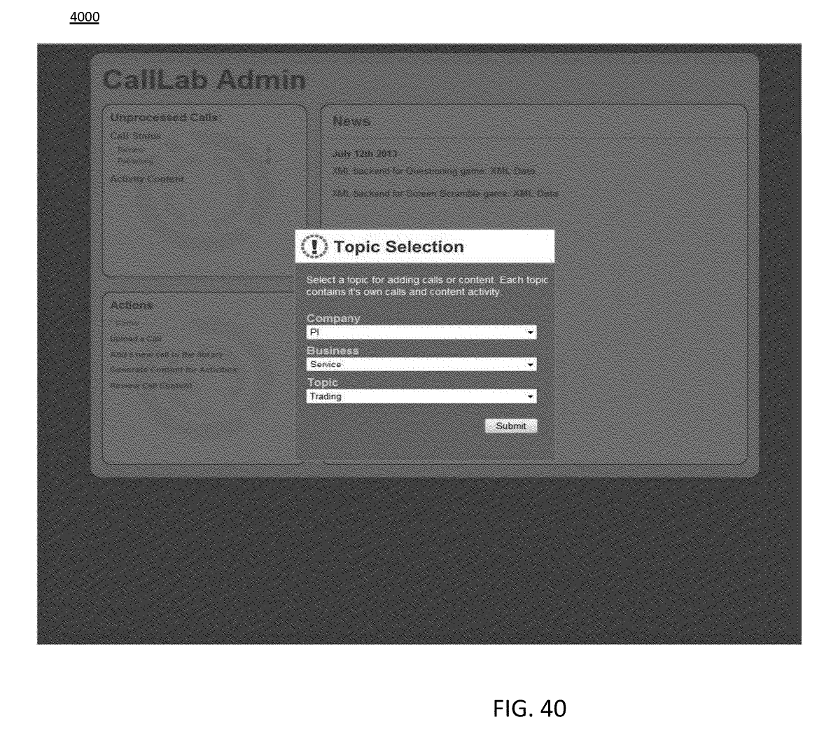

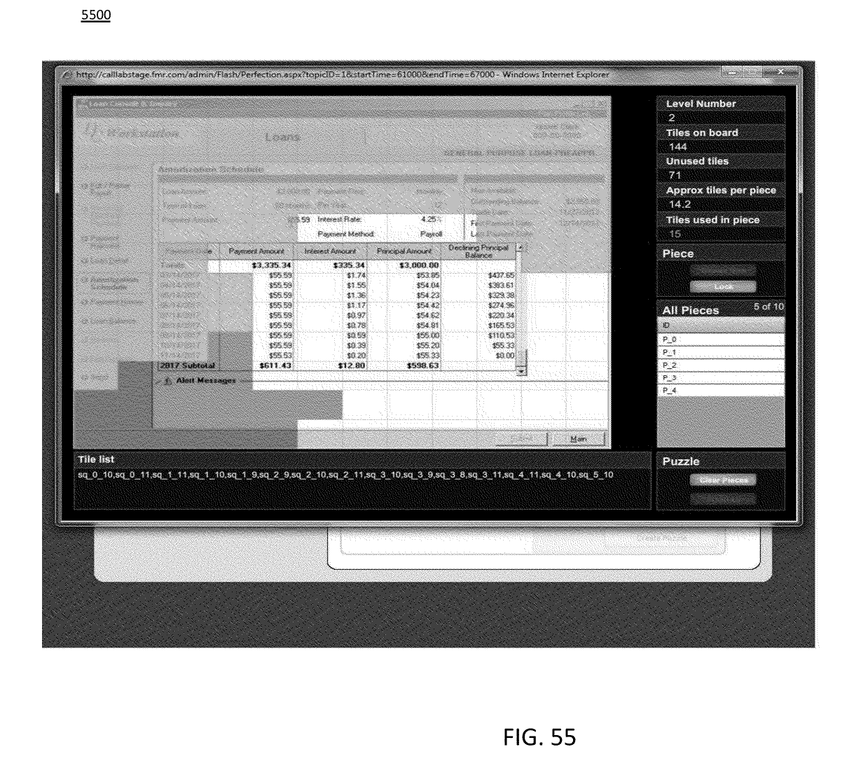

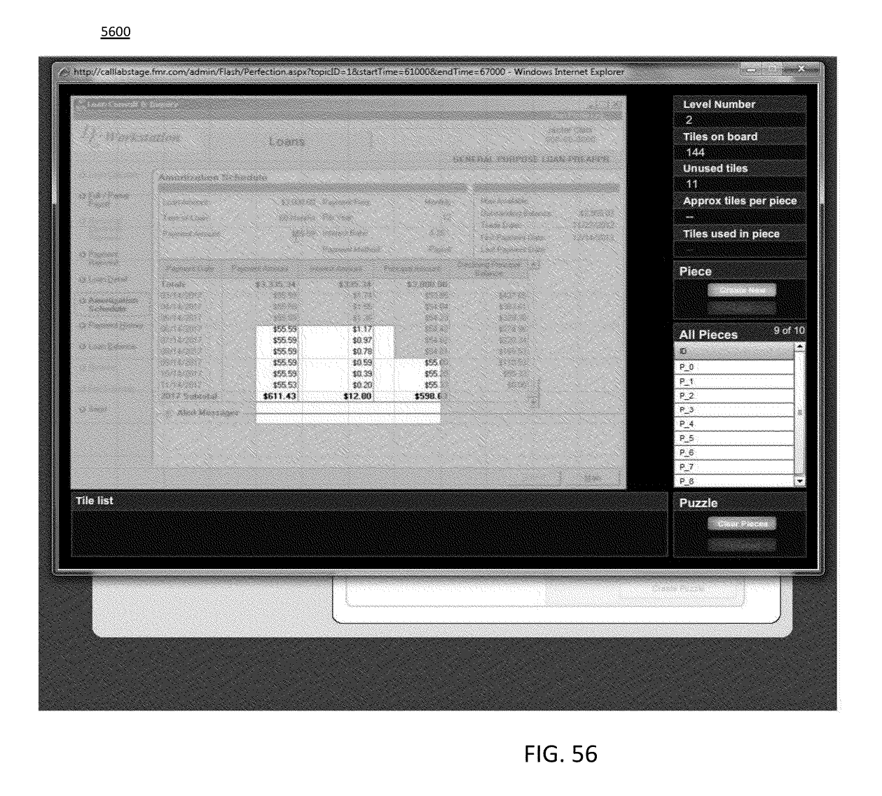

While call center gameplay has been described in foregoing FIGS. 12-39, the generation of game data for such call center games will now be discussed in more detail with respect to FIGS. 40-64. Turning to FIG. 40, therein is shown an exemplary login screen 4000 to an administrative module by which games and game content may be selected, designed and created. After an administrator accesses the administration module, they may be asked to enter into the login screen 4000 a valid user ID, password, a business unit and a call topic for a game to be created.

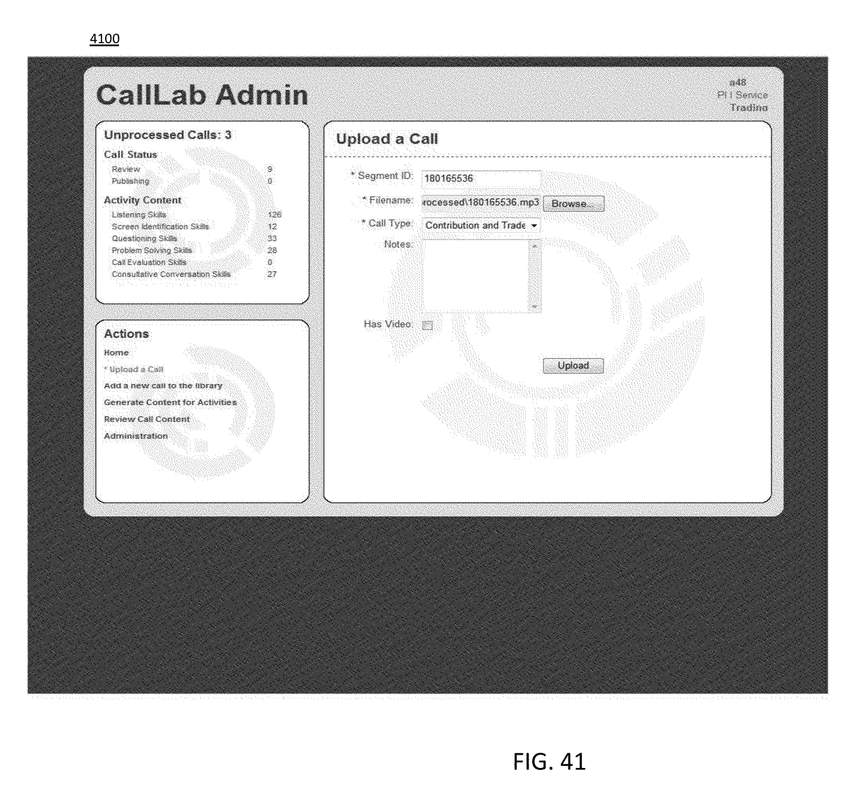

FIG. 41 shows an “Upload a Call” screen 4100. The administrator may select a call (e.g., by an available .mp3 file or the like) from a database of available calls, such as may be maintained by Database Server 104. The administrator may enter an identification of the call segment, its filename and the call type for a phone call selected from the database.

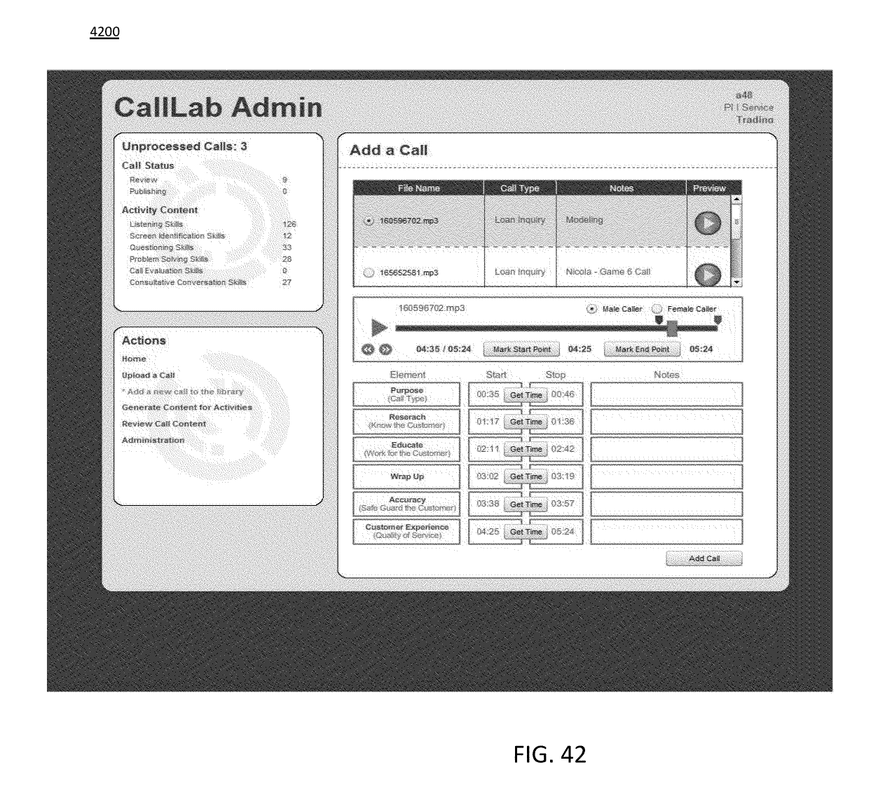

FIG. 42 shows a Call Review screen 4200 by which the administrator may catalogue the contents of a selected call segment in one or more notes section provided therein.

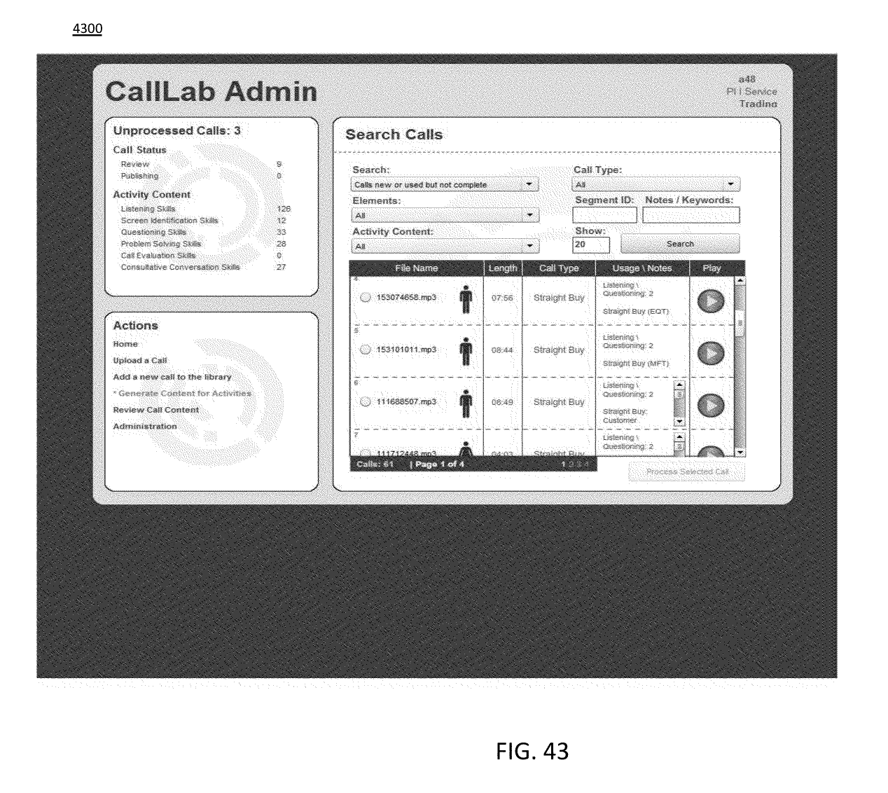

FIG. 43 shows a Call Search screen 4300 by which an administrator may search for call segments to be added to a game. Once call segments have been entered in a database in accordance with the foregoing, they may be searched, previewed and accessed to create content for games.

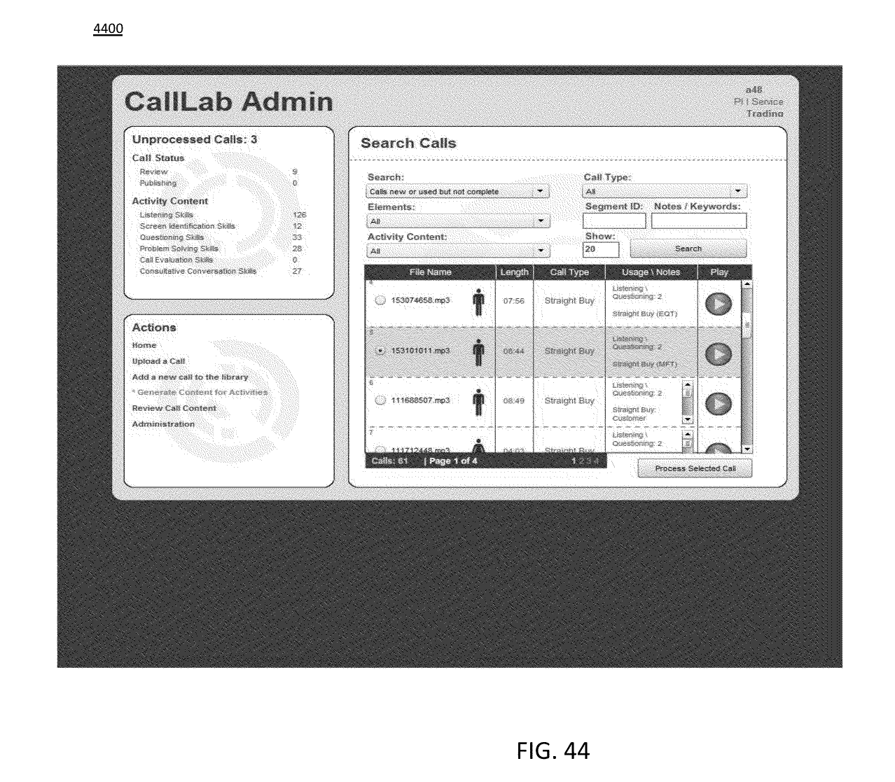

FIG. 44 shows a call selection 4400 being made by an administrator to create content for a game.

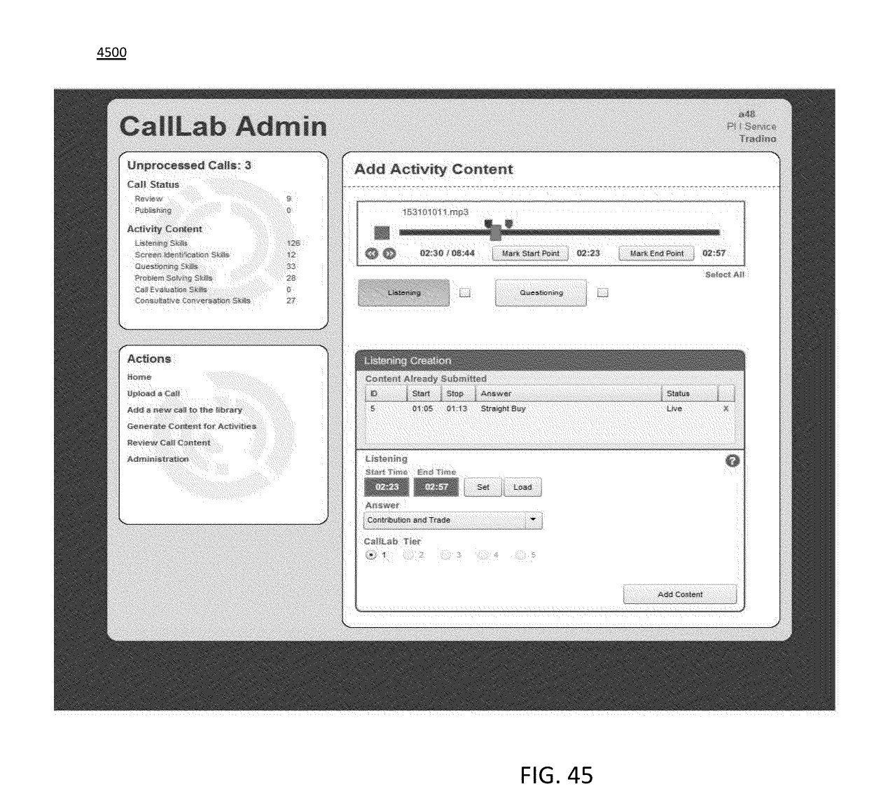

FIG. 45 shows an Add Activity Content screen 4500 that is presented to an administrator during game content creation. The Add Activity Content screen 4500 may be used to edit the Listening portion of a Listening and Questioning game, which in turn, may require the input of a start and stop time for a given phone call segment so that the game plays the correct portion(s) of the selected call to a trainee. The administrator also inputs the correct answer and call type for that call segment. Each call segment may be mined multiple times for each available game, thereby allowing the creation of many game content items from a single recorded call.

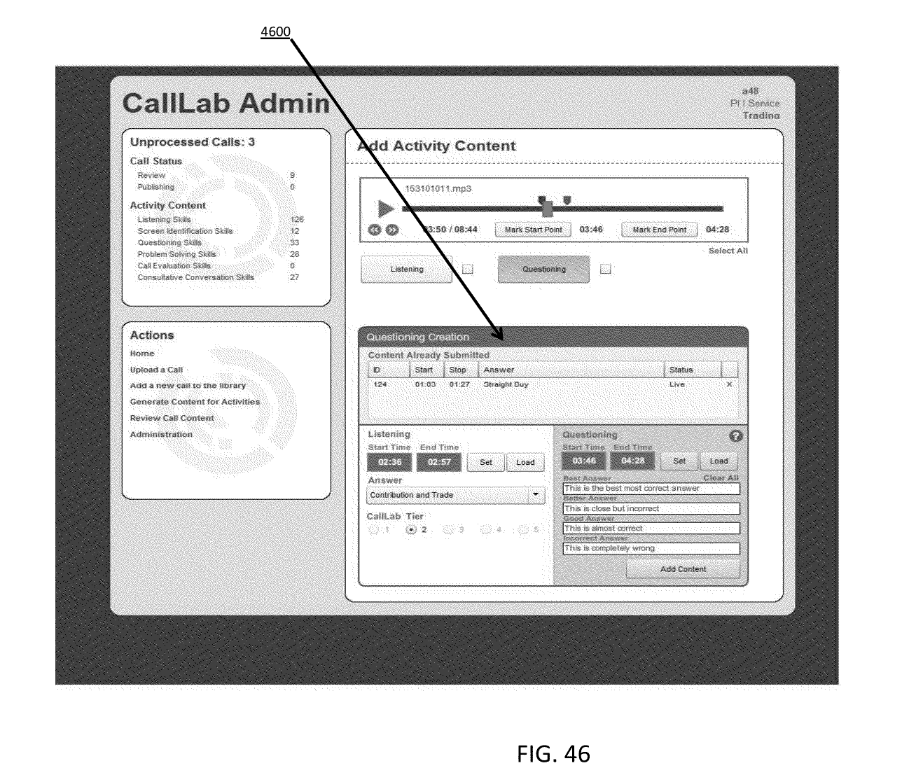

FIG. 46 shows a Question Creation panel 4600 that is presented to an administrator during game content creation for the Questioning portion of a Listening and Questioning game, which was previously described. The administrator may input one or more questions to be asked of a trainee regarding a phone call segment or other types of call training game data.

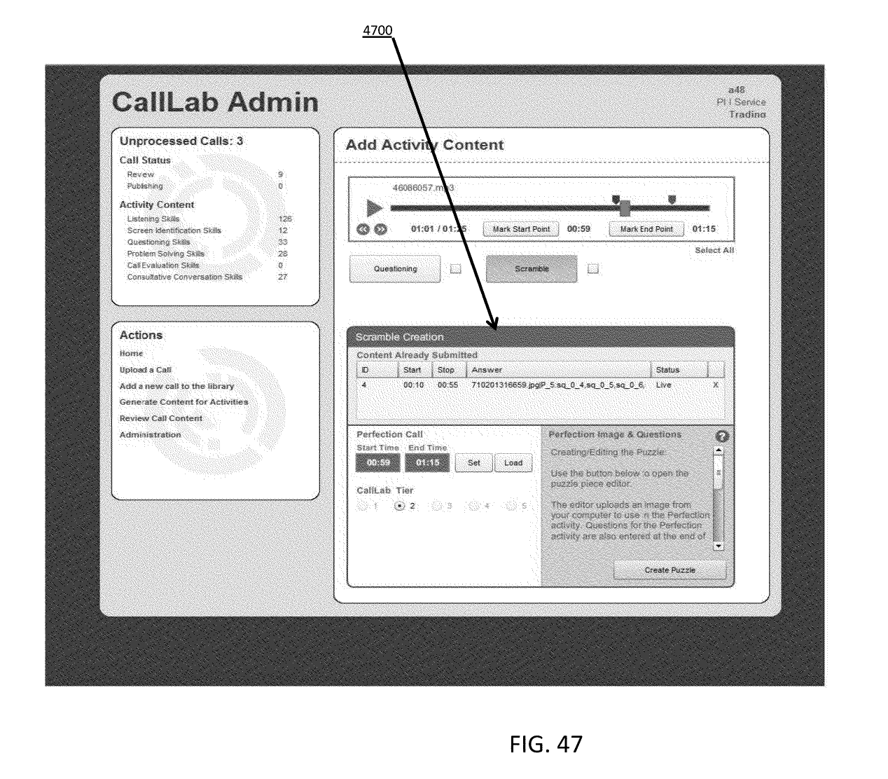

FIG. 47 shows a Screen Puzzle Game Creation panel 4700 that is presented to an administrator during game content creation. The Screen Puzzle Game Creation panel 4700 has two parts. The first part allows an administrator to enter the start and stop time of the phone segment used in the game and to select a tier of a call training game in which this phone segment will be used. The second part allows an administrator to create puzzle pieces from call operator screen display information that was used by the call operator during the live call that was the basis for this content.

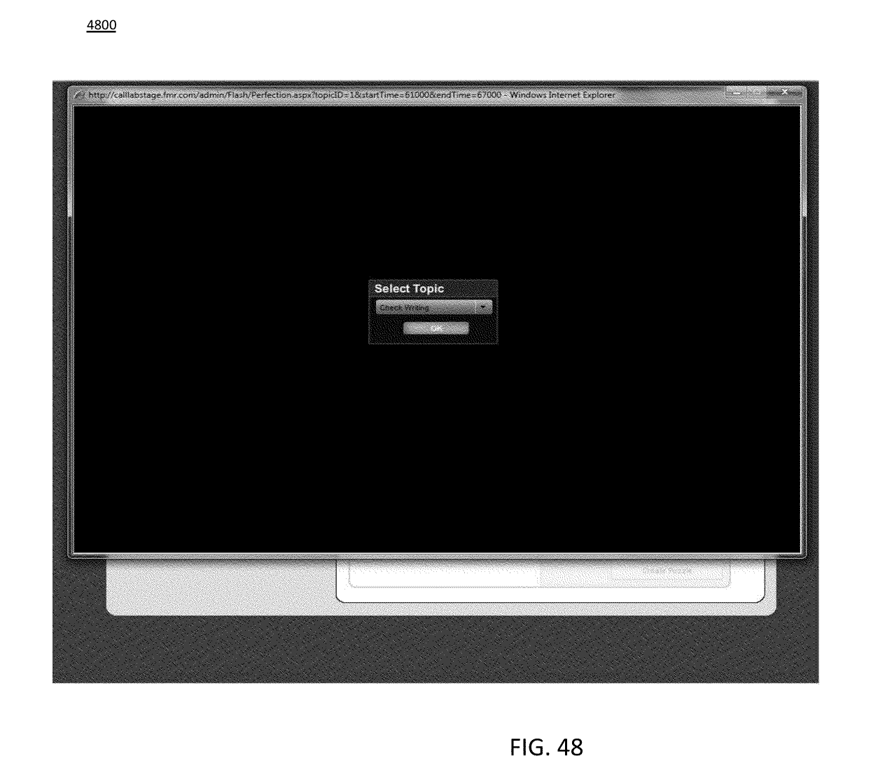

FIG. 48 shows a Topic Selection screen 4800 that is presented to an administrator during Screen Puzzle game content creation. On this screen 4800, the administrator first selects the type of call or topic for which the game is being created.

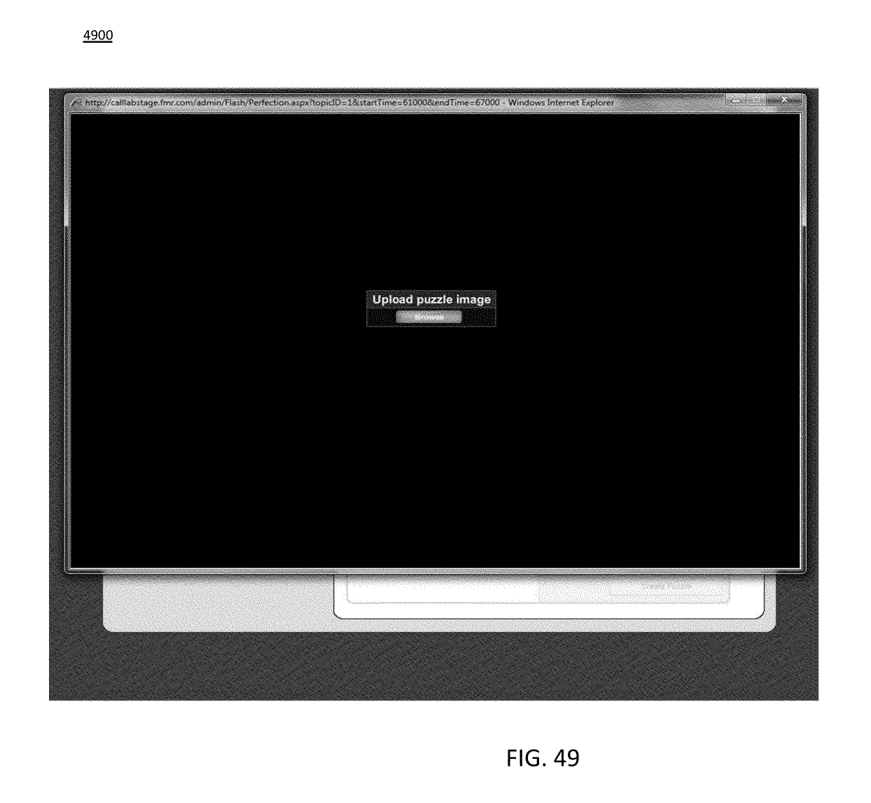

FIG. 49 shows an Upload screen 4900 that is presented to an administrator during Screen Puzzle game content creation. In this portion of the editor, the administrator selects and uploads an image from which to create puzzle pieces for the game. The image may relate to display screen information that is presented to a call center operator during a call with a customer.

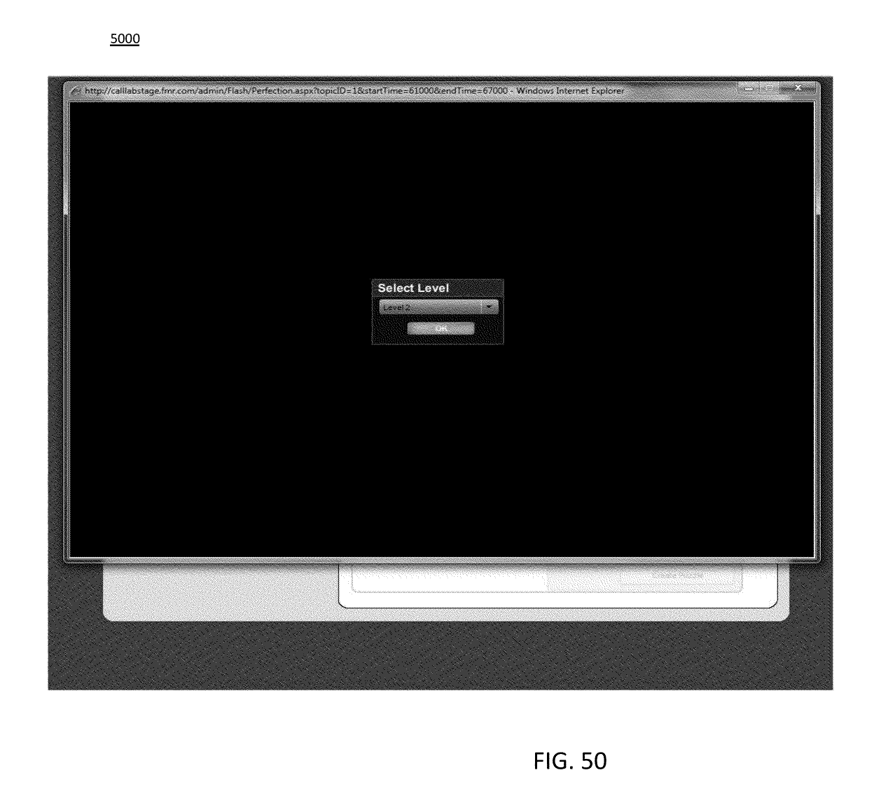

FIG. 50 shows a Level Selection screen 5000 that is presented to an administrator during content creation for the Screen Puzzle game. Once a selected image has been uploaded, the administrator may select the game level for which the content is to be used. Each level may be configured differently, allowing for increasing difficulty in putting together the puzzles and answering screen-based questions.

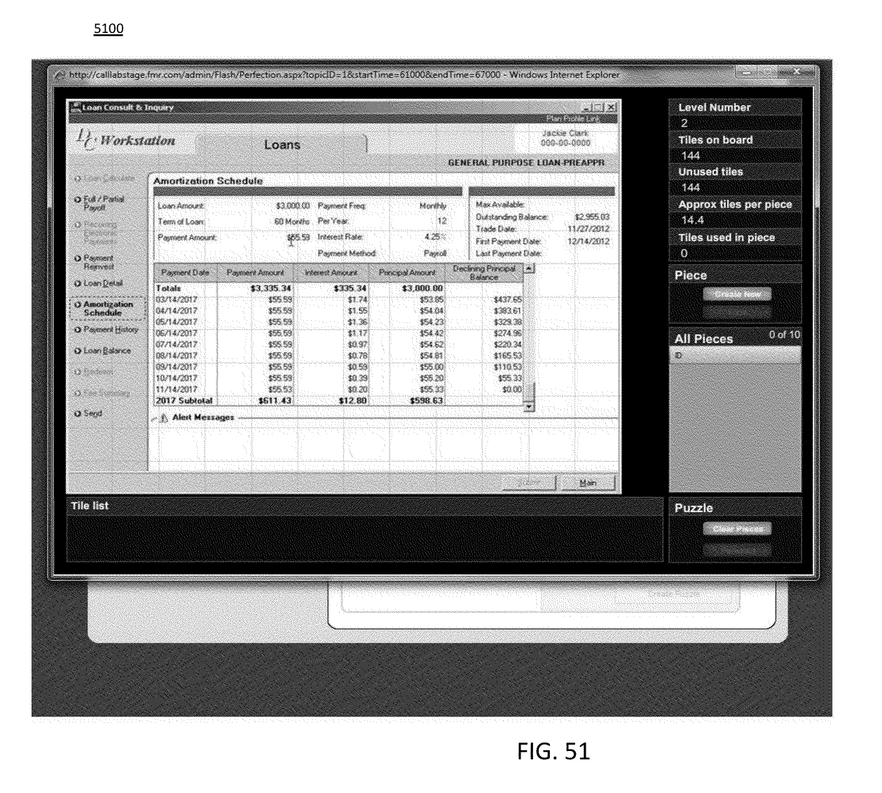

FIG. 51 shows a Puzzle Image Creation screen 5100. This is the main screen in the puzzle game editor. The uploaded image is broken into a grid, the size of which may depend upon the game level assigned to the content. Puzzle pieces are then drawn until the grid has been filled.

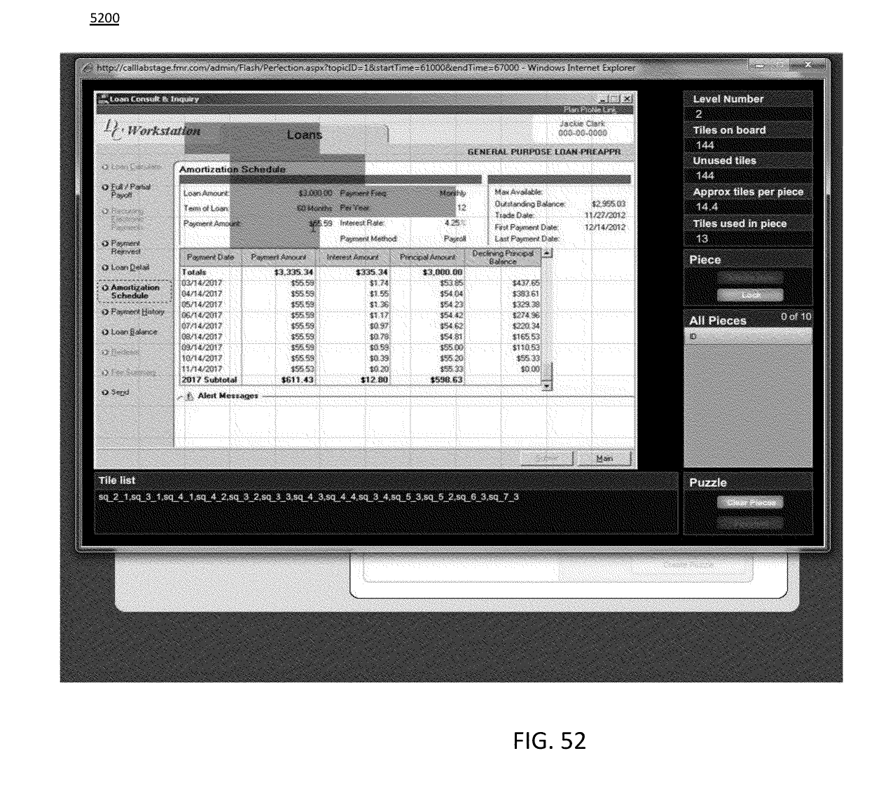

FIG. 52 shows the creation of a first puzzle piece 5200 that is created by an administrator by selecting grid tiles on the Puzzle Image creation screen 5100.

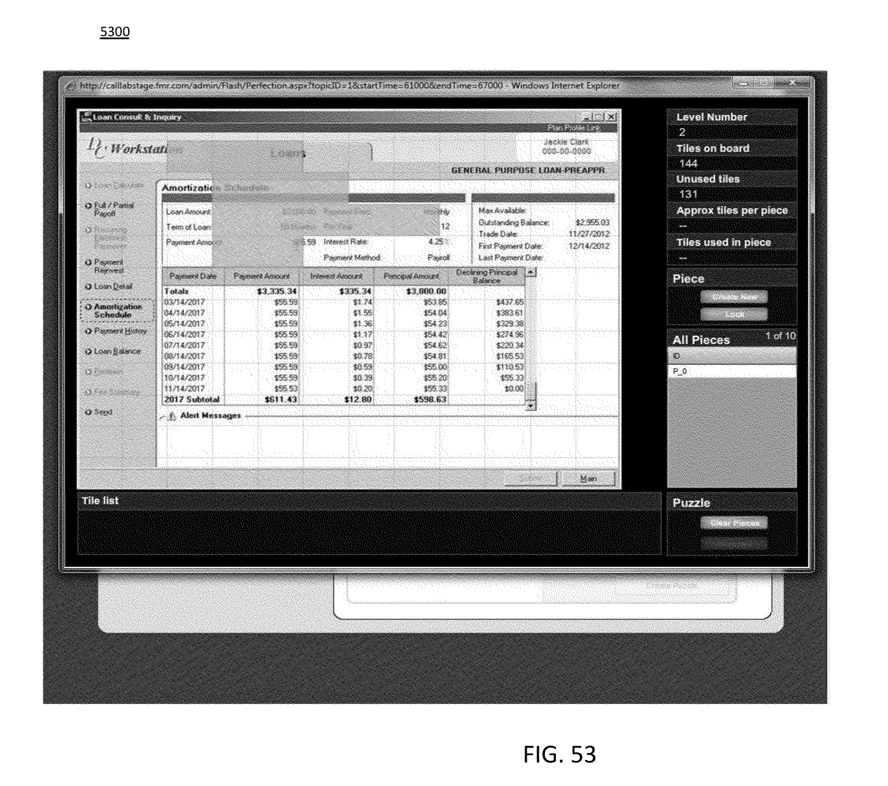

FIG. 53 shows the creation of a second puzzle piece 5300 that is created by an administrator by selecting grid tiles on the Puzzle Image creation screen 5100.

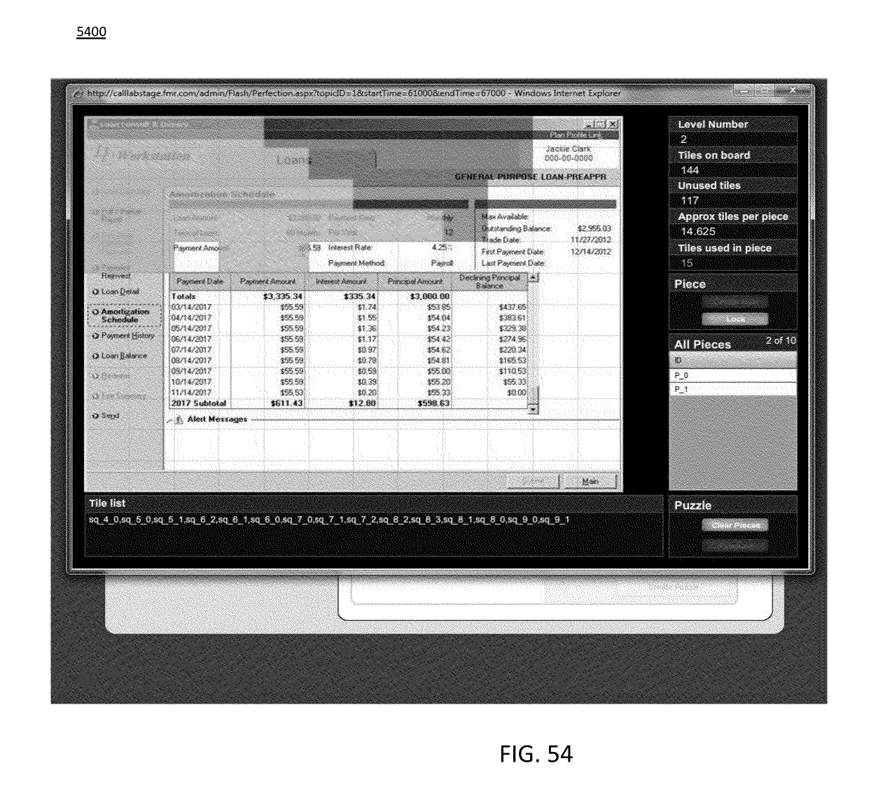

FIGS. 54-56 similarly show the creation of additional puzzle pieces 5400, 5500, 5600.

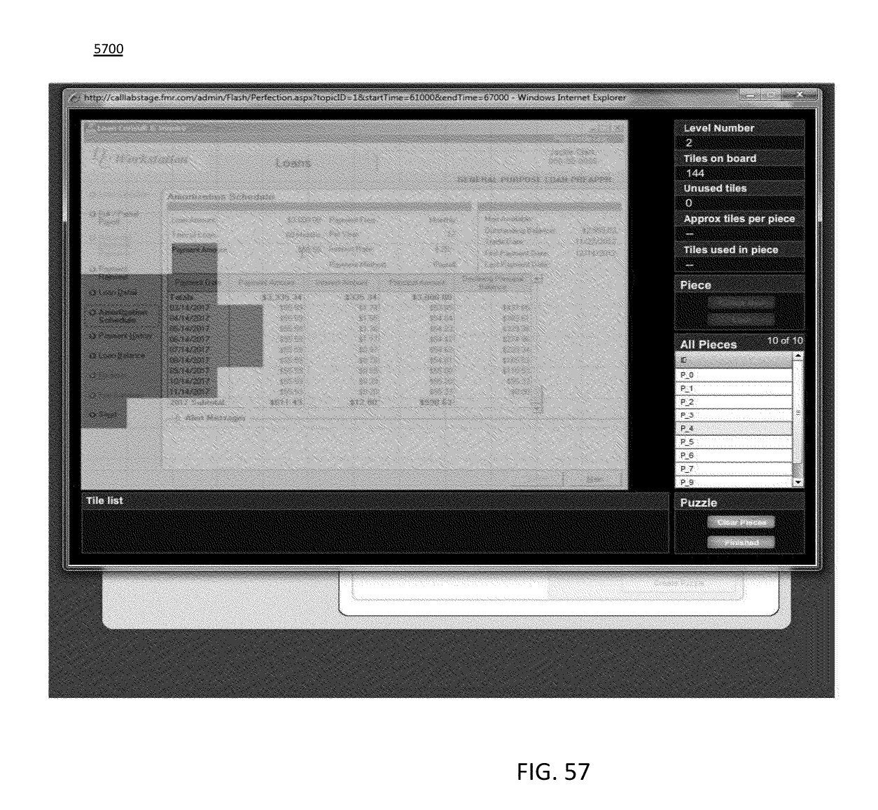

FIG. 57 shows the editing of a previously created puzzle piece 5700 that may be used by an administrator to edit one or more previously created puzzle pieces.

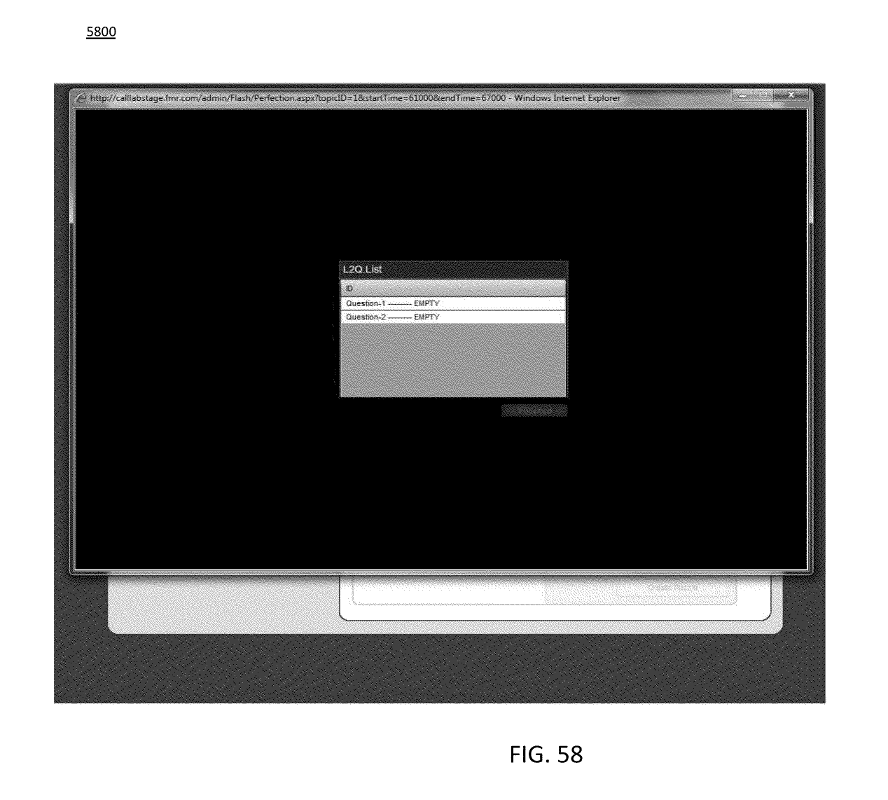

FIG. 58 shows a Puzzle Game Question Creation screen 5800. After building puzzle pieces, the administrator may enter one or more questions that will be asked of the trainee during the puzzle game about the puzzle, the screen display information and/or the corresponding call.

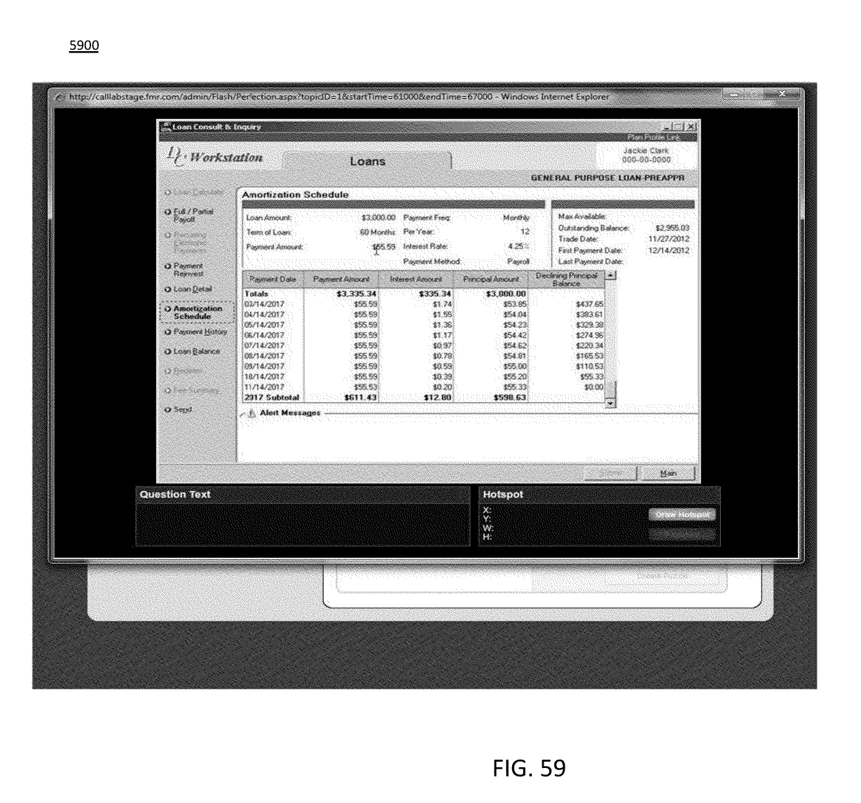

FIG. 59 show a Puzzle Game Question Text Entry screen 5900. Here the administrator enters the question text to be presented and further selects areas on the puzzle image that the trainee needs to select in response to the question, which may occur after the puzzle image is completed by a trainee during a call training game.

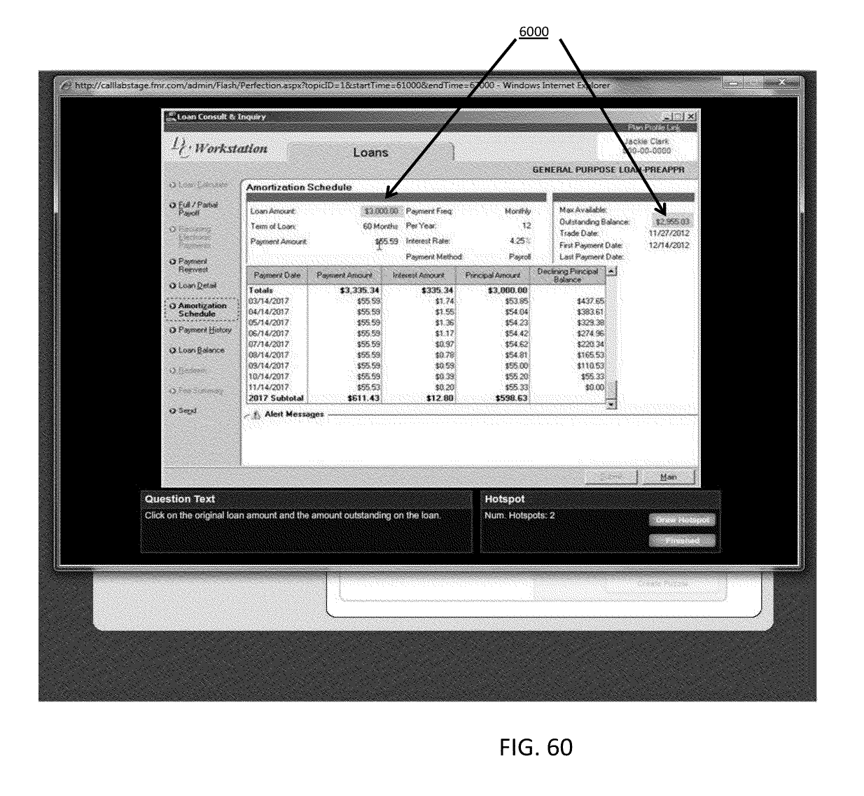

FIG. 60 shows an exemplary selection of two hotpsot areas 6000 selected by an administrator as appropriate answers for a question regarding a completed puzzle image to be presented to a trainee.

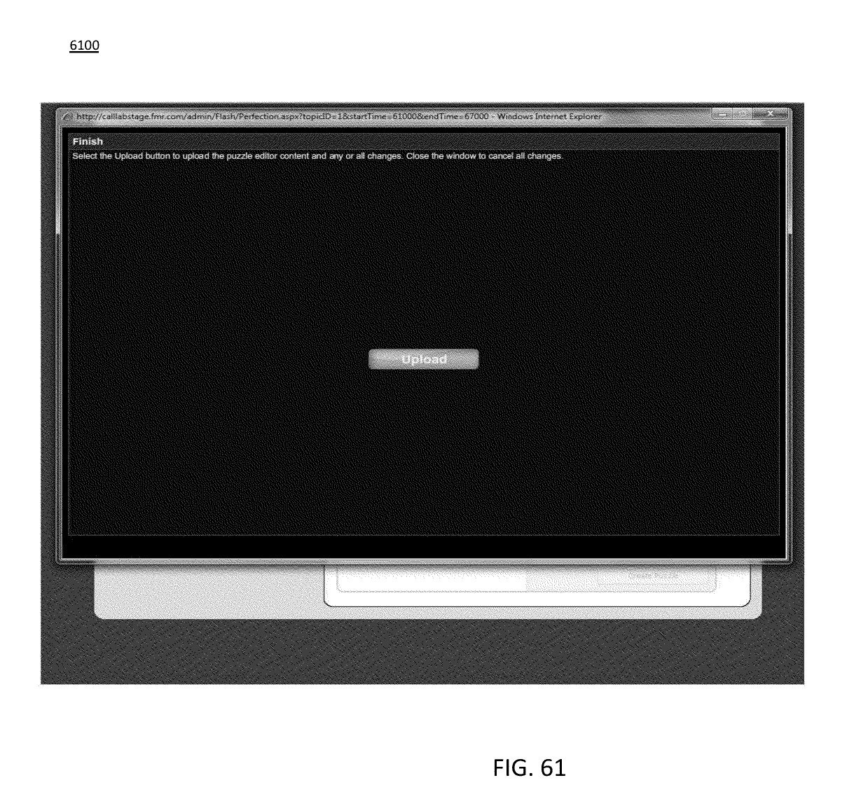

FIG. 61 shows a Puzzle Game Editing Completion screen 6100 that is displayed to an administrator upon completing the editing of puzzle game content. When the game content has been properly established and edited, it may be uploaded to the call game server for use in one or more call training games. In various embodiments, the content may need to be reviewed and approved by additional parties before it becomes available in a call game.

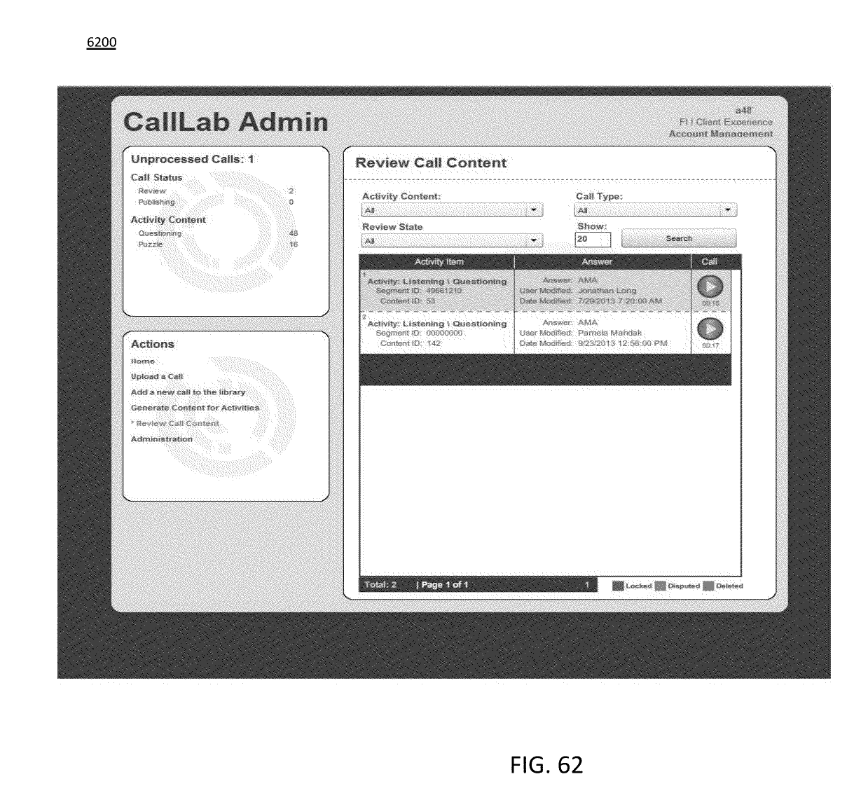

FIG. 62 shows a Review Call Content screen 6200 that may be presented to a reviewer after content has been created and uploaded. The Review Call Content screen 6200 is where all content is accessed after being created. Somebody other than the content creator should review the content before it goes live and used within the call training games.

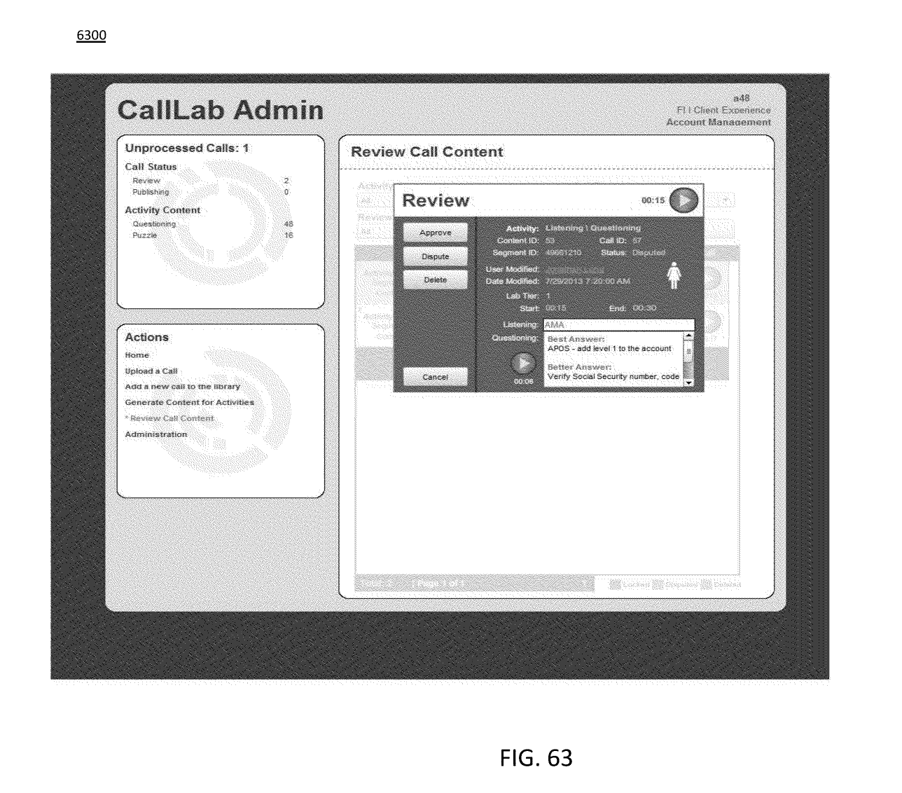

FIG. 63 shows a Call Content Approval screen 6300. When a call is selected for review, it is played back and the reviewer can look at the content to decide whether it is valid or needs to be edited. Once approved, the content immediately goes live and is ready to use in live call training games.

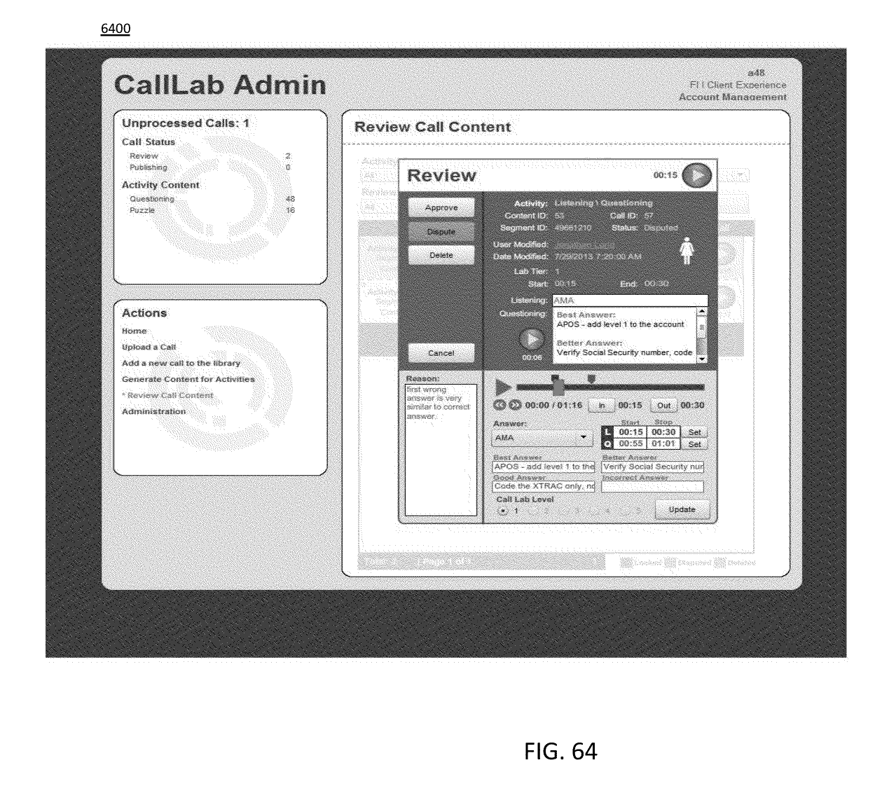

FIG. 64 shows a Call Content Editing screen 6400. If content is not approved by a reviewer and is instead to be edited, the reviewer has the opportunity to amend and update the content. If this happens, the content may be sent back to the review queue and another reviewer may be requested to review and either approve or disapprove the edited content before it is used in a call training game.

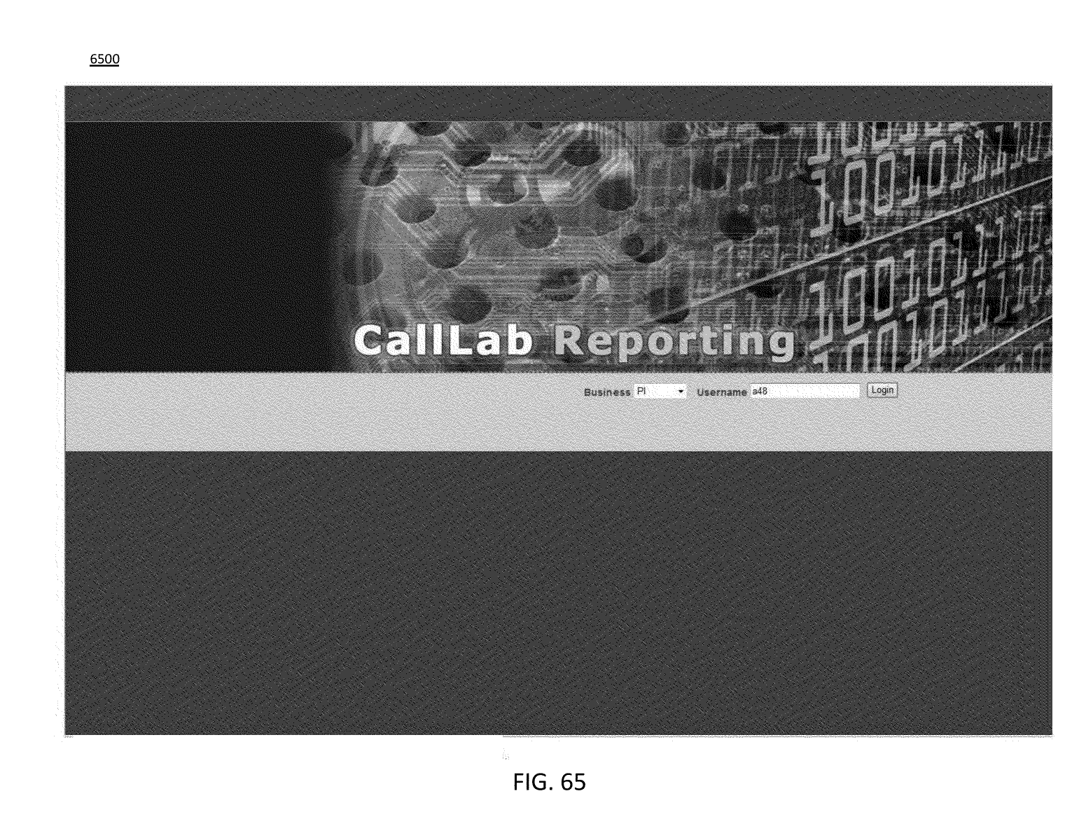

Turning now to FIGS. 65-69, therein are presented a series of exemplary sequential screens shots of a reporting component that may be used to evaluate trainees performances during call training games. FIG. 65 shows an initial CallLab Reporting screen 6500 of the reporting component. Access to the reporting site may be restricted by user ID and may be available for different business units.

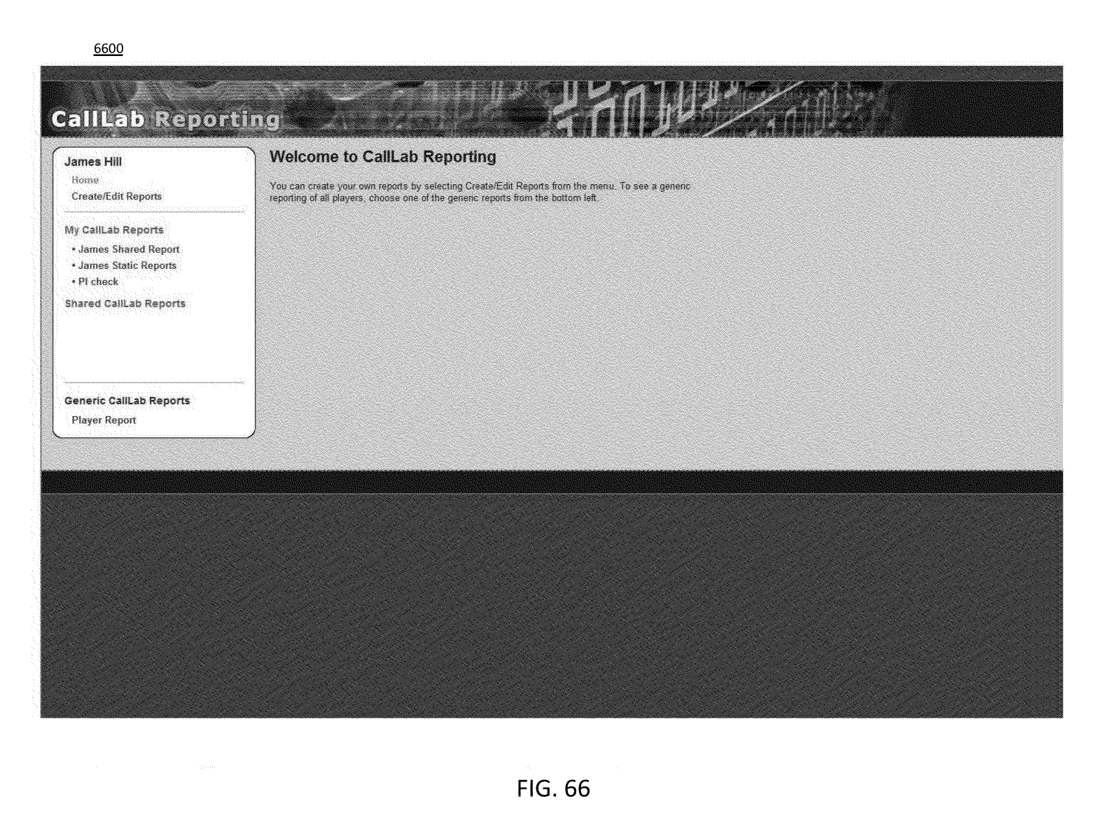

FIG. 66 shows an initial Report Generation screen 6600 of the reporting component. Reports can be completely generic, showing all users in the system, or may be divided by business unit, call game, or any other attribute stored by the CallLab servers.

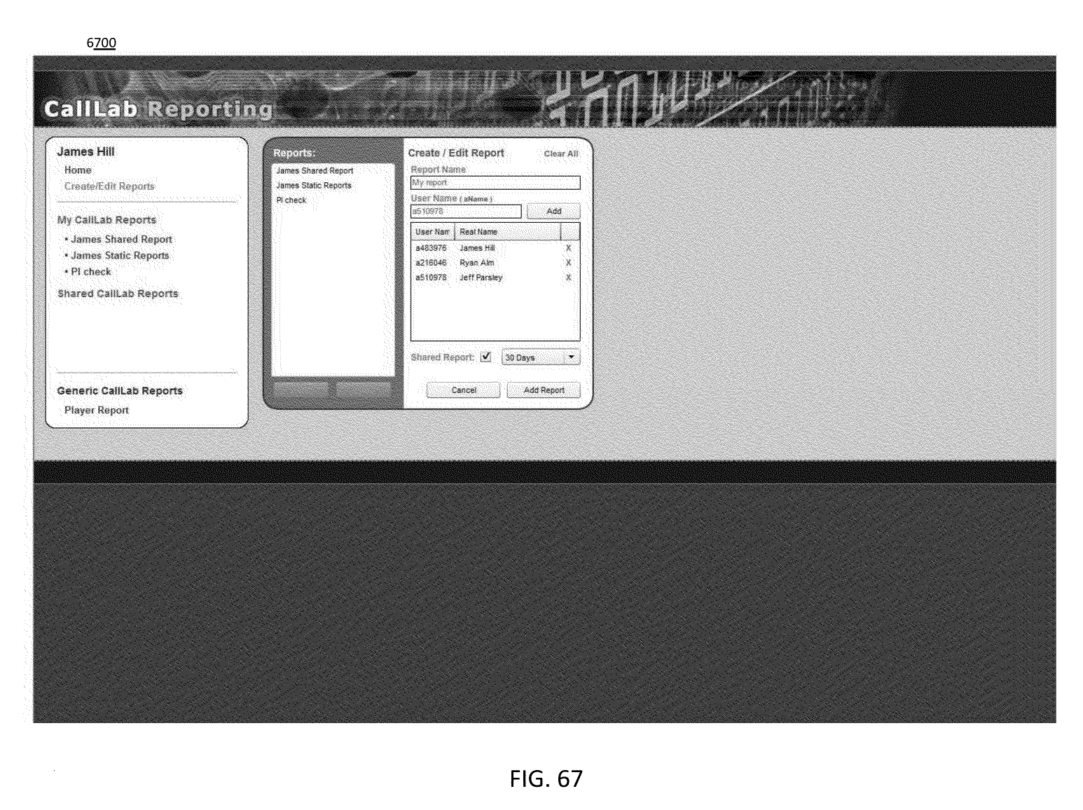

FIG. 67 shows a Custom Reporting panel 6700 of the reporting component. Reports can be custom built to only show certain users to be tracked. These reports may be kept private or may be shared with other personnel who have access to the reporting site for a given business unit.

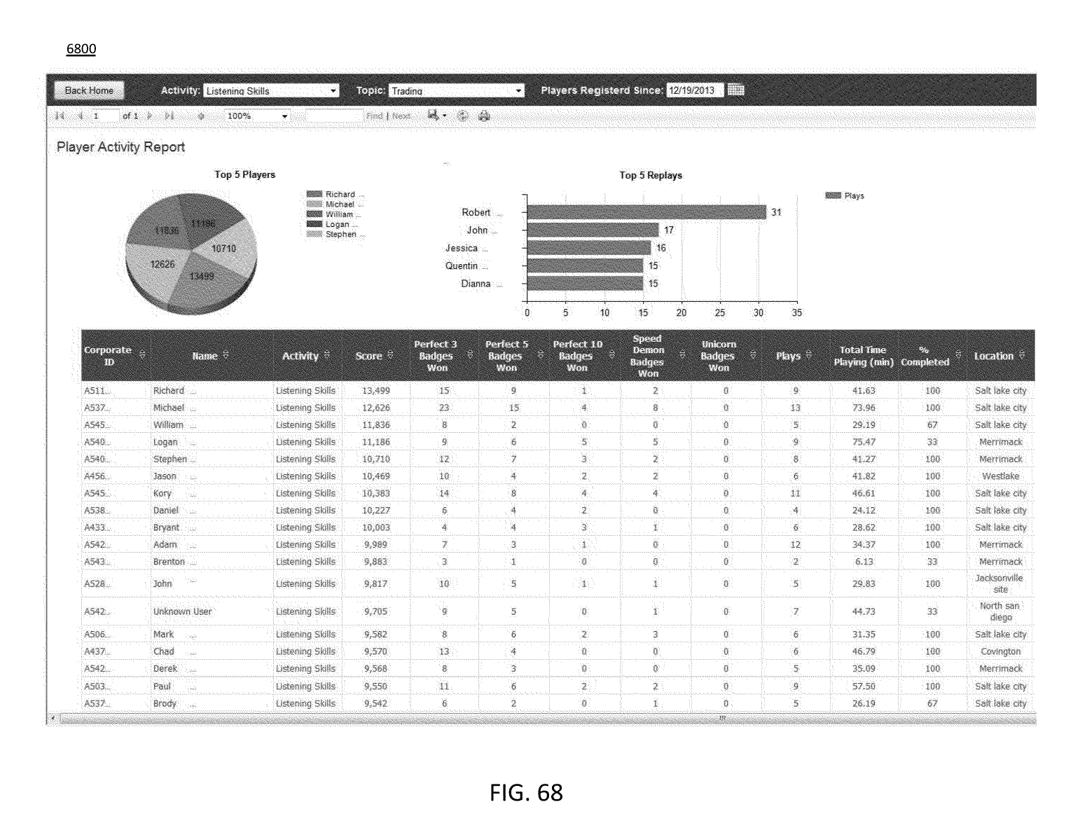

FIG. 68 shows a Player Activity Report screen 6800 of the reporting component. This exemplary report enables administrators to see where trainees are in each game, including their scores and badges earned. This enables administrators to gain insight into how well individual trainees progress in the games and how the trainee's skills in the targeted areas may be improving.

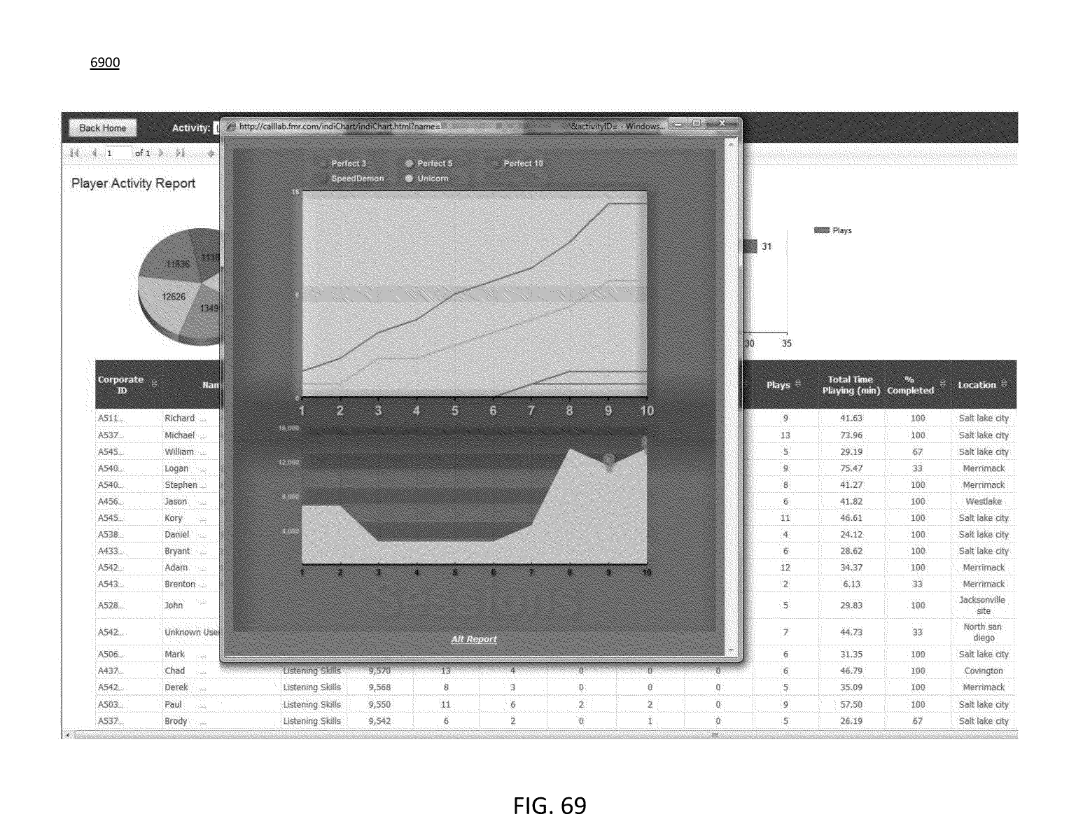

FIG. 69 shows a Performance Charting screen 6900. This view from the reporting module allows administrators to visualize trainees' progression of skills over time.

### CallLab

FIG. 70 shows a block diagram illustrating various embodiments of the CallLab.

### Example Datastructure Commands

CallLab may provide a (Secure) Hypertext Transfer Protocol (“HTTP(S)”) POST message including data formatted according to the eXtensible Markup Language (“XML”). An example database request may substantially be in the form of a HTTP(S) POST message including XML-formatted data, an example of which is provided below:

POST /authrequest.php HTTP/1.1
Host: www.server.com
Content-Type: Application/XML
Content-Length: 667
<?XML version = ”1.0” encoding = ”UTF-8”?>
<auth_request>

<timestamp>2020-12-31 23:59:59</timestamp>
<user_accounts_details>

<user_account_credentials>

<user_name>JohnDoe@gmail.com</account_name>
<password>abc123</password>
//OPTIONAL <cookie>cookieID</cookie>
//OPTIONAL <digital_cert_link>www.mydigitalcertificate.com/

JohnDoeDaDoeDoe@gmail.com/mycertifcate.dc</digital_cert_link>

//OPTIONAL <digital_certificate>_DATA_</digital_certificate>

</user_account_credentials>

</user_accounts_details>
<client_details> //iOS Client with App and Webkit

<client_IP>10.0.0.123</client_IP>
<user_agent_string>Mozilla/5.0 (iPhone; CPU iPhone OS 7_1_1 like Mac

OS X) AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>app with webkit</client_app_type>
<app_installed_flag>true</app_installed_flag>
<app_name>_Innovation_Nickname_.app</app_name>
<app_version>1.0 </app_version>
<app_webkit_name>Mobile Safari</client_webkit_name>
<client_version>537.51.2</client_version>

</client_details>
<client_details> //iOS Client with Webbrowser

<client_IP>10.0.0.123</client_IP>
<user_agent_string>Mozilla/5.0 (iPhone; CPU iPhone OS 7_1_1 like Mac

OS X) AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>web browser</client_app_type>
<client_name>Mobile Safari</client_name>
<client_version>9537.53</client_version>

</client_details>
<client_details> //Android Client with Webbrowser

<client_IP>10.0.0.123</client_IP>
<user_agent_string>Mozilla/5.0 (Linux; U; Android 4.0.4; en-us; Nexus

S Build/IMM76D) AppleWebKit/534.30 (KHTML, like Gecko) Version/4.0 Mobile
Safari/534.30</user_agent_string>

<client_product_type>Nexus S</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Android</client_OS>
<client_OS_version>4.0.4</client_OS_version>
<client_app_type>web browser</client_app_type>
<client_name>Mobile Safari</client_name>
<client_version>534.30</client_version>

</client_details>
<client_details> //Mac Desktop with Webbrowser

<client_IP>10.0.0.123</client_IP>
<user_agent_string>Mozilla/5.0 (Macintosh; Intel Mac OS X 10_9_3)

AppleWebKit/537.75.14 (KHTML, like Gecko) Version/7.0.3
Safari/537.75.14</user_agent_string>

<client_product_type>MacPro5,1</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Mac OS X</client_OS>
<client_OS_version>10.9.3</client_OS_version>
<client_app_type>web browser</client_app_type>
<client_name>Mobile Safari</client_name>
<client_version>537.75.14</client_version>

</client_details>

</auth_request>

In one implementation, after receiving a new information request, the CallLab controller 7001 may parse the message, and retrieve records from the one or more databases and/or tables (e.g., game content database). The CallLab controller 7001 may then update the record and store the updated record to the CallLab database 7050. An exemplary listing, written substantially in the form of PHP/SQL commands, to update a record in the CallLab database 7050, is provided below:

Update Record

<?PHP
header(′Content-Type: text/plain′);
// store input data in a database
mysql_connect(″201.408.185.132″,$DBserver,$password); // access
database server
mysql_select(″Trainee_Profile_DB.SQL″); // select database to append
mysql_query(”UPDATE UserTable
SET street_name = ′400 Turtle bay road′ , apt_unit = ′6H′ , city =
′New York′ ,
zip_code = ′10086′ timestamp = ′2013-02-22 15:22:43′
WHERE username = ′JDoe@gmail.com′″);
mysql_close(″CSF_DB.SQL″); // close connection to database
?>

### CallLab Controller

FIG. 70 shows a block diagram illustrating embodiments of a CallLab controller 7001. In this embodiment, the CallLab controller 7001 may serve to aggregate, process, store, search, serve, identify, instruct, generate, match, and/or facilitate interactions with a computer through Automated Management Arrangements technologies, and/or other related data.

Typically, users, which may be administrators, trainees and/or other people or systems, may engage information technology systems (e.g., computers) to facilitate information processing. In turn, computers employ processors to process information; such processors 7004 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 7040 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the CallLab controller 7001 may be connected to and/or communicate with entities such as, but not limited to: one or more users 7034 using client computers 7032 which may include user input devices 7024; peripheral devices 7026; an optional cryptographic processor device 7028; and/or a communications network 7030.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The CallLab controller 7001 may be based on computer systems that may comprise, but are not limited to, components such as: a computer systemization 7002 connected to memory 7039, which may include a data storage device 7040.

### Computer Systemization

A computer systemization 7002 may comprise a system clock 7005, central processing unit (“CPU(s)” and/or “processor(s)” (these terms are used interchangeable throughout the disclosure unless noted to the contrary)) 7004, a system memory (e.g., a read only memory (ROM) 7010, a random access memory (RAM) 7008, etc.), and/or an interface bus 7018, and most frequently, although not necessarily, are all interconnected and/or communicating through a system bus 7006 on one or more (mother)board(s) having conductive and/or otherwise transportive circuit pathways through which instructions (e.g., binary encoded signals) may travel to effectuate communications, operations, storage, etc. The computer systemization may be connected to a power source 7003; e.g., optionally the power source may be internal. Optionally, a cryptographic processor 7012 may be connected to the system bus 7006. In another embodiment, the cryptographic processor 7012 and/or transceivers (e.g., ICs) 7038 may be connected as either internal and/or external peripheral devices via the interface bus I/O and/or directly via the interface bus 7018. In turn, the transceivers may be connected to antenna(s) 7036, thereby effectuating wireless transmission and reception of various communication and/or sensor protocols; for example the antenna(s) may connect to various transceiver chipsets (depending on deployment needs), including: Broadcom BCM4329FKUBG transceiver chip (e.g., providing 802.11n, Bluetooth 2.1+EDR, FM, etc.); a Broadcom BCM4750IUB8 receiver chip (e.g., GPS); a Broadcom BCM4335 transceiver chip (e.g., providing 2G, 3G, and 4G long-term evolution (LTE) cellular communications; 802.11ac, Bluetooth 4.0 low energy (LE) (e.g., beacon features)); an Infineon Technologies X-Gold 618-PMB9800 transceiver chip (e.g., providing 2G/3G HSDPA/HSUPA communications); a MediaTek MT6620 transceiver chip (e.g., providing 802.11a/b/g/n, Bluetooth 4.0 LE, FM, global positioning system (GPS) (thereby allowing CallLab controller 7001 to determine its location); a Texas Instruments WiLink WL1283 transceiver chip (e.g., providing 802.11n, Bluetooth 3.0, FM, GPS); and/or the like. The system clock 7005 typically has a crystal oscillator and generates a base signal through the computer systemization's circuit pathways. The clock 7005 is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU 7004, and/or organized in numerous variations employed as exemplified by various computer systems.

The CPU 7004 comprises at least one high-speed data processor adequate to execute program components for executing user and/or system-generated requests. The CPU 7004 is often packaged in a number of formats varying from large mainframe computers, down to mini computers, servers, desktop computers, laptops, netbooks, tablets (e.g., iPads, Android and Windows tablets, etc.), mobile smartphones (e.g., iPhones, Android and Windows phones, etc.), wearable devise (e.g., watches, glasses, goggles (e.g., Google Glass), etc.), and/or the like. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 7039 beyond the processor itself; internal memory may include, but is not limited to: fast registers, various levels of cache memory (e.g., level 1, 2, 3, etc.), RAM, etc. The processor 7004 may access this memory 7039 through the use of a memory address space that is accessible via instruction address, which the processor can construct and decode allowing it to access a circuit path to a specific memory address space having a memory state. The CPU 7004 may be a microprocessor such as: AMD's Athlon, Duron and/or Opteron; Apple's A series of processors (e.g., A5, A6, A7, etc.); ARM's application, embedded and secure processors; IBM and/or Motorola's DragonBall and PowerPC; IBM's and Sony's Cell processor; Intel's 80X86 series (e.g., 80386, 80486), Pentium, Celeron, Core (2) Duo, i series (e.g., i3, i5, i7, etc.), Itanium, Xeon, and/or XScale; Motorola's 680X0 series (e.g., 68020, 68030, 68040, etc.); and/or the like processor(s). The CPU 7004 interacts with memory through instruction passing through conductive and/or transportive conduits (e.g., (printed) electronic and/or optic circuits) to execute stored instructions (i.e., program code) according to conventional data processing techniques. Such instruction passing facilitates communication within the CallLab controller and beyond through various interfaces. Should processing requirements dictate a greater amount speed and/or capacity, distributed processors (e.g., Distributed CallLab), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the CallLab may be achieved by implementing a microcontroller such as CAST's R8051XC2 microcontroller; Intel's MCS 51 (i.e., 8051 microcontroller); and/or the like. Also, to implement certain features of the CallLab, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the CallLab component collection (distributed or otherwise) and/or features may be implemented via the microprocessor and/or via embedded components; e.g., via ASIC, coprocessor, DSP, FPGA, and/or the like. Alternately, some implementations of the CallLab may be implemented with embedded components that are configured and used to achieve a variety of features or signal processing.

Depending on the particular implementation, the embedded components may include software solutions, hardware solutions, and/or some combination of both hardware/software solutions. For example, CallLab features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the CallLab features. A hierarchy of programmable interconnects allow logic blocks to be interconnected as needed by the CallLab system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the CallLab may be developed on regular FPGAs and then migrated into a fixed version that more resembles ASIC implementations. Alternate or coordinating implementations may migrate CallLab controller features to a final ASIC instead of or in addition to FPGAs. Depending on the implementation all of the aforementioned embedded components and microprocessors may be considered the “CPU” and/or “processor” for the CallLab.

### Power Source

The power source 7003 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 7003 is connected to at least one of the interconnected subsequent components of the CallLab thereby providing an electric current to all subsequent components. In one example, the power source 7003 is connected to the system bus component Error! Reference source not found.04. In an alternative embodiment, an outside power source is provided through a connection across the I/O interface 7016. For example, a USB and/or IEEE 1394 connection carries both data and power across the connection and is therefore a suitable source of power.

### Interface Adapters

Interface bus(ses) 7018 may accept, connect, and/or communicate to a number of interface adapters, conventionally although not necessarily in the form of adapter cards, such as but not limited to: input output interfaces (I/O) 7016, storage interfaces 7022, network interfaces 7020, and/or the like. Optionally, cryptographic processor interfaces 7014 similarly may be connected to the interface bus 7018. The interface bus 7018 provides for the communications of interface adapters with one another as well as with other components of the computer systemization 7002. Interface adapters are adapted for a compatible interface bus 7018. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X), PCI Express, Personal Computer Memory Card International Association (PCMCIA), and/or the like.

Storage interfaces 7022 may accept, communicate, and/or connect to a number of storage devices such as, but not limited to: storage devices 7040, removable disc devices, and/or the like. Storage interfaces may employ connection protocols such as, but not limited to: (Ultra) (Serial) Advanced Technology Attachment (Packet Interface) ((Ultra) (Serial) ATA(PI)) (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 7020 may accept, communicate, and/or connect to a communications network 7030. Through a communications network 7030, the CallLab controller is accessible through remote clients 7032 (e.g., computers with web browsers) by users 7034. Network interfaces 7020 may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., Distributed CallLab), architectures may similarly be employed to pool, load balance, and/or otherwise decrease/increase the communicative bandwidth required by the CallLab controller. A communications network 7030 may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 7020 may be used to engage with various communications networks 7030. For example, multiple network interfaces may be employed to allow for the communication over broadcast, multicast, and/or unicast networks.

Input Output interfaces (I/O) 7016 may accept, communicate, and/or connect to user input devices 7024, peripheral devices 7026, cryptographic processor devices 7028, and/or the like. I/O 7016 may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 7024 often are a type of peripheral device 7026 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 7026 may be connected and/or communicate to I/O 7016 and/or other facilities of the like such as network interfaces, storage interfaces, directly to the interface bus 7018, system bus 7006, the CPU 7004, and/or the like. Peripheral devices 7026 may be external, internal and/or part of the CallLab controller. Peripheral devices 7026 may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices 7026 often include types of input devices (e.g., cameras).

It should be noted that although user input devices 7024 and peripheral devices 7026 may be employed, the CallLab controller 7001 may be embodied as an embedded, dedicated, and/or monitor-less (i.e., headless) device, wherein access would be provided over a network interface connection 7020.

Cryptographic units such as, but not limited to, microcontrollers, processors 7012, interfaces 7014, and/or devices 7028 may be attached, and/or communicate with the CallLab controller 7001. A MC68HC16 microcontroller, manufactured by Motorola Inc., may be used for and/or within cryptographic units 7012. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 7039. However, memory is a fungible technology and resource, thus, any number of memory embodiments may be employed in lieu of or in concert with one another. It is to be understood that the CallLab controller 7001 and/or a computer systemization 7002 may employ various forms of memory 7039. For example, a computer systemization 7002 may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 7039 will include ROM 7010, RAM 7008, and a storage device 7040. A storage device 7040 may be any conventional computer system storage. Storage devices may include: an array of devices (e.g., Redundant Array of Independent Disks (RAID)); a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; solid state memory devices (USB memory, solid state drives (SSD), etc.); other processor-readable storage mediums; and/or other devices of the like. Thus, a computer systemization 7001 generally requires and makes use of memory 7039.

### Component Collection

The memory 7039 may contain a collection of program and/or database components and/or data such as, but not limited to: operating system (OS) component(s) 7013 (operating system); information server component(s) 7072 (information server); user interface component(s) 7075 (user interface); Web browser component(s) 7074 (Web browser); CallLab database(s) 7050; mail server component(s) 7071; mail client component(s) 7073; cryptographic server component(s) 7070 (cryptographic server); the CallLab component(s) 7042; and/or the like (i.e., collectively a component collection). These components may be stored and accessed from the storage devices and/or from storage devices accessible through an interface bus. Although non-conventional program components such as those in the component collection, typically, are stored in a local storage device 7040, they may also be loaded and/or stored in memory such as: peripheral devices, RAM, remote storage facilities through a communications network, ROM, various forms of memory, and/or the like.

### Operating System

The operating system component 7013 is an executable program component facilitating the operation of the CallLab controller 7001. Typically, the operating system facilitates access of I/O, network interfaces, peripheral devices, storage devices, and/or the like. The operating system may be a highly fault tolerant, scalable, and secure system such as: Apple's Macintosh OS X (Server); AT&T Plan 9; Be OS; Google's Chrome; Microsoft's Windows 7/8; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/Mobile/NT/Vista/XP (Server), Palm OS, and/or the like. Additionally, for robust mobile deployment applications, mobile operating systems may be used, such as: Apple's iOS; China Operating System COS; Google's Android; Microsoft Windows RT/Phone; Palm's WebOS; Samsung/Intel's Tizen; and/or the like. An operating system 7013 may communicate to and/or with other components in a component collection, including itself, and/or the like. Most frequently, the operating system 7013 communicates with other program components, user interfaces, and/or the like. For example, the operating system 7013 may contain, communicate, generate, obtain, and/or provide program component, system, user, and/or data communications, requests, and/or responses. The operating system 7013, once executed by the CPU 7004, may enable the interaction with communications networks 7030, data, I/O 7016, peripheral devices 7026, program components, memory, user input devices, and/or the like. The operating system 7013 may provide communications protocols that allow the CallLab controller 7001 to communicate with other entities through a communications network 7030. Various communication protocols may be used by the CallLab controller 7001 as a subcarrier transport mechanism for interaction, such as, but not limited to: multicast, TCP/IP, UDP, unicast, and/or the like.

### Information Server

An information server component 7072 is a stored program component that is executed by a CPU 7004. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the CallLab controller 7001 based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the CallLab database 7050, operating systems 7013, other program components, user interfaces, Web browsers, and/or the like.

Access to the CallLab database 7050 may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the CallLab. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the CallLab as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple's iOS, Macintosh Operating System's Aqua; IBM's OS/2; Google's Chrome; Microsoft's Windows varied UIs 2000/2003/3.1/95/98/CE/Millenium/Mobile/NT/Vista/XP (Server) (i.e., Aero, Surface, etc.); Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 7075 is a stored program component that is executed by a CPU 7004. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 7074 is a stored program component that is executed by a CPU 7004. The Web browser may be a conventional hypertext viewing application such as Apple's (mobile) Safari, Google's Chrome, Microsoft Internet Explorer, Mozilla's Firefox, Netscape Navigator, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the CallLab enabled nodes. The combined application may be nugatory on systems employing standard Web browsers.

### Mail Server

A mail server component 7071 is a stored program component that is executed by a CPU Error! Reference source not found.03. The mail server may be a conventional Internet mail server such as, but not limited to: dovecot, Courier IMAP, Cyrus IMAP, Maildir, Microsoft Exchange, sendmail, and/or the like. The mail server 7071 may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server 7071 can route, forward, and process incoming and outgoing mail messages that have been sent, relayed and/or otherwise traversing through and/or to the CallLab.

Access to the CallLab mail may be achieved through a number of APIs offered by the individual Web server components and/or the operating system 7031.

Also, a mail server 7071 may contain, communicate, generate, obtain, and/or provide program component, system, user, and/or data communications, requests, information, and/or responses.

### Mail Client

A mail client component 7073 is a stored program component that is executed by a CPU 7004. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client 7073 provides a facility to compose and transmit electronic mail messages.

### Cryptographic Server

A cryptographic server component 7070 is a stored program component that is executed by a CPU 7004, cryptographic processor 7012, cryptographic processor interface 7014, cryptographic processor device 7028, and/or the like. Cryptographic processor interfaces 7014 will allow for expedition of encryption and/or decryption requests by the cryptographic server component 7070; however, the cryptographic component 7070, alternatively, may run on a conventional CPU. The cryptographic component 7070 allows for the encryption and/or decryption of provided data. The cryptographic component 7070 allows for both symmetric and asymmetric (e.g., Pretty Good Protection (PGP)) encryption and/or decryption. The cryptographic component 7070 may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the CallLab may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component 7070 may communicate to and/or with other components in a component collection, including itself, and/or facilities of the like. The cryptographic component 7070 supports encryption schemes allowing for the secure transmission of information across a communications network to enable the CallLab component 7042 to engage in secure transactions if so desired. The cryptographic component 7070 facilitates the secure accessing of resources on the CallLab and facilitates the access of secured resources on remote systems; i.e., it may act as a client and/or server of secured resources. Most frequently, the cryptographic component 7070 communicates with information servers, operating systems, other program components, and/or the like. The cryptographic component 7070 may contain, communicate, generate, obtain, and/or provide program component, system, user, and/or data communications, requests, and/or responses.

### The CallLab Database

The CallLab component 7042 may be embodied in a CallLab database 7050 and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the CallLab component 7042 may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the CallLab database 7050 is implemented as a data-structure, the use of the CallLab database 7050 may be integrated into another component such as the CallLab component 7042. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the CallLab Database 7050 includes several tables 7057-7059:

A users table 7057 includes fields such as, but not limited to: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, userAccessPrivilges, userPreferences, userRestrictions, and/or the like (the user table may support and/or track multiple entity accounts on a CallLab);

A devices table 7058 includes fields such as, but not limited to: deviceID, accountID, assetIDs, paymentIDs, deviceType, deviceName, deviceModel, deviceVersion, deviceSerialNo, devicelPaddress, deviceMACaddress, device_ECID, deviceUUID, deviceLocation, deviceCertificate, deviceOS, appIDs, deviceResources, deviceSession, authKey, deviceSecureKey, walletAppinstalledFlag, deviceAccessPrivileges, device Preferences, deviceRestrictions, and/or the like;

An applications table 7059 includes fields such as, but not limited to: appID, appName, appType, appDependencies, accountID, deviceIDs, transactionID, userID, appStoreAuthKey, appStoreAccountID, appStorelPaddress, appStoreURLaccessCode, appStorePortNo, appAccessPrivileges, appPreferences, appRestrictions and/or the like.

CallLab database 7050 may further include stored triage questions 7051, generic questions 7052 and custom questions 7053 as described above for use with the call training games described previously.

CallLab database 7050 may further include SQL databases of information related business units associated with CallLab, such as FI SQL database 7054, PI SQL database 7055 and WI SQL database 7056.

CallLab component 7042 may include further programming components for accomplishing the functions described herein. The CallLab component 7042 may include business unit components (FI component 7060, PI Component 7061 and WI component 7062), an administrator component 7063, a reporting component 7064 and a call game component 7065.

In one embodiment, the CallLab database 7050 may be unitary or may interact with other database systems to accomplish the functions described herein.

In one embodiment, user programs may contain various user interface primitives, which may serve to update the CallLab. Also, various accounts may require custom database tables depending upon the environments and the types of clients the CallLab may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 7051-7059. The CallLab may be configured to keep track of various settings, inputs, and parameters via database controllers.

The CallLab database may communicate to and/or with other components in a component collection, including itself, and/or facilities of the like. Most frequently, the CallLab database communicates with the CallLab component, other program components, and/or the like. The database may contain, retain, and provide information regarding other nodes and data.

### The CallLab

The CallLab component 7042 is a stored program component that is executed by a CPU. In one embodiment, the CallLab component incorporates any and/or all combinations of the aspects of the CallLab that was discussed in the previous figures. As such, the CallLab affects accessing, obtaining and the provision of information, services, transactions, and/or the like across various communications networks. The features and embodiments of the CallLab discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the CallLab's features and facilities, and in many cases reduce the costs, energy consumption/requirements, and extend the life of CallLab's underlying infrastructure; this has the added benefit of making the CallLab more reliable. Similarly, many of the features and mechanisms are designed to be easier for users to use and access, thereby broadening the audience that may enjoy/employ and exploit the feature sets of the CallLab; such ease of use also helps to increase the reliability of the CallLab. In addition, the feature sets include heightened security as noted via the Cryptographic components 7012, 7014, 7070 and throughout, making access to the features and data more reliable and secure

The CallLab transforms Error! Reference source not found. via CallLab components into outputs that may be displayed to users.

The CallLab component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the CallLab server employs a cryptographic server to encrypt and decrypt communications. The CallLab component may communicate to and/or with other components in a component collection, including itself, and/or facilities of the like. Most frequently, the CallLab component communicates with the CallLab database, operating systems, other program components, and/or the like. The CallLab may contain, communicate, generate, obtain, and/or provide program component, system, user, and/or data communications, requests, and/or responses.

### Distributed CallLabs

The structure and/or operation of any of the CallLab node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the CallLab controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c -post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the CallLab controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ’192.168.0.100’;
$port = 255;
// create a server-side SSL socket, listen for/accept incoming
communication
$sock = socket_create(AF_INET, SOCK_STREAM, 0);
socket_bind($sock, $address, $port) or die(’Could not bind to address’);
socket_listen($sock);
$client = socket_accept($sock);
// read input data from client device in 1024 byte blocks until end of
message
do {

$input = ””;
$input = socket_read($client, 1024);
$data .= $input;

} while($input != ””);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(”INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm
.IBMDI.doc/referenceguide295.htm

and other parser implementations:

http://publib.boulder.ibm.com/infocenter/tivihelp/v2r1/index.jsp?topic=/com.ibm
.IBMDI.doc/referenceguide259.htm

all of which are hereby expressly incorporated by reference.

In order to address various issues and advance the art, the entirety of this application for Apparatuses, Methods and Systems for Improved Call Center Training (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached,” “affixed,” “connected,” “coupled,” “interconnected,” and similar may refer to a relationship wherein structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a CallLab individual and/or enterprise user, database configuration and/or relational model, data type, data transmission and/or network framework, syntax structure, and/or the like, various embodiments of the CallLab, may be implemented that enable a great deal of flexibility and customization. While various embodiments and discussions of the CallLab have included Automated Management Arrangements, however, it is to be understood that the embodiments described herein may be readily configured and/or customized for a wide variety of other applications and/or implementations.

What is claimed is:

1. A call game apparatus, comprising:
a memory;
a component collection stored in the memory, including:
a business unit component,
an administrator component,
a reporting component, and
a call game component;
a processor disposed in communication with the memory, and configured to issue a plurality of processing instructions from the component collection stored in the memory,
where the processor issues instructions from the business unit component, stored in the memory, to:
obtain at least one of: (i) phone call segments from a phone call between a call center operator and a customer and (ii) display screen information from a call center screen displayed to the call center operator during the phone call, and
provide the phone call segments and display screen information to the administrator component;
where the processor issues instructions from the administrator component, stored in the memory, to:
obtain the phone call segments and display screen information from the business unit component,
determine call game data comprising portions of the phone call segments and portions of the display screen information;
where the processor issues instructions from the call game component, stored in the memory, to:
obtain the call game data from the administrator component,
insert the call game data into a live game administrated by the call game component while a user is interacting with the live game, and
provide results of the live game to the reporting component for evaluating the user.

2. The apparatus of claim 1, wherein the processor issues instructions from the reporting component stored in memory to display an evaluation of a user to an administrator, the evaluation based on a performance of the user during the live game.

3. A processor-readable call game non-transient medium storing processor-executable components, the components, comprising:
a component collection stored in the medium, including:
a business unit component,
an administrator component, and
a call game component;
where the business unit component, stored in the medium, includes processor-issuable instructions to:
obtain phone call segments from a phone call between a call center operator and a customer and,
provide the phone call segments to the administrator component,
where the administrator component, stored in the medium, includes processor-issuable instructions to:
obtain the phone call segments from the business unit component,
determine call game data comprising portions of the phone call segments, and
receive inputs of question and answer data corresponding to the call game data;
where the call game component, stored in the medium, includes processor-issuable instructions to:
obtain the call game data and the question and answer data from the administrator component,
insert the call game data and the question and answer data into a live game administrated by the call game component while a user is interacting with the live game, and
provide results of the live game for evaluating the user.

4. The medium of claim 3, the component collection further comprising:
a reporting component, stored in the medium, which includes processor-issuable instructions to:
obtain the results of the live game from the call game component,
determine an evaluation of a performance of the user during the live call game, and
display the evaluation of the user to an administrator, the evaluation based on the performance of the user during the live game.

5. A processor-implemented call game system, comprising:
a business unit component means, to:
obtain display screen information from a call center screen displayed to the call center operator during a phone call between a call center operator and a customer, and
provide the display screen information to an administrator component means,
the administrator component means to:
obtain the display screen information from the business unit component means,
determine call game data comprising portions of the display screen information, and
receive inputs of question and answer data corresponding to the call game data; and
a call game component means to:
obtain the call game data and the question and answer data from the administrator component means,
insert the call game data and the question and answer data into a live call game administrated by the call game component means while a user is interacting with the live call game, and
provide results of the live call game for evaluating the user.

6. The system of claim 5, further comprising:
a reporting component means to:
obtain the results of the live call game from the call game component means,
determine an evaluation of a performance of the user during the live call game, and
display the evaluation of the user to an administrator, the evaluation based on the performance of the user during the live call game.

7. A processor-implemented call game method to transform phone conversations into call game data, comprising:
executing processor-implemented call center component instructions to:
obtain at least one of: (i) phone call segments from a phone call between a call center operator and a customer and (ii) display screen information from a call center screen displayed to the call center operator during the phone call, and
provide the phone call segments and display screen information as call game data to a call game played by a trainee;
executing processor-implemented call game component instructions to:
obtain call game data,
insert the call game data into the call game while the trainee is interacting with the call game, and
display results of the call game to an administrator for evaluating the user.

8. An improved computer network for training call center employees, comprising:
a call center server having a first processor in operative communication with a telephone network via a telephone network interface and with a first memory, the first memory for storing processing instructions in the form of a first programmed component for recording live telephone conversation data between a call center operator and a customer on the telephone network;
a database server having a second processor in operative communication with a second memory, the second memory for storing processing instructions in the form of a second programmed component for storing the live telephone conversation data as recorded telephone conversation data;
an administrator server having a third processor in operative communication with a third memory for storing processing instructions in the form of a third programmed component for editing the recorded telephone conversation data to produce edited telephone conversation data, and for storing the edited telephone conversation data in the second memory of the database server, the edited telephone conversation data comprising a plurality of telephone call segments to be used in a call training game;
a call training game server having a fourth processor in operative communication with a fourth memory for storing processing instructions in the form of a fourth programmed component for generating call training game data from the plurality of telephone call segments, the fourth memory further storing processing instructions in the form of a fifth programmed component for executing the call training game using the call training game data; and
a network interface server having a fifth processor in operative communication with a fifth memory for storing processing instructions in the form of a sixth programmed component for transmitting the live telephone conversation data from the telephone network to the call center server, for transmitting the live telephone conversation data from the call center server to the database server, for transmitting the recorded telephone conversation data from the database server to the administrator server, for transmitting the edited telephone conversation data from the administrator server to the training game server, and for transmitting the call training game data between the call training game server and a user terminal for presenting the call training game to a trainee; where the call training game is updated with the call training game data originating from the recorded telephone conversation data while the call training game is run by the user terminal without interrupting the call training game.

9. An improved computer network for training call center employees, comprising:
a call center server having a first processor in operative communication with a first memory, the first memory for storing processing instructions in the form of a first programmed component for capturing call center screen shot data comprising graphics and information displayed to a call center operator on a call center terminal;
a database server having a second processor in operative communication with a second memory, the second memory for storing processing instructions in the form of a second programmed component for storing the call center screen shot data as stored call center screen shot data;
an administrator server having a third processor in operative communication with a third memory for storing processing instructions in the form of a third programmed component for editing the stored call center screen shot data to produce edited call center screen shot data, and for storing the edited call center screen shot data in the second memory of the database server, the edited call center screen shot data comprising a plurality of call center screen shot segments to be used in a call training game;
a call training game server having a fourth processor in operative communication with a fourth memory for storing processing instructions in the form of a fourth programmed component for generating call training game data from the plurality of call center screen shot segments, the fourth memory further storing processing instructions in the form of a fifth programmed component for executing the call training game using the call training game data; and
a network interface server having a fifth processor in operative communication with a fifth memory for storing processing instructions in the form of a sixth programmed component for transmitting the call center screen shot data from the telephone network to the call center server, for transmitting the call center screen shot data from the call center server to the database server, for transmitting the call center screen shot data from the database server to the administrator server, for transmitting the edited call center screen shot data from the administrator server to the training game server, and for transmitting the call training game data between the call training game server and a user terminal for presenting the call training game to a trainee; where the call training game is updated with the call training game data originating from the call center screen shot data while the call training game is run by the user terminal without interrupting the call training game.
